(19) United States
(12) Patent Application Publication
(10) Pub. No.: US 2024/0342602 A1
(43) Pub. Date: Oct. 17, 2024

(54) NON-TRANSITORY COMPUTER READABLE MEDIUM, INFORMATION PROCESSING METHOD, GAME DEVICE, AND INFORMATION PROCESSING SYSTEM

(71) Applicant: CYGAMES, INC., Tokyo (JP)

(72) Inventors: Atsushi Sato, Tokyo (JP); Yohei Yamagishi, Tokyo (JP); Yuki Nishi, Tokyo (JP)

(73) Assignee: CYGAMES, INC., Tokyo (JP)

(21) Appl. No.: 18/752,230

(22) Filed: Jun. 24, 2024

Related U.S. Application Data
(63) Continuation of application No. PCT/JP2022/046695, filed on Dec. 19, 2022.

(30) Foreign Application Priority Data
Dec. 28, 2021 (JP) 2021-215172

(51) Int. Cl. A63F 13/533; A63F 13/58; A63F 13/69; A63F 13/825

(52) U.S. Cl. CPC A63F 13/533; A63F 13/58; A63F 13/69; A63F 13/825

(57) ABSTRACT

A non-transitory computer readable medium stores a program causing a computer to execute a process of executing a first game and a process of executing a second game, wherein the process of executing the first game includes a process of changing a second parameter linked with a raising subject game medium on the basis of a first parameter when a raising-completed game medium for which the first parameter is set is set as an in-use game medium, and the process of executing the second game includes a process of setting the first parameter on the basis of the second parameter of the raising-completed game medium.

### CROSS REFERENCE TO RELATED APPLICATIONS

This application is a continuation application of International Application No. PCT/JP2022/046695, filed on Dec. 19, 2022, which claims priority to Japanese Patent Application No. 2021-215172, filed on Dec. 28, 2021, the entire contents of which are incorporated by reference herein.

### BACKGROUND ART

### Technical Field

The present invention relates to an information processing program, an information processing method, a game device, and an information processing system.

A game genre so-called a raising game is known. For example, Patent Literature 1 discloses a raising game in which the player acts as a racehorse owner to produce and raise racehorses. PTL 1 discloses that the player selects a favorite breeding horse, produces a racehorse, and has the racehorse participate in a race.

### CITATION LIST

### Patent Literature

Patent Literature 1: JP 2002-126349 A

### SUMMARY OF INVENTION

### Technical Problem

However, when a raised character raised by the player is used in an event game different from the raising game, the raised character does not necessarily have a parameter advantageous for the event game. Thus, for example, it has been difficult to improve eagerness to play the game.

An object of the present invention is to provide an information processing program, an information processing method, a game device, and an information processing system that can improve eagerness to play the game.

### Solution to Problem

To address the issues described above, an information processing program includes instructing a computer to perform:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
   a process of changing the second parameter linked with the raising subject game medium on the basis of the first parameter when the raising-completed game medium for which the first parameter is set is set as the in-use game medium, and
the process of executing the second game includes:
   a process of setting the first parameter on the basis of the second parameter of the raising-completed game medium.

In the process of executing the second game,
a reward granted in the second game may be increased on the basis of the second parameter of the raising-completed game medium.

The process of enabling the player to select a game medium may involve:
enabling the player to select the raising-completed game medium raised by another player, and
not changing the second parameter on the basis of the first parameter linked with the in-use game medium when the raising-completed game medium raised by the other player is set as the in-use game medium.

To address issues described above, an information processing method is an information processing method to be performed by a computer, the computer performing:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
   a process of changing the second parameter linked with the raising subject game medium on the basis of the first parameter when the raising-completed game medium for which the first parameter is set is set as the in-use game medium, and
the process of executing the second game includes:
   a process of setting the first parameter on the basis of the second parameter of the raising-completed game medium.

To address the issues described above, a game device includes one computer or a plurality of computers,
wherein the computer or computers perform:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
   a process of changing the second parameter linked with the raising subject game medium on the basis of the first parameter when the raising-completed game medium for which the first parameter is set is set as the in-use game medium, and
the process of executing the second game includes:
   a process of setting the first parameter on the basis of the second parameter of the raising-completed game medium.

To address the issues described above, an information processing system includes one computer or a plurality of computers,
wherein the computer or computers perform
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
   a process of changing the second parameter linked with the raising subject game medium on the basis of the first parameter when the raising-completed game medium for which the first parameter is set is set as the in-use game medium, and
the process of executing the second game includes:
   a process of setting the first parameter on the basis of the second parameter of the raising-completed game medium.

### Effects

According to the present invention, eagerness to play the game can be improved

### BRIEF DESCRIPTION OF DRAWINGS

FIG. 1 is a diagram illustrating a schematic structure of an information processing system.

FIG. 2A is a diagram illustrating a hardware configuration of a player terminal. FIG. 2B is a diagram illustrating a hardware configuration of a server.

FIG. 3A is a diagram illustrating one example of a home screen. FIG. 3B is a diagram illustrating one example of an option setting screen. FIG. 3C is a diagram illustrating one example of a profile setting screen. FIG. 3D is a diagram illustrating one example of a home setting screen.

FIG. 4 is a diagram roughly illustrating the flow of a raising game.

FIG. 5A is a diagram illustrating a main character select screen. FIG. 5B is a first diagram illustrating a character detail screen. FIG. 5C is a second diagram illustrating the character detail screen.

FIG. 6A is a diagram illustrating an ability parameter (initial value) table. FIG. 6B is a diagram illustrating an aptitude parameter (initial value) table. FIG. 6C is a diagram illustrating a skill table. FIG. 6D is a diagram illustrating a dedicated event table.

FIG. 7 is a first diagram illustrating one example of a raising information display screen.

FIG. 8A is a diagram illustrating one example of special clear targets. FIG. 8B is a diagram illustrating one example of a clear target set for a character.

FIG. 9 is a second diagram illustrating one example of a raising information display screen.

FIG. 10A is a first diagram illustrating an inheritance character select screen. FIG. 10B is a first diagram illustrating a raised character list screen. FIG. 10C is a second diagram illustrating the inheritance character select screen. FIG. 10D is a third diagram illustrating the inheritance character select screen.

FIG. 11 is a diagram illustrating a lineage of inheritance.

FIG. 12 is a diagram illustrating factor information.

FIG. 13A is a diagram illustrating compatibility judgment subjects, and FIG. 13B is a diagram illustrating compatibility judgment items.

FIG. 14A is a diagram illustrating sorting conditions. FIG. 14B is a diagram illustrating narrowing conditions.

FIG. 15 is a first diagram illustrating a character detail dialogue.

FIG. 16 is a second diagram illustrating the character detail dialogue.

FIG. 17 is a third diagram illustrating the character detail dialogue.

FIG. 18 is a diagram illustrating a skill display dialogue.

FIG. 19A is a first diagram illustrating a support card formation screen. FIG. 19B is a diagram illustrating a support card select screen. FIG. 19C is a second diagram illustrating the support card formation screen.

FIG. 20A is a diagram illustrating a support card table. FIG. 20B is a diagram illustrating a supporting effect table. FIG. 20C is a diagram illustrating an in-possession skill table. FIG. 20D is a diagram illustrating a support event table.

FIG. 21A is a diagram illustrating a final confirmation screen. FIG. 21B is a diagram illustrating a preset select screen.

FIG. 22 is a first diagram illustrating a character identification information table.

FIG. 23 is a second diagram illustrating the character identification information table.

FIG. 24 is a diagram illustrating a selection item table.

FIG. 25A is a first diagram illustrating a game screen. FIG. 25B is a second diagram illustrating the game screen.

FIG. 26A is a first diagram illustrating a training screen. FIG. 26B is a second diagram illustrating the training screen. FIG. 26C is a diagram illustrating a training result notification screen. FIG. 26D is a diagram illustrating an event screen.

FIG. 27A is a first diagram illustrating an inheritance event. FIG. 27B is a second diagram illustrating the inheritance event. FIG. 27C is a third diagram illustrating the inheritance event. FIG. 27D is a fourth diagram illustrating the inheritance event.

FIG. 28A is a first diagram illustrating a skill screen. FIG. 28B is a second diagram illustrating the skill screen.

FIG. 29A is a first diagram illustrating an individual race select screen. FIG. 29B is a diagram illustrating an individual race start screen. FIG. 29C is a first diagram illustrating an individual race result screen. FIG. 29D is a second diagram illustrating the individual race result screen.

FIG. 30A is a diagram illustrating a team race select screen. FIG. 30B is a diagram illustrating a team formation screen. FIG. 30C is a diagram illustrating a team race start screen. FIG. 30D is a diagram illustrating a team race midway result screen.

FIG. 31A is a first diagram illustrating a team race detailed result screen. FIG. 31B is a first diagram illustrating a team race comprehensive result screen. FIG. 31C is a second diagram illustrating the team race detailed result screen. FIG. 31D is a second diagram illustrating the team race comprehensive result screen.

FIG. 32 is a flowchart roughly illustrating the flow of a turn start process.

FIG. 33 is a diagram illustrating an assignment table.

FIG. 34A is a diagram illustrating a training level table. FIG. 34B is a diagram illustrating a fixed increase value (speed) table. FIG. 34C is a diagram illustrating a fixed increase value (power) table. FIG. 34D is a diagram illustrating a bonus addition rate table.

FIG. 35 is a diagram illustrating the types and classifications of the events.

FIG. 36 is a diagram illustrating the relationship between the event type and the turn number.

FIG. 37A is a third diagram illustrating the game screen. FIG. 37B is a third diagram illustrating the training screen.

FIG. 38A is a diagram illustrating a table that determines whether a special event will be held or not. FIG. 38B is a diagram illustrating a special icon determination table. FIG. 38C is a diagram illustrating a bonus icon determination table.

FIG. 39A is a diagram illustrating a bonus fixed value (main character) table. FIG. 39B is a diagram illustrating a bonus additional value (main character) table.

FIG. 40A is a diagram illustrating a fixed increase value (intensive training subject) table. FIG. 40B is a diagram illustrating a bonus increase value (intensive training subject) table.

FIG. 41A is a diagram illustrating a raising complete screen. FIG. 41B is a second diagram illustrating the raising complete screen. FIG. 41C is a third diagram illustrating the raising complete screen.

FIG. 42A is a diagram illustrating a race game select screen. FIG. 42B is a diagram illustrating a team competition race screen. FIG. 42C is a diagram illustrating a team formation screen. FIG. 42D is a diagram illustrating a raised character list screen.

FIG. 43A is a diagram illustrating an opponent team select screen. FIG. 43B is a diagram illustrating a start confirmation screen. FIG. 43C is a first diagram illustrating a result list screen. FIG. 43D is a second diagram illustrating the result list screen.

FIG. 44 is a diagram illustrating a comprehensive race result screen.

FIG. 45 is a diagram illustrating a score list screen.

FIG. 46A is a diagram illustrating a practice match top screen. FIG. 46B is a diagram illustrating a participant character setting screen. FIG. 46C is a first diagram illustrating a participant character select screen. FIG. 46D is a second diagram illustrating the participant character select screen.

FIG. 47 is a diagram illustrating race conditions.

FIG. 48 is a diagram illustrating a practice member select screen.

FIG. 49A is a first diagram illustrating a practice partner screen. FIG. 49B is a second diagram illustrating the practice partner screen. FIG. 49C is a fourth diagram illustrating a character detail dialogue.

FIG. 50A is a diagram illustrating a practice match result screen. FIG. 50B is a diagram illustrating a practice member registration screen. FIG. 50C is a diagram illustrating a race result save dialogue.

FIG. 51A is a diagram illustrating a room match top screen. FIG. 51B is a diagram illustrating a host race select screen. FIG. 51C is a diagram illustrating a mode select screen.

FIG. 52 is a diagram illustrating a simple mode.

FIG. 53 is a diagram illustrating a detail mode.

FIG. 54A is a diagram illustrating a room match participant character select screen. FIG. 54B is a diagram illustrating a strategy select tab. FIG. 54C is a diagram illustrating an entry information screen. FIG. 54D is a diagram illustrating a waiting room screen of a host player.

FIG. 55 is a diagram illustrating a race detail screen.

FIG. 56A is a diagram illustrating a room search screen. FIG. 56B is a diagram illustrating a waiting room screen of a guest player.

FIG. 57A is a diagram illustrating a daily race screen. FIG. 57B is a diagram illustrating a difficulty level select screen. FIG. 57C is a diagram illustrating a play mode select screen. FIG. 57D is a diagram illustrating a daily race participant character select screen.

FIG. 58A is a diagram illustrating a skip setting screen. FIG. 58B is a first diagram illustrating a skip result display screen. FIG. 58C is a second diagram illustrating the skip result display screen. FIG. 58D is a third diagram illustrating the skip result display screen.

FIG. 59 is a diagram illustrating a special event race screen.

FIG. 60A is a first diagram illustrating a display example of an irregular race select operation portion. FIG. 60B is a second diagram illustrating a display example of an irregular race select operation portion. FIG. 60C is a third diagram illustrating a display example of the irregular race select operation portion. FIG. 60D is a fourth diagram illustrating a display example of the irregular race select operation portion. FIG. 60E is a fifth diagram illustrating a display example of the irregular race select operation portion.

FIG. 61 is a diagram illustrating the event skill factor winning probability.

FIG. 62 is a diagram illustrating correction values provided by event skills to the event points.

FIG. 63 is a diagram illustrating the structure of a memory in the player terminal and the function as a computer.

FIG. 64 is a diagram illustrating the structure of a memory in the server and the function as a computer.

FIG. 65 is a sequence diagram illustrating raising game-related processes in the player terminal and the server.

FIG. 66 is a first flowchart illustrating a preparation stage process in the player terminal.

FIG. 67 is a second flowchart illustrating the preparation stage process in the player terminal.

FIG. 68 is a second flowchart illustrating the preparation stage process in the player terminal.

FIG. 69 is a flowchart illustrating the preparation stage process in the server.

FIG. 70 is a flowchart illustrating a raising stage process in the player terminal.

FIG. 71 is a flowchart illustrating a turn start process in the player terminal.

FIG. 72 is a flowchart illustrating an assignment process in the player terminal.

FIG. 73 is a flowchart illustrating a numerical value determination process in the player terminal.

FIG. 74 is a flowchart illustrating an event determination process in the player terminal.

FIG. 75 is a flowchart illustrating a mid-turn process in the player terminal.

FIG. 76 is a flowchart illustrating a raising execution process in the player terminal.

FIG. 77 is a first flowchart illustrating an inheritance event execution process in the player terminal.

FIG. 78 is a second flowchart illustrating the inheritance event execution process in the player terminal.

FIG. 79 is a flowchart illustrating a raising game end process in the server.

FIG. 80 is a sequence diagram illustrating event race-related processes in the player terminal and the server.

FIG. 81 is a flowchart illustrating a race result deriving process in the server.

### DESCRIPTION OF EMBODIMENTS

One of embodiments of the present invention will now be described in detail with reference to the attached drawings. The numerical values and the like indicated in the embodiment are merely examples for promoting understanding and do not limit the present invention unless otherwise noted. In the present description and the drawings, elements that have substantially the same functions and structures are denoted by the same reference signs to omit redundant descriptions, and elements that do not directly relate to the present invention are not illustrated in the drawings.

### (Overall Structure of Information Processing System S)

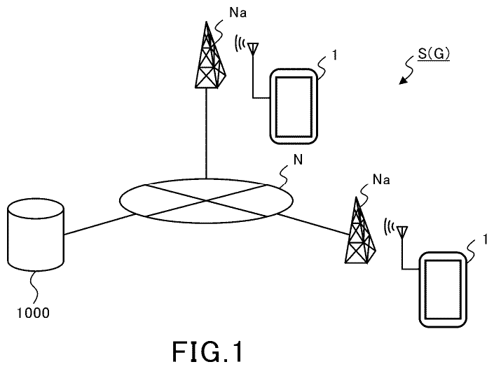

FIG. 1 is a diagram illustrating a schematic structure of an information processing system S. The information processing system S is what is known as a client server system that includes a player terminal 1 that functions as a client, i.e., a game terminal, a server 1000, and a communication network N having communication base stations Na.

In the information processing system S of this embodiment, the player terminal 1 and the server 1000 function as a game device G. The player terminal 1 and the server 1000 divide tasks of controlling the progress of the game, and the game can progress as the player terminal 1 and the server 1000 work together.

The player terminal 1 can establish communication with the server 1000 via the communication network N. The player terminal 1 widely includes electronic appliances capable of establishing wired or wireless communication connection with the server 1000. Examples of the player terminal 1 include smart phones, cellular phones, tablet devices, personal computers, and game consoles. In this embodiment, the case in which a smart phone is used as the player terminal 1 is described.

The server 1000 is communicatively connected to multiple player terminals 1. The server 1000 stores various types of information with respect to each player playing the game. Furthermore, the server 1000 executes processes mainly on the basis of the operation input through the player terminal 1, such as updating the stored information or downloading images and various types of information to the player terminal 1.

The communication base stations Na are connected to the communication network N, and send and receive information wirelessly to and from the player terminal 1. The communication network N is constituted by a mobile phone network, the Internet, a local area network (LAN)), a dedicated line, etc., and realizes wired or wireless communication connection between the player terminal 1 and the server 1000.

### (Hardware Configurations of Player Terminal 1 and Server 1000)

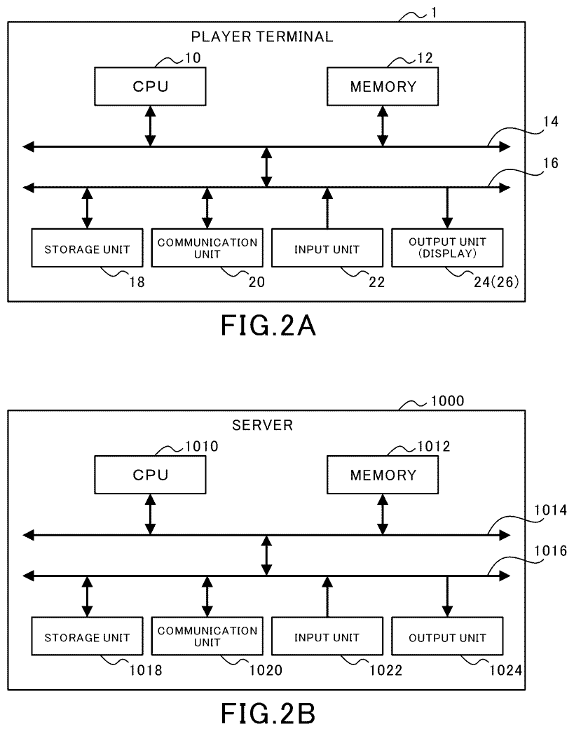

FIG. 2A is a diagram illustrating the hardware configuration of the player terminal 1. FIG. 2B is a diagram illustrating the hardware configuration of the server 1000. As illustrated in FIG. 2A, the player terminal 1 includes a central processing unit (CPU) 10, a memory 12, a bus 14, an I/O interface 16, a storage unit 18, a communication unit 20, an input unit 22, and an output unit 24.

As illustrated in FIG. 2B, the server 1000 includes a CPU 1010, a memory 1012, a bus 1014, an I/O interface 1016, a storage unit 1018, a communication unit 1020, an input unit 1022, and an output unit 1024.

Here, the structures and functions of the CPU 1010, the memory 1012, the bus 1014, the I/O interface 1016, the storage unit 1018, the communication unit 1020, the input unit 1022, and the output unit 1024 of the server 1000 are substantially the same as, respectively, the CPU 10, the memory 12, the bus 14, the I/O interface 16, the storage unit 18, the communication unit 20, the input unit 22, and the output unit 24 of the player terminal 1. Thus, in the description below, the hardware configuration of the player terminal 1 is described but not that of the server 1000.

The CPU 10 runs the program stored in the memory 12 and controls the progress of the game. The memory 12 includes a read only memory (ROM) or a random access memory (RAM), and stores programs and various types of data necessary for controlling the progress of the game. The memory 12 is connected to the CPU 10 via the bus 14.

The I/O interface 16 is connected to the bus 14. The storage unit 18, the communication unit 20, the input unit 22, and the output unit 24 are connected to the I/O interface 16.

The storage unit 18 is configured of a semiconductor memory such as a dynamic random access memory (DRAM), and stores various types of programs and data. In the player terminal 1, the program and data stored in the storage unit 18 are loaded into the memory 12 (RAM) by the CPU 10.

The communication unit 20 forms wireless communication connection with the communication base stations Na, and sends and receives information, such as various types of data and programs, with the server 1000 via the communication network N. In the player terminal 1, the program etc., received from the server 1000 are stored in the memory 12 or the storage unit 18.

The input unit 22 includes, for example, a touch panel, a button, a keyboard, a mouse, an arrow key, an analog controller, or the like used by the player to input an operation (used to accept the operation). Alternatively, the input unit 22 may be a dedicated controller installed in the player terminal 1 or connected (externally attached) to the player terminal 1. Furthermore, the input unit 22 may include an acceleration sensor that detects the inclination and movement of the player terminal 1 or a microphone that detects the voice of the player. In other words, the input unit 22 includes a wide range of devices that enable recognition and input of the intention of the player.

The output unit 24 includes a display device and a speaker. The output unit 24 may be an appliance connected (externally attached) to the player terminal 1. In this embodiment, the player terminal 1 is equipped with a display 26 that serves as the output unit 24, and a touch panel that serves as the input unit 22 and is superposed on the display 26.

### (Game Content)

Next, the game provided by the information processing system S and the game device G of the present embodiment is described. The player can hold in possession characters obtained by a type of lottery known as “gacha” and characters distributed by the administrator. The player can also hold in possession support cards acquired by a lottery and support cards distributed by the administrator.

In the game of the present embodiment, a raising game (first game) is provided as described in detail below. In the raising game, the player can raise a character in the player's possession. In addition, the raising game of this embodiment offers a game element of raising a character by having the character participate in a race resembling a horse race.

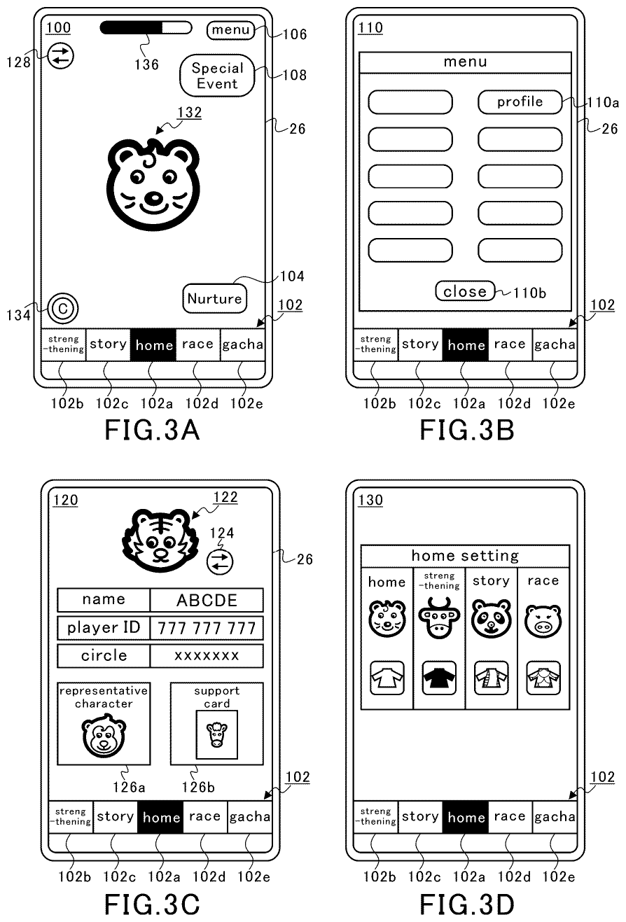

FIG. 3A is a diagram illustrating one example of a home screen 100. When the game application is started in the player terminal 1, the home screen 100 is displayed on the display 26. A menu bar 102 is displayed at the bottom of the home screen 100. The menu bar 102 includes multiple operation portions which the player can operate (tap).

Here, the menu bar 102 includes a home screen select operation portion 102a, a strengthening screen select operation portion 102b, a story screen select operation portion 102c, a race game select operation portion 102d, and a gacha screen select operation portion 102e. Note that, in the menu bar 102, the operation portion that corresponds to the screen that is currently displayed is highlighted so that the screen currently displayed on the display 26 can be identified.

When the home screen select operation portion 102a is tapped, the home screen 100 illustrated in FIG. 3A appears on the display 26.

When the strengthening screen select operation portion 102b is tapped, a strengthening screen not illustrated in the drawing appears. In the strengthening screen, the characters and support cards in the player's possession can be strengthened. The player can increase the levels set for the characters and the support cards by strengthening the characters and the support cards. Various parameters are set for the characters and the support cards, and these parameters increase by increasing the levels. The player can raise a character having a more powerful status in the raising game when the parameters of the characters and the support cards increase.

When the story screen select operation portion 102c is tapped, a story screen not illustrated in the drawing appears. Here, a story image is provided for each character in the game. The player can select, in the story screen, the character and the story image, and watch the story.

When the race game select operation portion 102d is tapped, a race game select screen described below appears. In this embodiment, various race games in which the raised character raised in the raising game described below can participate are provided. The player can select, in the race game select screen, the race game in which the raised character is to participate. An example of the race game is a team competition game in which a team formed by multiple raised characters competes against a team of another player selected by the computer. The team competition game offers a game element of competing against other players for ranking.

When the gacha screen select operation portion 102e is tapped, a gacha screen not illustrated in the drawing appears. In the gacha screen, the player spends in-game currency to play a so-called gacha lottery by which the player can win characters and support cards by a lottery.

In the home screen 100, a raising game operation portion 104 is provided above the menu bar 102. When the raising game operation portion 104 is tapped, a raising game screen appears, and the raising game described below starts. The raising game is roughly divided into a preparation stage and a raising stage, and, first, in the preparation stage, the player selects one character out of the characters in the player's possession and sets this character as the main character to be raised.

In the preparation stage, the player also sets a deck used for raising the main character. The deck is formed of multiple inheritance characters (game media) and multiple support cards described in detail below. Thus, in the raising game, the inheritance characters and the support cards formed into a deck are used.

After setting of the main character and the deck (inheritance characters and support cards) is completed, the stage transitions from the preparation stage to the raising stage, and a game for raising the main character starts. The player can hold in possession a character raised in the raising game as a raised character. As described above, the player can organize raised characters in the player's possession into a team and use these raised characters in a team competition game, etc.

As described above, the main objective of the game of the present embodiment is to raise raised characters through the raising game and to improve the ranking in the team competition game by using the raised characters.

In addition, the present embodiment provides a function for sharing the raised characters or the support cards among the players and a function for sharing information among multiple players. The player can set the raised characters and the support cards that can be used by other players in the raising game. Specifically, as illustrated in FIG. 3A, a setting operation portion 106 is provided on the upper right side of the home screen 100. When the setting operation portion 106 is tapped, an option setting screen 110 appears.

FIG. 3B is a diagram illustrating one example of the option setting screen 110. The option setting screen 110 is a screen in which various types of information can be confirmed and set. The option setting screen 110 includes multiple operation portions, and a tap on an operation portion enables confirmation and setting of the information corresponding to the tapped operation portion.

The operation portions in the option setting screen 110 include a profile setting operation portion 110a and a close operation portion 110b. When the close operation portion 110b is tapped, the option setting screen 110 closes, and the home screen 100 appears. When the profile setting operation portion 110a is tapped, a profile setting screen 120 appears.

FIG. 3C is a diagram illustrating one example of the profile setting screen 120. In the profile setting screen 120, the player can confirm and set the player's own profile information. The profile information includes a profile character, a player name, a player ID, an affiliated circle, a representative character, and a rental card.

The profile character functions as a character displayed when the information of the player is viewed by other players. For example, the profile character is displayed when the circle function which is the place where information is shared with other players is being used. The profile setting screen 120 displays a profile character image 122 currently set. A change button 124 is provided near the profile character image 122. When the change button 124 is tapped, a profile character change screen not illustrated in the drawing appears. In the profile character change screen, the player can change the profile character.

The profile setting screen 120 also displays the player name set by the player, the player ID assigned to the player, and the name of the circle that the player belongs to. In addition, a representative character setting operation portion 126a and a rental card setting operation portion 126b are provided in the profile setting screen 120.

When the representative character setting operation portion 126a is tapped, a representative character setting screen not illustrated in the drawing appears. In the representative character setting screen, the player can set, as the representative character, one character from among the raised characters the player has raised. In the representative character setting operation portion 126a, an icon image indicating the currently set representative character is displayed. Although the detailed description is provided below, the representative character can be included in the deck as an inheritance character in a raising game played by another players.

When the rental card setting operation portion 126b is tapped, a rental card setting screen not illustrated in the drawing appears. In the rental card setting screen, the player can set, as a rental card, one support card from among the support cards in the player's possession. In the rental card setting operation portion 126b, an icon image indicating the currently set rental card is displayed. Note that, as described above, the support card set as a rental card can be included in a deck by another player and is used in a raising game played by another player.

Although the detailed description is omitted, when the settings of the profile information are changed in the profile setting screen 120, setting change information is transmitted to the server 1000. The server 1000 stores profile information with respect to each player.

As illustrated in FIG. 3A, a setting icon 128 is displayed in the home screen 100. When the setting icon 128 is tapped, a home setting screen 130 appears.

FIG. 3D is a diagram illustrating one example of the home setting screen 130. In the home setting screen 130, the player can set a home screen setting character 132 to be displayed in the home screen 100. The player can set four home screen setting characters 132 to be displayed in the home screen 100.

Although not illustrated in the drawings, the screen displayed on the display 26, that is, the home screen 100, changes when a flick operation is input in horizontal directions in the home screen 100. Four home screen setting characters 132 currently set are displayed in the home screen 100. The functions of the operation portions displayed in the menu bar 102 are assigned to the home screen setting characters 132. Thus, when a home screen setting character 132 displayed in the home screen 100 is tapped, the screen switches in the same manner as when an operation portion in the menu bar 102 is tapped.

In the home setting screen 130, character images respectively corresponding to the currently set four home screen setting characters 132 and the corresponding operation portions are displayed to enable recognition. When a character image displayed in the home setting screen 130 is tapped, a character select screen not illustrated in the drawing appears. In the character select screen, the player can select the home screen setting characters 132. Furthermore, in the home setting screen 130, the player can set the costumes of the home screen setting characters 132.

As illustrated in FIG. 3A, a circle icon 134 is displayed in the home screen 100. When the circle icon 134 is tapped, a circle screen appears. In the circle screen, the player can exchange information with other players belonging to the same circle.

Furthermore, in the present embodiment, various limited-time events are held irregularly. During a special event, which is a limited-time event, a special event icon 108 is displayed in the home screen 100. When the special event icon 108 is tapped, a special event screen appears. In the special event screen, the player can exchange the special event points provided only in the special event with various rewards.

When the raising game operation portion 104 in the home screen 100 is tapped, a raising game screen appears and the raising game starts. Here, the player can play the raising game by spending game points. A particular value (for example, +1) of game points is given to the player every specified period of time (for example, 10 minutes). An upper limit (for example, 100) is set for the game points the player can keep, and the player can keep the game points within the upper limit. A game point indicator bar 136 is provided at the top of the home screen 100, and the proportion of the current game points relative to the upper limit is visually indicated.

It should be noted that, a specified value (for example, −30) is subtracted from the game points at the start of the raising game. Thus, the player cannot start the raising game if the player does not have the required game points. However, the player can hold in possession an item that recovers game points, and can recover the game points by using this item. This item is, for example, given as a reward in the raising game or the team competition game or can be acquired by spending in-game currency. The raising game will now be described in detail.

### (Raising Game)

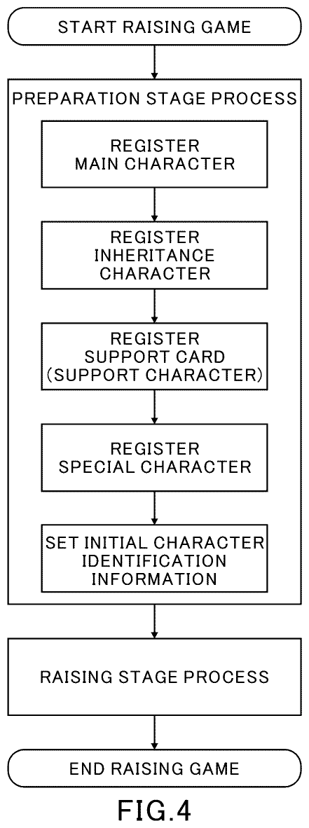

FIG. 4 is a flowchart roughly illustrating the flow of the raising game. The raising game is roughly divided into a setting game and raising main game. Although the details are described below, the raising main game involves raising, as a raising subject character, one main character selected from among the characters in possession of the player.

In the setting game, the player registers a main character and a deck (inheritance characters and support cards), and this corresponds to a preparation stage of the raising game. In the description below, a process performed in the setting game is referred to as a preparation stage process, and a process performed in the raising main game is referred to as a raising stage process. Here, for the sake of ease of understanding, the flow of the preparation stage process and the raising stage process are roughly described first.

### <Preparation Stage Process>

In the preparation stage process, mainly, registration of the main character, registration of the deck (inheritance characters and support cards), registration of special characters, and initial character identification information are set. The support cards help raise the main character. One character is always linked with one support card, and characters linked with the support cards registered in the preparation stage process will help raise the main character. Hereinafter, a character linked with a support card is referred to as a support character.

### <Registration of Main Character>

When the player taps the raising game operation portion 104 in the home screen 100, a scenario select screen not illustrated in the drawing appears. In the present embodiment, multiple scenarios are provided for the raising main game. The final target, targets to be achieved during the game, etc., are set in each of the scenarios of the raising main game, and the player is required to clear the set targets one by one. The targets, the time periods set for clearing the targets, etc., differ from one scenario to another. The player can select any one of multiple scenarios in the scenario select screen. Here, the case in which a particular scenario has been selected is described.

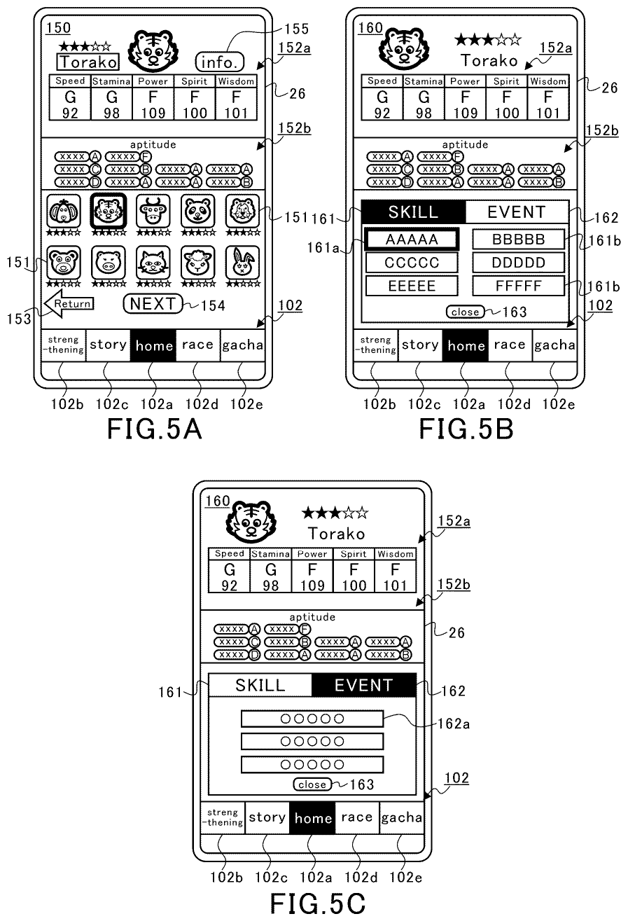

FIG. 5A is a diagram illustrating a main character select screen 150. Multiple character icons 151 are displayed in the center portion of the main character select screen 150, thereby listing the characters in the player's possession. An ability parameter display portion 152a and an aptitude parameter display portion 152b are displayed in an upper portion of the main character select screen 150. In addition, a return operation portion 153 indicated by “Return” and a next operation portion 154 indicated by “NEXT” are displayed in a lower portion of the main character select screen 150.

In the present embodiment, initial values of the ability parameters are set with respect to each character, and the numerical values of the initial ability parameters of the character corresponding to the character icon 151 selected by the player are displayed in the ability parameter display portion 152a. In the present embodiment, a higher numerical value of an ability parameter indicates a higher ability.

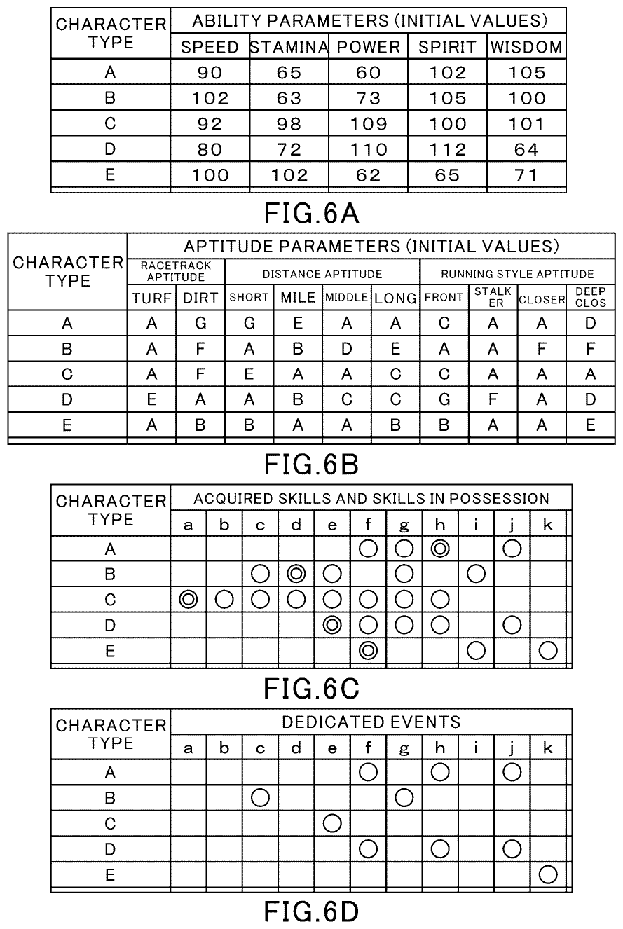

FIG. 6A is a diagram illustrating an ability parameter (initial value) table. In the present embodiment, as illustrated in FIG. 6A, the initial values of the ability parameters are stored with respect to each character in the ability parameter (initial value) table. On the basis of the initial values of the ability parameters stored in the ability parameter (initial value) table, the initial values of the ability parameters are displayed in the ability parameter display portion 152a.

In the present embodiment, an initial value is set for each of multiple ability parameters with respect to each character. Specifically, the ability parameters include a speed ability parameter indicated by “Speed” in the ability parameter display portion 152a, a stamina ability parameter indicated by “Stamina” in the ability parameter display portion 152a, a power ability parameter indicated by “Power” in the ability parameter display portion 152a, a spirit ability parameter indicated by “Spirit” in the ability parameter display portion 152a, and a wisdom ability parameter indicated by “Wisdom” in the ability parameter display portion 152a.

The initial values of the ability parameters of each character may increase by operation of the player, etc. For example, five levels may be set for the character, and the player may be able to increase the level of the character by spending in-game currency or consuming a specified item. In such a case, the initial values of the ability parameters may increase along with the increase in the level of the character. Here, the player can increase the values of the ability parameters in the raising main game. In other words, the objective of the raising main game is to raise a character that has higher numerical values of the ability parameters.

In the present embodiment, the aptitude parameters (initial values) are set for each character, and, as illustrated in FIG. 5A, the initial values of the aptitude parameters of the character corresponding to the character icon 151 selected by the player are displayed in the aptitude parameter display portion 152b.

FIG. 6B is a diagram illustrating an aptitude parameter (initial value) table. In the present embodiment, as illustrated in FIG. 6B, the initial values of the aptitude parameters are stored for each character in the aptitude parameter (initial value) table. The initial value of an aptitude parameter is set to one of seven stages indicated by alphabets A to G. Regarding the initial value of the aptitude parameter, A indicates the highest aptitude and G indicates the lowest aptitude. On the basis of the initial values of the aptitude parameters stored in the aptitude parameter (initial value) table, the initial values of the aptitude parameters are displayed in the aptitude parameter display portion 152b.

In the present embodiment, an initial value of an aptitude parameter is set for each of multiple aptitudes for each character. Specifically, the aptitude parameters include aptitude parameters related to the racetrack aptitudes in turf and dirt racetracks, aptitude parameters related to distance aptitudes for short distance, mile, middle distance, and long distance, and aptitude parameters related to running style aptitudes for front runner, stalker, closer, and deep closer.

In the raising game, the player can have the main character participate in various races. Here, the race develops to the advantage of the player as the aptitudes of the main character fit the content of the race.

Alternatively, the initial values of the aptitude parameters for each character may be increased by spending in-game currency. In addition, the values of the aptitude parameters may change during the raising main game. Furthermore, in the raising main game, an aptitude parameter may sometimes be set to S, which is higher than A.

FIG. 5B is a first diagram illustrating a character detail screen 160. FIG. 5C is a second diagram illustrating the character detail screen 160. When a character icon 151 in the main character select screen 150 is tapped and held, the character detail screen 160 appears on the display 26. The details of the abilities of the character corresponding to the character icon 151 tapped and held in the main character select screen 150 are displayed in the character detail screen 160.

A skill operation portion 161 and an event operation portion 162 are displayed in the center portion of the character detail screen 160. As illustrated in FIG. 5B, when the character detail screen 160 is first displayed, the skill operation portion 161 is highlighted, and the skills of each character are displayed. A skill is an ability that can be activated when specified conditions are established during an individual race or a team race described below. The race develops in favor of that character when skills are activated.

FIG. 6C is a diagram illustrating a skill table. As illustrated in FIG. 6C, the skill table stores skills with respect to each of the characters in the player's possession. In addition, as illustrated in FIG. 5B, skills are displayed in the character detail screen 160 on the basis of the skills stored in the skill table. A skill cannot be activated if that skill is merely held in the player's possession and can only be activated when the skill is acquired. Hereinafter, a skill of the character that can be activated is referred to as an acquired skill.

From the start of the raising main game, one acquired skill is set for the character. In addition, multiple in-possession skills are set for the character in addition to the acquired skill. An in-possession skill is a skill that can be acquired by consuming skill points described below after the start of the raising main game. In other words, an in-possession skill can turn into an acquired skill in exchange for skill points.

In the present embodiment, a skill corresponding to the “double circle symbol” in the skill table illustrated in FIG. 6C is displayed as an acquired skill in the character detail screen 160 illustrated in FIG. 5B. Furthermore, a skill corresponding to the “single circle symbol” in the skill table illustrated in FIG. 6C is displayed as an in-possession skill in the character detail screen 160 illustrated in FIG. 5B. In the present embodiment, as indicated by the character detail screen 160 in FIG. 5B, the acquired skill is highlighted so that the acquired skill can be easily distinguished from the in-possession skills.

FIG. 5B illustrates the case where one acquired skill is displayed in an acquired skill display box 161a and seven in-possession skills are displayed in an in-possession skill display box 161b as the skills provided to each character; however, these features are not limiting. For example, the number of acquired skills and in-possession skills may differ from one character to another. In addition, for example, the number of acquired skills or in-possession skills of each character may be increased by increasing the level of the character, spending in-game currency or items, etc.

When the player taps the event operation portion 162 in the character detail screen 160, as illustrated in FIG. 5C, the content of the character detail screen 160 changes, and a dedicated event display box 162a indicating dedicated events set for each character is displayed. In such a case, as illustrated in FIG. 5C, the event operation portion 162 is highlighted. A dedicated event occurs when specified conditions are established in the raising main game, and involves displaying a story related to characters in the raising game and changing the values of the ability parameters.

FIG. 6D is a diagram illustrating a dedicated event table. As illustrated in FIG. 6D, the dedicated event table stores dedicated events with respect to each character in the player's possession. In addition, as illustrated in FIG. 5C, dedicated events are displayed in the character detail screen 160 on the basis of the dedicated events stored in the dedicated event table. Here, the dedicated events may include a hint event that enables the player to hold a skill in possession or acquire a skill, an ability event that increases or decreases the numerical values of the ability parameters of the character.

The dedicated events displayed in the character detail screen 160 illustrated in FIG. 5C may all be executed during the raising main game or may at least partly be executed during the raising main game, or none of the dedicated event may be executed during the raising main game if specified conditions are not established. In addition, for example, the number of dedicated events provided to each character may be increased by increasing the level of the character, spending in-game currency or items, etc. Alternatively, a dedicated event not displayed as a dedicated event may be executed during the raising main game if specified conditions are established.

As illustrated in FIGS. 5B and 5C, a close operation portion 163 indicated by “close” is displayed in the lower portion of the character detail screen 160. When the close operation portion 163 in the character detail screen 160 is tapped, the display of the character detail screen 160 ends, and the main character select screen 150 is displayed on the display 26.

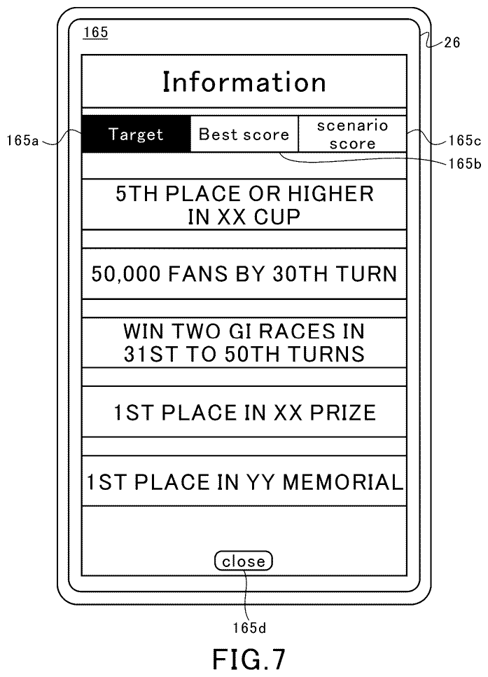

When a return operation portion 153 in the main character select screen 150 illustrated in FIG. 5A is tapped, the home screen 100 illustrated in FIG. 3A is displayed on the display 26. The main character select screen 150 includes a raising information display button 155. When the raising information display button 155 is tapped, a raising information display screen 165 illustrated in FIG. 7 appears. The player can confirm the information regarding the character, which has been selected in the main character select screen 150, in the raising information display screen 165.

FIG. 7 is a first diagram illustrating one example of the raising information display screen 165. The raising information display screen 165 includes a clear target tab 165a, a past score tab 165b, a scenario score tab 165c, and a close operation portion 165d. Here, the goal of the raising game is to raise a stronger raised character by raising the character selected as the main character to be raised from among the characters in the player's possession. The details thereof are described below, but the raising main game involves multiple turns, and the player needs to train the main character or have the main character participate in a race on each turn.

Multiple clear targets are set for each of the characters. When the clear target tab 165a is tapped, a list of clear targets set for the selected character is displayed in the raising information display screen 165. The race in which the main character can participate on a particular turn is predetermined. In addition, the clear targets include having the main character participate in a specified race on a specified turn and win a specified place.

When the main character to be raised participates in a race, the main character can acquire fans. In each race, the base acquisition number of fans is set according to the order of arrival, and the higher the order of arrival, the larger the number of fans acquired. Furthermore, a difficulty level is set for the race, and the higher the difficulty level of the race, the more fans that can be acquired.

Here, the number of fans that can be acquired by participating in the race is calculated by adding a bonus acquisition number to the base acquisition number set according to the order of arrival. Specifically, a correction value is determined on the basis of the race result, and the bonus acquisition number is calculated by multiplying the base acquisition number by the correction value. The total of the bonus acquisition number and the base acquisition number is the number of fans the main character acquires. For example, when first place was won as a race result, the correction value increases as the difference between the main character and the second-place character increases. When the second to fifth place was won as a race result, the correction value increases as the difference between the main character and the first-place character decreases.

During the race, the main character activates skills with a specified probability. The correction value increases as the number of activated skills increases. As such, in each race, the conditions for adding fans are set, and the number of fans acquired increases according to various race results other than the order of arrival and the development during the race. However, the number of fans the main character acquires is at least greater than or equal to the base acquisition number corresponding to the order of arrival.

In some races, the number of fans is specified as a participation condition. When the number of fans acquired by the main character is below the number of fans specified as a participation condition, the player cannot have the main character participate in that race. The number of fans required for participation increases with the increase in the difficulty level of the race. Thus, when the race for which the number of fans is specified as a participation condition is the race subject of the clear target (hereinafter such a race is referred to as a subject race), the main character needs to acquire the number of fans specified for that subject race before the turn on which the subject race is held.

In addition, the clear target includes acquiring a particular number of fans or more before a specified turn. Furthermore, the clear target includes winning first place a specified number of times or more in races of high difficulty levels (for example, GI races) within the range of specified turns, for example. As such, multiple clear targets are set for each character. By achieving the clear targets, the player can keep playing the raising main game until the last turn. Meanwhile, failing to achieve the clear target ends the raising main game on that turn.

Thus, if the number of fans specified for the subject race has not been acquired before the turn on which the subject race is held, the main character cannot participate in the subject race. In such a case, the clear target is not achieved, and the raising game ends.

In the raising main game, since various parameters of the main character increase on each turn, a stronger raised character can be generated by playing a larger number of turns. Thus, in playing the raising main game, the parameters of the main character need to be increased so that all clear targets can be achieved.

Here, basically, the clear targets set for each character are fixed, and the same clear targets are set as the objective every time the raising game is played. Meanwhile, the characters include a character for which clear targets that change according to the progress of the raising main game are set, and a character for which the player can select the clear targets.

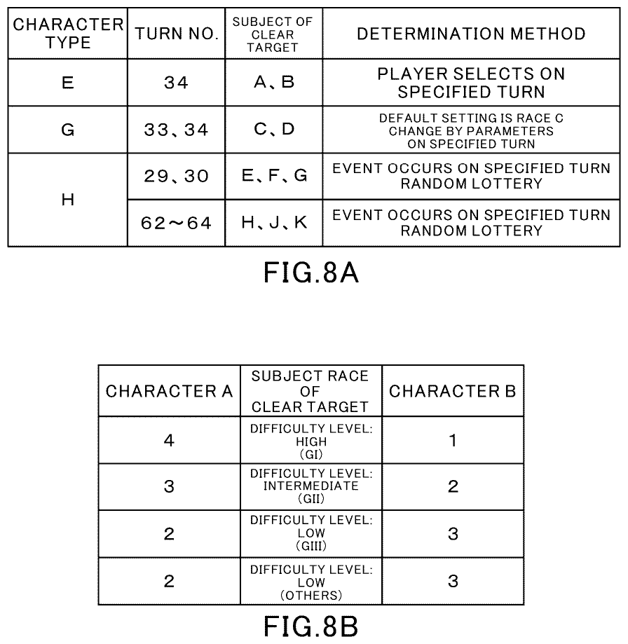

FIG. 8A is a diagram illustrating one example of special clear targets. For example, for a type “E” character, winning a specified place in a race selected by the player from among a race A and a race B is set as the clear target on the 34th turn.

In addition, for a type “G” character, winning a specified place in a race C on the 33rd turn is set as a default clear target. However, when a specified parameter of the main character is below or above the threshold on a predetermined turn before the 33rd turn, the race as the subject of the clear target is changed to a race D on the 34th turn.

For a type “H” character, an event occurs on a specified turn before the 29th turn. In this event, the race serving as the subject of the clear target is determined at random by a lottery from among races E and F on the 29th turn and a race G on the 30th turn. Furthermore, for the type “H” character, an event occurs on a specified turn before the 62nd turn. In this event, the race serving as the subject of the clear target is determined at random by a lottery among a race H on the 62nd turn, a race J on the 63rd turn, and a race K on the 64th turn.

As such, multiple fixed or variable clear targets are set for each character. Depending on the clear targets set for the character, the difficulty level for achieving all clear targets differs from one character to another. Note that, until a variable clear target is determined, an indicator that indicates that the clear target is undetermined is displayed in the raising information display screen 165. Once the clear target is determined, the display of the raising information display screen 165 is updated to let the player know of the determined clear target.

FIG. 8B is a diagram illustrating one example of a clear target set for a character. In the raising main game, there are multiple races from which the player can select. A difficulty level is set for each race, and these multiple races include races with different difficulty levels. The subject race differs for each character, and the number of high difficulty level races set as the subject races differs for each character.

For example, as illustrated in FIG. 8B, four high difficulty level races such as GI races are set as the subject races for the character A. In the same manner, three intermediate difficulty level races such as GII races, two low difficulty level races such as GIII races, and two other low difficulty level races are set as the subject races for the character A. Meanwhile, one high difficulty level race such as a GI race, two intermediate difficulty level races such as GII races, three low difficulty level races such as GIII races, and three other low difficulty level races are set as the subject races for the character B.

Now, suppose that the clear target is to win first place in all of the subject races. In such a case, the character A can be said to have more difficulty achieving all of the clear targets than the character B. Note that the higher the difficulty level of the race, the larger the set number of fans that can be acquired. Thus, the character A acquires more fans than the character B by achieving the clear target.

Meanwhile, the player can have the main character participate in races other than the subject race set for the main character as long as the participation condition is satisfied. The number of subject races for the character B is smaller than that for the character A. On the turn on which a subject race is set, the player must have the main character participate in the subject race.

Thus, the player has more alternatives on each turn for the character B than for the character A. However, when the character B is the main character, the player must have the main character voluntarily participate in a high difficulty level race in order to acquire as many fans as when the character A is the main character. As such, the player is required to deploy different strategies since the difficulty level of the subject race and the number of subject races are designed to be different for each character, making the game more interesting. Here, as illustrated in FIG. 8B, the number of subject races for the clear target can be different for each character, but the number of clear targets is the same for all characters. Thus, for example, for a character with fewer clear targets, such as winning a specified place in a subject race, a larger number of clear targets, such as acquiring a specified number of fans before a specified turn, are set. Here, the number of clear targets may differ from one character to another.

In the raising information display screen 165 illustrated in FIG. 7, clear targets set for the selected character can be confirmed. When the past score tab 165b in the raising information display screen 165 is tapped, the information on the raised characters having top three scores generated on the basis of the selected character is displayed in the raising information display screen 165.

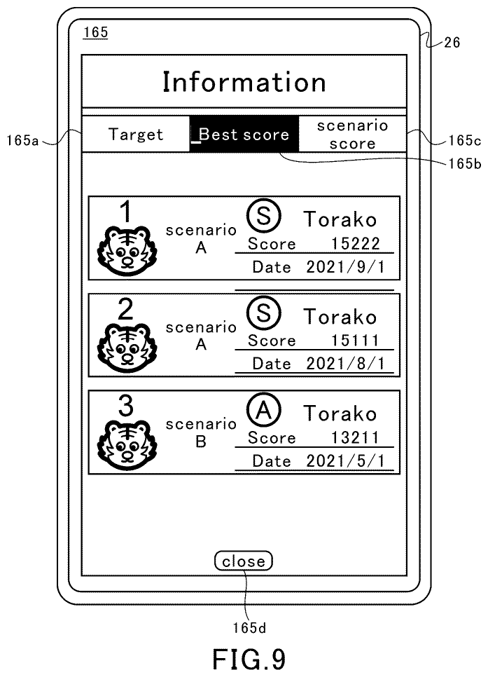

FIG. 9 is a second diagram illustrating one example of the raising information display screen 165. When the raising game ends, a raised character is generated. At the end of the raising game, the score is calculated for the raised character, and the raising rank is derived on the basis of the score. The score is calculated from a preset calculation formula that involves the points calculated from various parameters of the main character at the end of the raising, the points calculated from the acquired skills, etc. In the raising information display screen 165, information indicating the rank, the score, the name, and the registration date of three raised characters with three highest scores among the raised characters that have been raised on the basis of the selected character are displayed.

Although the detailed descriptions are omitted, multiple scenarios are provided for the raising game. The basic game specifications are common to all scenarios, but some functions are different between the scenarios. As illustrated in FIG. 9, a scenario selected in raising each of the raised characters is displayed in the raising information display screen 165. Although not illustrated in the drawing, when the scenario score tab 165c is tapped, three raised characters with three highest scores are displayed with respect to each scenario.

As described above, the player can select the main character while confirming various types of information regarding each character in the main character select screen 150 illustrated in FIG. 5A. When the next operation portion 154 in the main character select screen 150 is tapped, the selected character is set as the main character, and an inheritance character select screen 170 is displayed on the display 26.

### <Registration of Inheritance Characters>

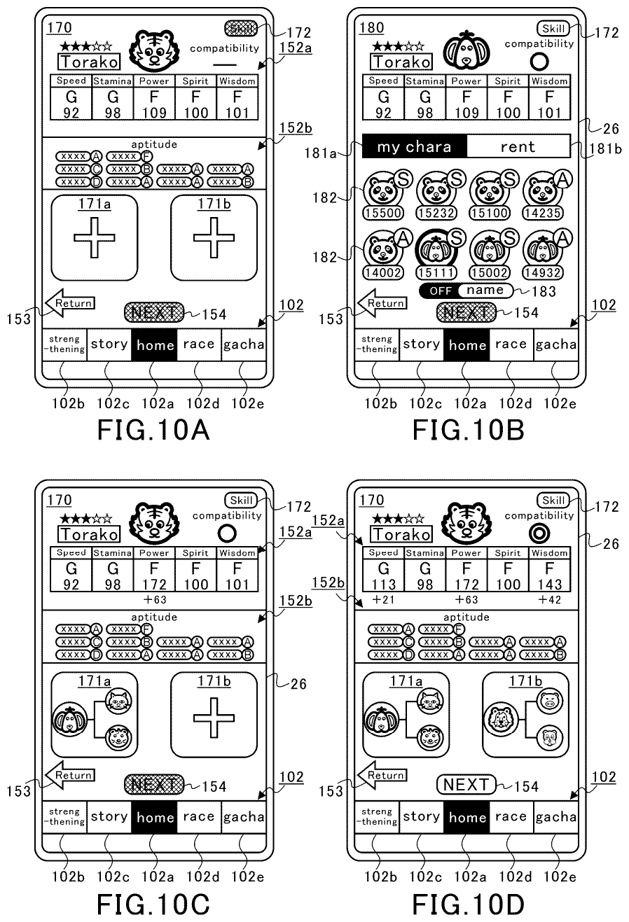

FIG. 10A is a first diagram illustrating the inheritance character select screen 170. FIG. 10B is a first diagram illustrating a raised character list screen 180. FIG. 10C is a second diagram illustrating the inheritance character select screen 170. FIG. 10D is a third diagram illustrating the inheritance character select screen 170. The inheritance character select screen 170 is a screen that allows the player to register inheritance characters.

An inheritance character is a character that passes on ability values, skills, etc., to the main character. The player can select two inheritance characters from among the raised characters in the player's possession and representative characters of other players extracted according to specified extraction conditions, such as a representative character of a friend such as a follower, and the selected inheritance characters can be formed into a deck and registered. Note that only one of the representative characters of other players can be formed into a deck as an inheritance character in one raising game.

The inheritance character select screen 170 includes the ability parameter display portion 152a, the aptitude parameter display portion 152b, a first inheritance character select region 171a, and a second inheritance character select region 171b. When the screen transitions from the main character select screen 150 to the inheritance character select screen 170, as illustrated in FIG. 10A, the first inheritance character select region 171a and the second inheritance character select region 171b are displayed as blanks.

When the first inheritance character select region 171a or the second inheritance character select region 171b is tapped, the raised character list screen 180 illustrated in FIG. 10B appears. The raised character list screen 180 includes a my character tab 181a and a rental tab 181b. A raised character list display region is provided below the my character tab 181a and the rental tab 181b. Raised character icons 182 are displayed in the raised character list display region.

In a state where the my character tab 181a is selected, as illustrated in FIG. 10B, raised character icons 182 corresponding to the raised characters in the player's possession are displayed. Although not illustrated in the drawing, in a state where the rental tab 181b is selected, raised character icons 182 corresponding to representative characters of friends, in other words, raised characters raised by friends, are displayed.

When a raised character icon 182 is tapped, a raised character corresponding to that raised character icon 182 assumes a temporary selected state. When a raised character icon 182 is tapped, as illustrated in FIG. 10C, the inheritance character select screen 170 appears. Here, for example, when the first inheritance character select region 171a is tapped and the raised character list screen 180 is displayed and a raised character icon 182 in the raised character list screen 180 is tapped, an image indicating the raised character in a temporary selected state is displayed in the first inheritance character select region 171a.

In this state, for example, when the second inheritance character select region 171b is tapped and the raised character list screen 180 is displayed and a raised character icon 182 in the raised character list screen 180 is tapped, an image indicating the raised character in a temporary selected state is displayed in the second inheritance character select region 171b as illustrated in FIG. 10D.

A raised character is linked with information regarding the inheritance characters used in raising, and stored. Information regarding the inheritance characters used in raising the raised character is displayed in the first inheritance character select region 171a.

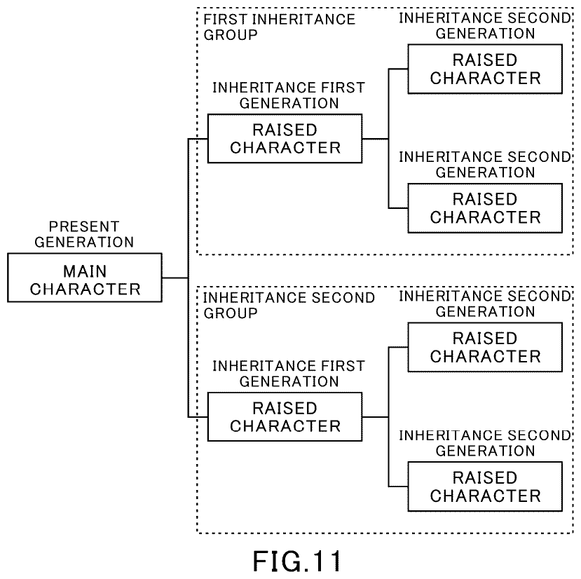

FIG. 11 is a diagram illustrating the lineage of inheritance. In the raising game, various effects such as the increase in ability parameters and aptitude parameters of the main character are brought about on the basis of factor information of the inheritance characters. Here, two inheritance characters are set for one main character, and these inheritance characters are raised characters that have been previously generated. Thus, when a raised character set as an inheritance character was generated, two inheritance characters were also set for that raised character.

As illustrated in FIG. 11, the main character to be raised in the raising main game about to start is assumed to be the present generation. Two raised characters set as the inheritance characters for that main character are assumed to be the inheritance first generation. Furthermore, for each of the raised characters of the inheritance first generation, two raised characters are set as the inheritance characters at the start of the raising. Two raised characters set as the inheritance characters when a raised character of the inheritance first generation is generated are assumed to be the inheritance second generation.

In such a case, the raised characters of the inheritance first generation and the inheritance second generation have effects on the main character of the present generation, as illustrated in FIG. 11. As described above, since two inheritance characters (inheritance first generation) are set for one main character, a total of six raised characters have effects on one main character.

For example, a first inheritance group is constituted by one of the two inheritance first generation raised characters and two inheritance second generation raised characters, which are the inheritance characters of this raised character. In the same manner, a second inheritance group is constituted by the other one of the two inheritance first generation raised characters and two inheritance second generation raised characters, which are the inheritance characters of this raised character.

As illustrated in FIG. 10D, icons corresponding to one inheritance first generation raised character and two inheritance second generation raised characters constituting the first inheritance group are indicated in the first inheritance character select region 171a. In the same manner, icons corresponding to the one inheritance first generation raised character and two inheritance second generation raised characters constituting the second inheritance group are indicated in the second inheritance character select region 171b.

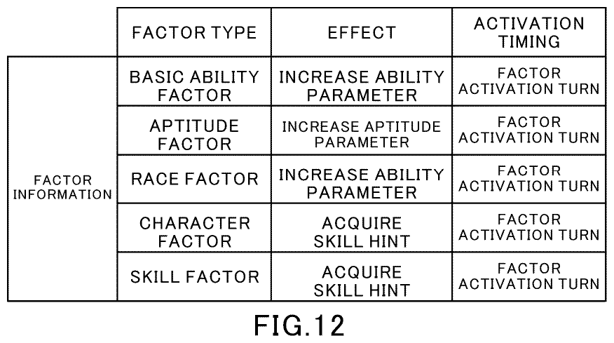

FIG. 12 is a diagram illustrating factor information. Although the details are described below, when the raising game is completed, the main character subjected to raising is registered as a raised character, and this raised character is linked with factor information and stored. Specifically, upon completion of raising of the raised character, the factor to be acquired by the raised character is determined by a lottery. Then the factor information indicating the factor won by the lottery is linked with the raised character. In other words, upon completion of the raising game, the raised character can acquire a factor won by a lottery.

However, the factor acquired by the raised character does not affect the ability of this raised character itself. For example, the raised character can participate in a race game such as a team competition game. Here, simulation, i.e., computation, that determines the order of arrival, the race development, etc., is performed on the basis of the ability parameters, the aptitude parameters, and the acquired skills of all raised characters participating in the race. The factors that the raised character has are not used in the computation; thus, even if the raised character holds many factors, the race does not proceed in favor of the raised character.

The factors that the raised character has affect the main character to be raised only when this raised character is set as an inheritance character. The factors that the raised character can acquire are categorized into multiple types. FIG. 12 shows a basic ability factor, an aptitude factor, a race factor, a character factor, and a skill factor as the factor types. For each factor, one of multiple levels is set. Here, as the levels of the factor, three factor levels are set: level 1, level 2, and level 3.

The factor level is determined by a lottery. Here, after the factors to be acquired by the raised character are determined, the factor level may be determined by a lottery for each of the acquired factors. Alternatively, the winning ratio may be set with respect to each combination pattern of a factor and a factor level, and one combination pattern may be determined on the basis of the set winning ratio. In such a case, the acquired factor and the factor level are determined simultaneously.

Regarding the factor level, level 3 has the highest effect, and level 1 has the lowest effect. In the lottery that determines the factor level, the winning probability for level 3 is set to be the lowest, and the winning probability for level 1 is set to be the highest. However, the winning probability of the factor to be acquired and the winning probability of the factor level may change depending on the results of the raising game. In such a case, for example, a high factor level may be determined for a raised character with high ability parameters or high scores.

The basic ability factor increases the ability parameters of the main character. There are five basic ability factors: a speed factor, a stamina factor, a power factor, a spirit factor, and a wisdom factor. The raised character always acquires one basic ability factor out of five basic ability factors. The five basic ability factors respectively correspond to five ability parameters, i.e., speed, stamina, power, spirit, and wisdom. For example, when the raised character of the inheritance first generation or inheritance second generation has a speed factor, the speed ability parameter of the main character increases.

Here, the value of increase in speed ability parameter changes depending on the factor level of the speed factor. For example, the speed ability parameter of the main character increases by “7” when the factor level of the speed factor is level 1, increases by “13” when the factor level is level 2, and increases by “21” when the factor level is level 3. Thus, when all of a total of six raised characters, that is, two inheritance first generation raised characters and four inheritance second generation raised characters, have a level 3 speed factor, the speed ability parameter of the main character increases by 126 (the value of increase 21×6) at most.

However, the activation timing and the activation conditions are set for each factor. Thus, even if an inheritance character has a factor, the factor does not have an effect on the main character if the activation conditions are not established at the activation timing.

As described above, the raising main game is constituted by multiple turns, and of these turns, specified turns are set as the factor activation turns. For example, suppose that three turns, namely, the first, 30th, and 54th turns, in the raising main game have been set as the factor activation turns. On these factor activation turns, whether activation occurs is determined for each factor, and when it is determined that the factor is to be activated, the activation condition of this factor is established, and the effect corresponding to the factor is brought about.

Here, whether a basic ability factor is activated or not is determined by a lottery. The probability of winning the lottery of whether the basic ability factor is to be activated or not, that is, the probability of activating the basic ability factor (hereinafter referred to as the activation probability), may differ among three factor activation turns. Here, on the first turn, the basic ability factor activation probability is set to 100% irrespective of the factor level. On the 30th and 54th turns, the basic ability factor activation probability is different depending on the factor level. For example, on the 30th and 54th turns, the basic ability factor activation probability is set to 100% for level 3, the basic ability factor activation probability is set to 90% for level 2, and the basic ability factor activation probability is set to 80% for level 1.

A value by which the ability parameter increases on the first turn is displayed in the inheritance character select screen 170. For example, in FIG. 10C, one inheritance character constituting the first inheritance group is temporarily selected. In this case, the type of the ability parameter that increases on the first turn and the value of increase thereof by the temporarily selected one inheritance character are displayed. Here, “+63” is displayed below the power ability parameter, which indicates that the power ability parameter increases by 63 points during the first turn. In addition, in the ability parameter display portion 152a, the sum that includes the value of increase on the first turn is displayed.

In FIG. 10D, two inheritance characters constituting the first inheritance group and the second inheritance group are temporarily selected. In this case, the types of the ability parameters that increase on the first turn and the values of increase thereof by the temporarily selected two inheritance characters are displayed. Here, “+21”, “+63”, and “+42” are respectively displayed under the speed, power, and wisdom ability parameters, which indicates that the speed, power, and wisdom ability parameters respectively increase by 21 points, 63 points, and 42 points on the first turn.

In the inheritance character select screen 170, the value of increase in the ability parameter increased by the inheritance character constituting the first inheritance group and the value of increase in ability parameter increased by the inheritance character constituting the second inheritance group are displayed so as to be distinguishable from one another. For example, in FIG. 10D, the indication “+63” displayed under the power ability parameter and the indications “+21” and “+42” displayed under the speed and wisdom ability parameters are distinguished by color.

The aptitude factors illustrated in FIG. 12 increase the aptitude parameters of the main character. There are six aptitude factors: a turf factor, a dirt factor, a short distance factor, a mile factor, a middle distance factor, and a long distance factor. The raised character invariably acquires one aptitude factor out of six aptitude factors. The six aptitude factors respectively correspond to a turf aptitude, a dirt aptitude, a short distance aptitude, a mile aptitude, an intermediate aptitude, and a long distance aptitude. For example, when a raised character having a turf factor is included in the inheritance first generation or the inheritance second generation, the aptitude parameter of the main character for the turf aptitude increases.

Here, the activation timing and the activation condition are set also for the aptitude factors, and whether activation occurs is determined for each aptitude factor on the same factor activation turn as the basic ability factor. When activation of the aptitude factor is determined, the corresponding aptitude factor increases by one level. In one example, on the first turn, the aptitude factor activation probability is set to 100% irrespective of the factor level.

For example, suppose that the three raised characters belonging to the first inheritance group respectively have a turf factor, a short distance factor, and a mile factor and that the three raised characters belonging to the second inheritance group respectively have a turf factor, a short distance factor, and a middle distance factor. In such a case, the turf aptitude and the short distance aptitude of the main character each increase by two levels, and the mile aptitude and the middle distance aptitude of the main character each increase by one level.

Furthermore, for example, suppose that the three raised characters belonging to the first inheritance group all have a turf factor and that the three raised characters belonging to the second inheritance group all have a short distance factor. In such a case, the turf aptitude and the short distance aptitude of the main character each increase by three levels. In another example, suppose that the three raised characters belonging to the first inheritance group all have a turf factor and that the three raised characters belonging to the second inheritance group respectively have a turf factor, a short distance factor, and a mile factor. In such a case, the turf aptitude of the main character increases by four levels, and the short distance aptitude and the mile aptitude of the main character each increase by one level.

However, on the first turn, a limit is set to the value of increase in aptitude parameter. Specifically, on the first turn, the upper limit is set to A for all of the aptitude parameters. Thus, if the initial value of the turf aptitude of the main character is A, the turf aptitude does not increase on the first turn even when an inheritance character has a turf factor.

In contrast, on the 30th turn and the 54th turn, a lottery of whether the aptitude factor is activated or not is conducted on the basis of the factor level for each aptitude factor. In one example, on the 30th and 54th turns, the aptitude factor activation probability is set to 5% for level 3, the aptitude factor activation probability is set to 3% for level 2, and the aptitude factor activation probability is set to 1% for level 1. When activation of the aptitude factor is determined by a lottery on the 30th turn and the 54th turn, the aptitude parameters corresponding to the aptitude factors increase. On the 30th turn and the 54th turn, the upper limit is elevated from A to S for each aptitude. Thus, on the 30th turn and the 54th turn, the value of the aptitude parameter can be increased to S by activating the aptitude factor.

A value of the aptitude parameter after the increase on the first turn is displayed in the aptitude parameter display portion 152b in the inheritance character select screen 170.

A race factor increases the ability parameter of the main character. The race factor is provided for high difficulty level races (hereinafter referred to as factor subject races) such as GI among the races that the main character can participate in the raising main game. When the raising game is completed, a lottery of whether a race factor is acquired or not is conducted for each factor subject race in which the main character won first place. By winning this lottery, the raised character can acquire a race factor.

A factor level is also set for the race factor, and the factor level is determined by a lottery for each of the race factors to be acquired. Here, the number of race factors that one raised character can acquire is not limited, and the raised character can acquire multiple race factors.

The ability parameter to be increased by activation and the value of increase thereof are preliminarily set for each of the race factors. For example, the race factors include a factor that increases the speed ability parameter and a factor that increases the power ability parameter. Here, the value of increase in ability parameter increases as the factor level increases.

The activation timing and the activation condition are set also for the race factors, and whether activation occurs is determined for each race factor on the factor activation turn. When activation of the race factor is determined, the ability parameter corresponding to that race factor increases. Here, the factor activation turns for the race factors are limited to the 30th turn and the 54th turn. Moreover, the activation probability of the race factor on the factor activation turn differs depending on the factor level, and the higher the factor level, the higher the activation probability.

A character factor is a factor unique to the character and, for example, only when a character strengthened to a specified level is raised as the main character, a character factor set for this character is invariably given to the raised character at the completion of the raising game. Here, since only one character factor is set for one character, the number of character factor that one raised character can acquire is 1 at most. When a raised character is generated on the basis of a character not strengthened to a specified level, the character factor cannot be acquired.

The character factor can be activated on the preliminarily set factor activation turn, and is activated by winning a lottery conducted on the factor activation turn. When the character factor is activated, a hint event set for each character factor is generated, and, as described above, a hint for the skill can be acquired.

Skill factors are given on the basis of the acquired skills acquired by the raised character. Specifically, at the completion of the raising game, a lottery of whether a skill factor is acquired or not is conducted for each of the acquired skills acquired by the raised character. By winning this lottery, the skill factor is given to the raised character. In other words, the raised character can acquire some or all of the skill factors that correspond to the acquired skills. When acquisition of a skill factor is determined, the factor level of this skill factor is determined by a lottery.

The skill factor can be activated on the preliminarily set factor activation turn, and is activated by winning a lottery conducted on the factor activation turn. Here, the higher the factor level, the higher the winning probability. When the skill factor is activated, a hint event set for each skill factor is generated, and a hint for the skill can be acquired. In this manner, the main character can acquire the same skills as the acquired skills acquired by the inheritance characters.

As such, whether a skill factor is acquired is determined within the range of the acquired skills acquired by the raised character. Thus, the possibility of acquiring a skill factor increases when the raised character has many acquired skills. However, since acquisition of the skill factors is determined by a lottery, skill factors cannot always be obtained despite a large number of acquired skills.

As such, the ability parameters of the main character change prominently by the inheritance characters in the deck. Moreover, even when the ability of the raised character itself is high, since acquisition of a factor is determined by a lottery, a raised character with a high ability is not necessarily preferable as an inheritance character. Meanwhile, even when a raised character itself does not have a high ability, the raised character may effectively function as an inheritance character by acquiring a large number of factors of high factor levels. As such, since it is possible to form a deck using the inheritance characters, not only the fun of simply raising a strong raised character but also the fun of raising a raised character effective as an inheritance character is introduced.

Furthermore, in this embodiment, compatibility between the main character, the inheritance first generation raised characters, and the inheritance second generation raised characters is judged. A combination of characters with good compatibility brings advantageous factor activation conditions.

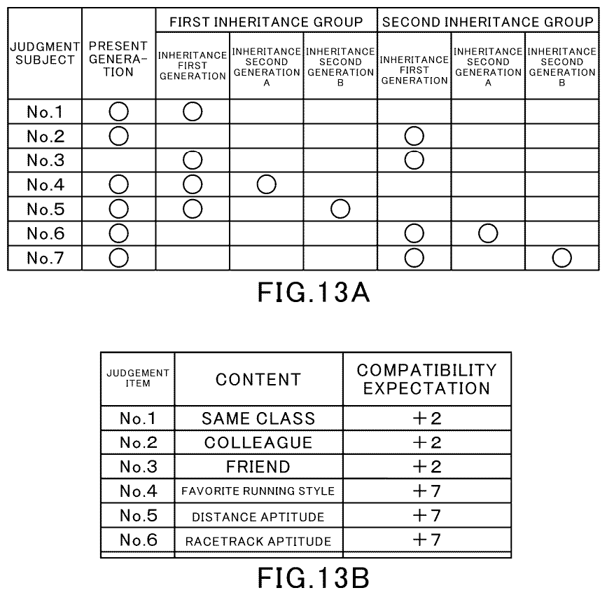

FIG. 13A is a diagram illustrating compatibility judgment subjects, and FIG. 13B is a diagram illustrating compatibility judgment items. As illustrated in FIG. 13A, in this embodiment, there are seven judgment subjects: Nos. 1 to 7. A first judgement subject (No. 1) is a main character of the present generation and a raised character of the inheritance first generation in the first inheritance group. A second judgement subject (No. 2) is a main character of the present generation and a raised character of the inheritance first generation in the second inheritance group.

A third judgement subject (No. 3) is a raised character of the inheritance first generation in the first inheritance group and a raised character of the inheritance first generation in the second inheritance group. A fourth judgement subject (No. 4) is a main character of the present generation, a raised character of the inheritance first generation in the first inheritance group, and one (raised character A) of raised characters of the inheritance second generation in the first inheritance group. A fifth judgement subject (No. 5) is a main character of the present generation, a raised character of the inheritance first generation in the first inheritance group, and the other (raised character B) of raised characters of the inheritance second generation in the first inheritance group.

A sixth judgement subject (No. 6) is a main character of the present generation, a raised character of the inheritance first generation in the second inheritance group, and one (raised character A) of raised characters of the inheritance second generation in the second inheritance group. A seventh judgement subject (No. 7) is a main character of the present generation, a raised character of the inheritance first generation in the second inheritance group, and the other (raised character B) of raised characters of the inheritance second generation in the second inheritance group.

Whether the condition is established for each of the multiple judgment items is judged with respect to each of the judgment subjects described above. FIG. 13B illustrates examples of the judgment items. In this embodiment, the game worldview is set such that characters that can be selected as the main character are students and that these characters undergo training in school.

Furthermore, as illustrated in FIG. 13B, settings such as grade, colleague, friend, etc., are preliminarily given to each of the characters. For example, the judgment items include such contents as whether or not the two or three characters of the judgment subject are in the same grade, are colleagues, or are friends. Furthermore, the judgment items include whether or not the character's favorite running style, the distance aptitude, and the racetrack aptitude are compatible.

Each of the judgment items is linked with a compatibility expectation, and the compatibility expectations of the judgment items established between the characters of the judgment subject are totaled. Here, the compatibility expectation differs for each judgment item; alternatively, the compatibility expectation may be the same for all of the judgment items.

For example, in judging the compatibility, whether or not the judgment items are established are judged for all of the judgment items between the main character of the present generation and the raised characters of the inheritance first generation in the first inheritance group designated as the first judgment subject. Here, the compatibility expectations linked with the established judgment items are totaled and counted. As such, the compatibility expectations are sequentially counted starting from the first judgment subject to the seventh judgment subject, and the activation probability of the factor is corrected on the basis of the final compatibility expectation. That is, the higher the compatibility expectation, the higher the activation probability of all factors, and the lower the compatibility expectation, the lower the activation probability of all factors.

Alternatively, the activation probability may be calculated by using the calculated compatibility expectation as a correction value. Alternatively, for example, the correction value for correcting the factor activation probability may be set with respect to each compatibility level, and the compatibility level may be determined from the calculated compatibility expectation.

As such, since the factor activation probability changes depending on the compatibility between the main character and the inheritance characters or the compatibility between the inheritance characters, the combination of two inheritance characters significantly affects the raising of the main character. In other words, the compatibility between characters is critical in selecting inheritance characters.

As illustrated in FIGS. 10B, 10C, and 10D, in a state where the inheritance characters are selected, a compatibility indicator that indicates the degree of compatibility is displayed in the upper right portion of the inheritance character select screen 170 and the raised character list screen 180. Here, the compatibility level for the selected character is indicated by three compatibility indicators: double circle symbol, single circle symbol, and triangle symbol. As illustrated in FIG. 10A, in a state where no inheritance character is selected, the compatibility indicator is not displayed.

As illustrated in FIG. 10B, the raised character list screen 180 includes a display switch button 183. When the display switch button 183 is operated, a display condition setting screen not illustrated in the drawing appears. In the display condition setting screen, the player can change settings to sort and narrow-down the raised character icons 182 to be displayed in the raised character list screen 180, that is, the raised characters that can be selected as the inheritance characters.

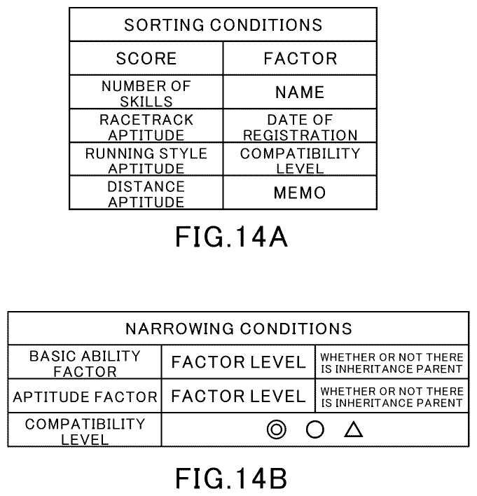

FIG. 14A is a diagram illustrating sorting conditions. FIG. 14B is a diagram illustrating narrowing conditions. In the display condition setting screen, the player can select and set the sorting conditions illustrated in FIG. 14A. Here, one selected from score, factor, number of skills, name, racetrack aptitude, registration date, running style aptitude, compatibility level, distance aptitude, and memorandum can be set as a sorting condition. Once the sorting condition is set, the raised character list screen 180 is displayed. Here, in the raised character list screen 180, the order in which the raised character icons 182 are displayed is changed according to the sorting condition.

In the display condition setting screen, the player can select and set the narrowing conditions illustrated in FIG. 14B. Here, basic ability factor, aptitude factor, and compatibility level are provided as the narrowing conditions. Note that, when the basic ability factor or the aptitude factor is set as the narrowing condition, only the raised characters that have the factor selected by the player are displayed in the raised character list screen 180.

Here, the player can set the factor level; for example, when narrowing is performed by setting the factor level to level 3, only the raised characters that have level 3 factors from among the factors selected by the player are displayed in the raised character list screen 180. The player can also narrow down the raised characters by selecting whether or not it is the raised character itself or the inheritance character of that raised character that has that factor.

In addition, the player can use the compatibility level for the narrowing. Here, it is possible to narrow down raised characters to those with double-circle compatibility, those with single-circle compatibility, or those with triangle compatibility. Thus, sorting and narrowing are possible by using various conditions, and this improves the convenience of the player.

When a raised character icon 182 in the raised character list screen 180 illustrated in FIG. 10B is tapped and held, detail information of the raised character corresponding to this raised character icon 182 is displayed.

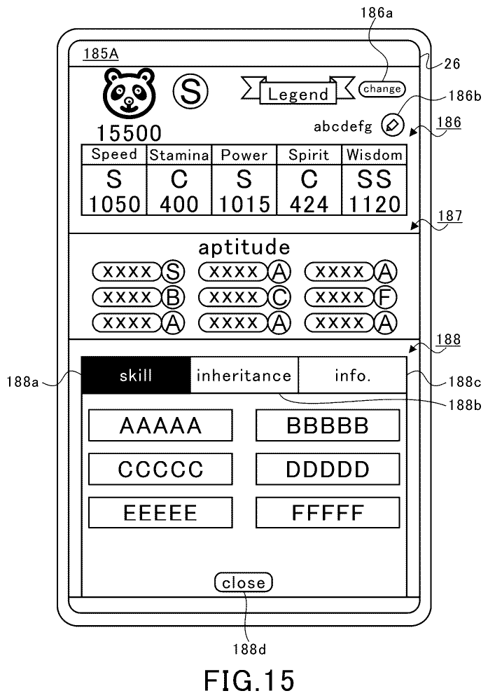

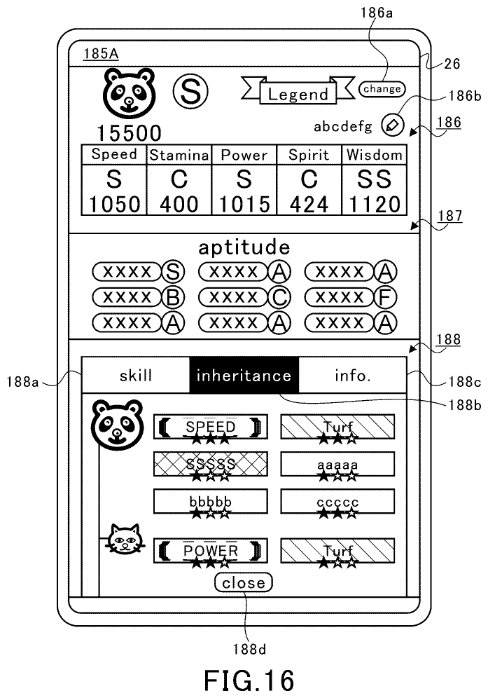

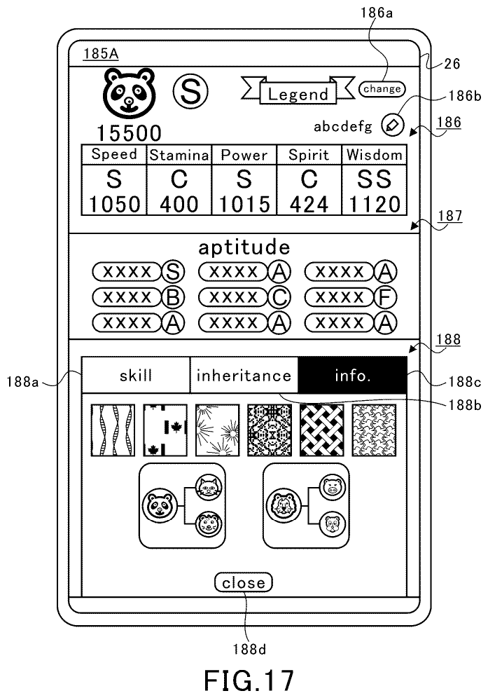

FIG. 15 is a first diagram illustrating a character detail dialogue 185A. FIG. 16 is a second diagram illustrating the character detail dialogue 185A. FIG. 17 is a third diagram illustrating the character detail dialogue 185A. The character detail dialogue 185A displays detail information of the raised character. An ability parameter display box 186 indicating the ability parameters of the raised character is displayed in the upper portion of the character detail dialogue 185A.

An icon indicating a character used as the base of the raised character and the score and the raising rank of the raised character are indicated above the left side of the ability parameter display box 186. In addition, a nickname change button 186a and a memo input button 186b are provided above the right side of the ability parameter display box 186. When the nickname change button 186a is tapped, a nickname list screen not illustrated in the drawing appears. A list of nicknames that the raised character has acquired is displayed in the nickname list screen. Note that, in the raising main game, many nicknames are provided, and acquisition conditions are set with respect to all of the nicknames.

In the raising main game, a nickname for which the acquisition condition is satisfied is given to the raised character. The player can select one nickname from the nicknames that the raised character has acquired, and set that nickname for that raised character. The player can change the nickname set for the raised character through the nickname list screen. A currently set nickname (Legend in this case) is displayed on the left side of the nickname change button 186a. Here, examples of the condition for acquiring a nickname include that the main character acquires a specified number of fans, that the ability parameter or aptitude parameter is equal to or higher than a specified value, that a specified skill is acquired, that the number of races won is equal to or higher than a specified value, and that a specified place (for example, first place) is won in a specified race.

When the memo input button 186b is tapped, a text input screen not illustrated in the drawing appears. In the text input screen, for example, nine or less characters such as hiragana, katakana, numerals, and alphabets can be input. The text input through the text input screen is linked with the raised character and stored as a memo. When a memo is stored for a raised character, the memo (abcdefg in this case) is displayed on the left side of the memo input button 186b.

The aforementioned memo is included in the conditions for sorting the raised character icons 182 in the raised character list screen 180. Thus, the player can more easily search for a raised character to be used as an inheritance character by registering the raised character linked with a memo.

An aptitude information display box 187 is displayed below the ability parameter display box 186. In the aptitude information display box 187, aptitude parameters related to the racetrack aptitudes for turf and dirt, aptitude parameters related to distance aptitudes for short distance, mile, middle distance, and long distance, and aptitude parameters related to the running style aptitudes for front runner, stalker, closer, and deep closer are displayed.

A various information display box 188 is displayed below the aptitude information display box 187. The various information display box 188 includes a skill display tab 188a, an inheritance information display tab 188b, a raising information display tab 188c, and a close operation portion 188d. When the skill display tab 188a is tapped, as illustrated in FIG. 15, the acquired skills of the raised character are displayed in the various information display box 188. When the inheritance information display tab 188b is tapped, as illustrated in FIG. 16, the inheritance information of the raised character is displayed.

The inheritance information is displayed in the various information display box 188 on the basis of the raised characters that can be set as inheritance characters and the inheritance characters used to raise the raised characters. The inheritance information includes information about inheritance characters used in raising the raised character, factor information about the factors that the raised character has, and factor information about the factors that the inheritance characters have. Here, a list indicating the inheritance information is displayed with respect to each raised character.

Specifically, the factor information linked with the raised character and the factor information linked with the inheritance characters of that raised character are displayed with respect to each character. Thus, by scrolling the various information display box 188 in the vertical directions, the player can confirm the factor information that the three characters have.

In the various information display box 188, the basic ability factors, the aptitude factors, and the character factors are color-coded and displayed. For example, the basic ability factors are indicated in blue, the aptitude factors are indicated in red, and the character factors are indicated in green. In the various information display box 188, the race factors and the skill factors are indicated in white. Moreover, stars that indicate the factor level are superposed and displayed with the factor information.

When the raising information display tab 188c is tapped, as illustrated in FIG. 17, the raising information of the raised character appears. The raising information includes the types of the support cards used in raising the raised character, the characters of the inheritance first generation and the inheritance second generation, the record of individual races in the raising game, and the score.

As such, the player can confirm various information about the raised character through the character detail dialogue 185A. Thus, the player can easily access the information linked with the inheritance characters to be included in the deck, and the convenience of the player can be improved.

When the close operation portion 188d in the character detail dialogue 185A is tapped, the character detail dialogue 185A closes, and the raised character list screen 180 is displayed on the display 26. As illustrated in FIGS. 10A, 10B, 10C, and 10D, a skill display button 172 is provided on the upper right side of the inheritance character select screen 170 and the raised character list screen 180. When the skill display button 172 is tapped, a list of skills that the raised character temporarily selected as an inheritance character can acquire is displayed.

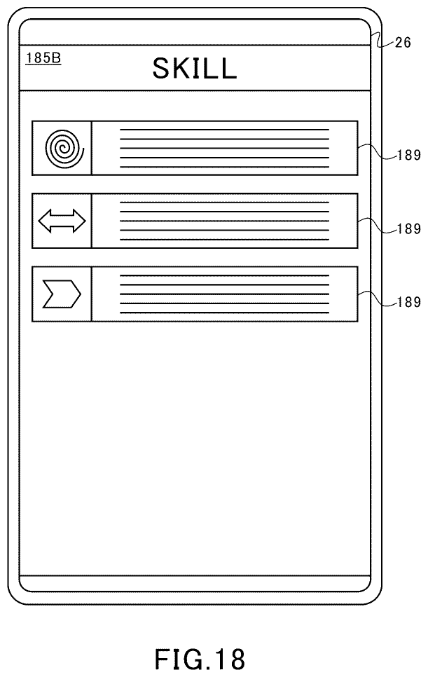

FIG. 18 is a diagram illustrating a skill display dialogue 185B. In the skill display dialogue 185B, skill description display boxes 189 in which an icon corresponding to a skill and the content of the skill are indicated are displayed. The skills indicated in the skill description display boxes 189 are displayed as a list of all skills that can be acquired by the main character when the currently selected raised character is used as an inheritance character.

In other words, in the skill display dialogue 185B, a list of information regarding the skills linked with the character factor or skill factors of the raised character is displayed. As illustrated in FIG. 10C, when the skill display button 172 is tapped in the state where one raised character is selected as an inheritance character, skills linked with the character factor and the race factors of this one raised character (inheritance character) are displayed in the skill display dialogue 185B.

Meanwhile, as illustrated in FIG. 10D, when the skill display button 172 is tapped in the state where two raised characters are selected as inheritance characters, skills linked with the character factors and the race factors of the two raised characters (inheritance characters) are displayed in the skill display dialogue 185B.

As described above, in this embodiment, the inheritance information (factor information) is listed and displayed in the character detail dialogue 185A with respect to each of the raised characters that can be set as inheritance characters. In the skill display dialogue 185B, the information (skills) linked with the inheritance information (factor information) is listed and displayed. Here, the character detail dialogue 185A and the skill display dialogue 185B are displayed on the basis of the raised characters that can be set as inheritance characters and the inheritance characters used in generating the raised characters. The convenience of the player is improved by the display of the character detail dialogue 185A and the skill display dialogue 185B.

Here, the skills that can be acquired by activation of the factors are displayed in the skill display dialogue 185B. Alternatively, instead of the information about the skills, the factor information from which a hint for the skills is obtained may be displayed in the skill display dialogue 185B. In any case, it is preferable that the inheritance information (factor information) be categorized into multiple types (factor types) and the inheritance information (character factor and race factors) categorized into a specified type or information (information about skills) linked with the inheritance information be displayed in the skill display dialogue 185B. As such, it can be said that some of the inheritance information is extracted and then the display regarding the extracted information is presented in the skill display dialogue 185B.

When two raised characters are in a temporary selected state, the next operation portion 154 in the inheritance character select screen 170 is enabled. When the enabled next operation portion 154 is tapped, the raised characters in a temporary selected state are temporarily registered in the deck as the inheritance characters, and a support card formation screen 190 described below is displayed.

The player must always select, in the inheritance character select screen 170, two raised characters as the inheritance characters. When two inheritance characters are not in a temporary selected state, as illustrated in FIGS. 10A and 10C, the next operation portion 154 is grayed out and does not accept operation by the player. Moreover, the inheritance character select screen 170 includes the return operation portion 153, and when the return operation portion 153 is tapped, the main character select screen 150 appears.

### <Registration of Support Cards>

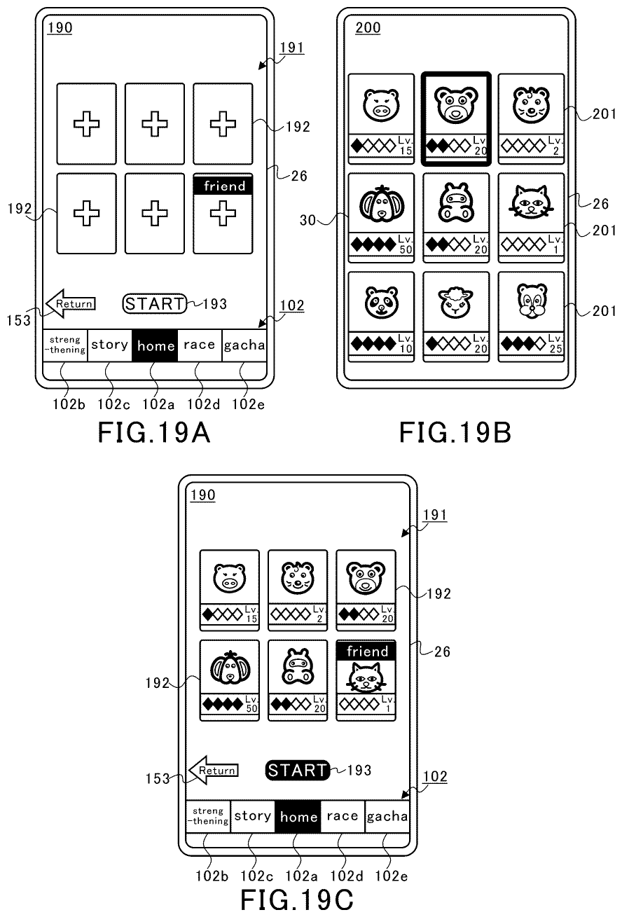

FIG. 19A is a first diagram illustrating the support card formation screen 190. When two inheritance characters are registered in the inheritance character select screen 170, the support card formation screen 190 illustrated in FIG. 19A is displayed. A support card display region 191 is provided in the center portion of the support card formation screen 190. The support card display region 191 includes multiple support card display panes 192. A return operation portion 153 indicated by “Return” and a start operation portion 193 indicated by “START” are displayed in a lower portion of the support card formation screen 190.

Multiple (six here) support card display panes 192 are displayed in the support card display region 191. The number of support card display panes 192 displayed is the same as the number of the support cards that the player can set. In the initial state of displaying the support card formation screen 190, the support card display panes 192 are blank.

In this embodiment, the player can set six types of support cards in the deck. Of the six types that the player can set, some (for example, five types) can be selected from the support cards in the player's possession. Of the six types that the player can set, some of others (for example, one type) can be selected from the support cards that other players, such as friends, set as rental cards.

FIG. 19B is a diagram illustrating a support card select screen 200. In the support card formation screen 190 illustrated in FIG. 19A, when a support card display pane 192 (excluding the support card display pane 192 displayed on the lower right side) is tapped, the support card select screen 200 illustrated in FIG. 19B is displayed on the display 26. A list of card icons 201 corresponding to the support cards in the player's possession are displayed in the support card select screen 200. By tapping a card icon 201 displayed in the support card select screen 200, the player can select a support card.

Although not illustrated in the drawing, when a support card display pane 192 displayed on the lower right side of the support card formation screen 190 is tapped, a support card set as a rental card by a friend or a player extracted on the basis of a specified condition such as a lottery appears in the support card select screen 200. By tapping a support card displayed in the support card select screen 200, the player can select one support card of a friend. As such, the player can use the support cards in possession of other players in the raising game.

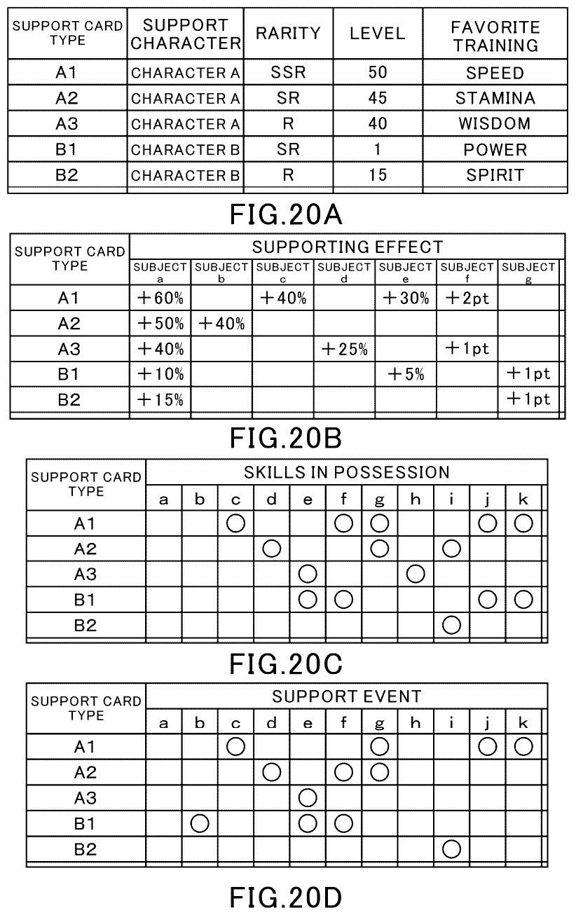

FIG. 20A is a diagram illustrating a support card table. As illustrated in FIG. 20A, the support card table stores types of the support characters (that is, character identifications), rarity, level, and favorite training with respect to the types of the support cards (that is, support card IDs) in the player's possession. The support characters and the types of support cards have one-to-one correspondence. That is, one support card ID is always linked with one character identification. In other words, one support card is always associated with one support character.

In this embodiment, rarity is set for each support card. There are three levels of rarity: rare (R), super rare (SR), and super special rare (SSR). Here, R is set to indicate the lowest rarity, and SSR is set to indicate the highest rarity. In this embodiment, a support card with a higher rarity tends to have a higher supporting effect described below. In addition, in this embodiment, a support card with a higher rarity tends to have a larger number of in-possession skills and support events described below.

There are 50 levels of the support cards: levels 1 to 50. The level of a support card can be increased by the player, and the level increased by the player is stored for each of the support cards. Here, the level of the support card can be increased by using, for example, in-game currency or items. There is also an upper limit to the level of the support card imposed by rarity.

For example, level 20 is set as the upper limit of a support card with R rarity, level 25 is set as the upper limit of a support card with SR rarity, and level 30 is set as the upper limit of a support card with SSR rarity.

The upper limit of the level can be increased stepwise when a specified condition is established. For example, the upper limit for the level of a support card with R rarity can be increased to 40 at most, the upper limit for the level of a support card with SR rarity can be increased to 45 at most, and the upper limit for the level of a support card with SSR rarity can be increased to 50 at most.

FIG. 20B is a diagram illustrating a supporting effect table. As illustrated in FIG. 20B, the supporting effect table stores supporting effects with respect to the types of the support cards in the player's possession.

Supporting effects increase various statuses in the raising main game. In a support card, multiple subjects of the supporting effect are set. Examples of the subject of the supporting effect include physical strength, speed, stamina, power, spirit, and wisdom.

FIG. 20C is a diagram illustrating an in-possession skill table. As illustrated in FIG. 20C, in the in-possession skill table, in-possession skills are set with respect to each of the support cards in the player's possession. In this embodiment, in-possession skills are set for each support card in the same manner as the character set as the main character by the player holding in-possession skills. When a hint event occurs during the raising main game, the in-possession skills set for each support card become acquirable by the main character selected by the player or another character promoted to be a team member described below.

FIG. 20D is a diagram illustrating a support event table. As illustrated in FIG. 20D, the support event table stores support events that can occur with respect to each of the support cards in the player's possession. A support event is an event that can occur during the raising main game. When a support event occurs, the values of various statuses in the raising main game may increase or decrease.

For example, a support event that occurs on the basis of the turn number may be determined, or a support event that occurs by a specified lottery may be determined. Multiple support events may be selected to occur in one turn. In any case, it is sufficient if a support event to occur is determined by a specified determination method that has been preliminarily set.

FIG. 19C is a second diagram illustrating the support card formation screen 190. In this embodiment, when all six support cards are selected, as illustrated in FIG. 19C, the start operation portion 193 becomes operable. Meanwhile, if not all of six support cards are selected, as illustrated in FIG. 19A, the start operation portion 193 is non-operable.

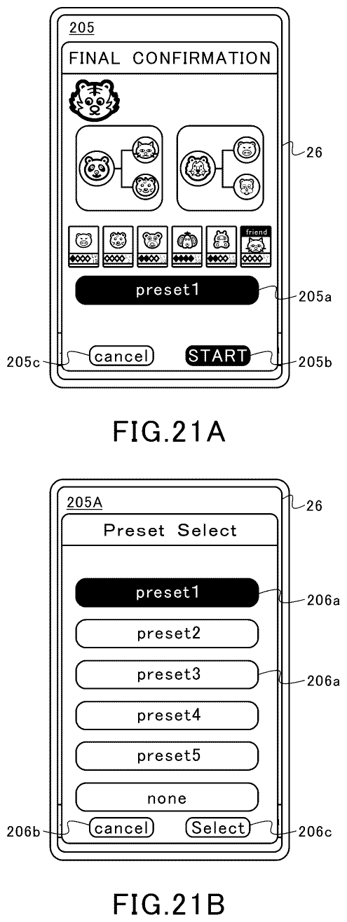

When the return operation portion 153 in the support card formation screen 190 is operated, the inheritance character select screen 170 illustrated in FIG. 10D is displayed on the display 26. Furthermore, as illustrated in FIG. 19C, when the start operation portion 193 in the support card formation screen 190 is tapped, the selected support cards are temporarily registered, and a final confirmation screen 205 (FIG. 21A) appears.

FIG. 21A is a diagram illustrating the final confirmation screen 205. FIG. 21B is a diagram illustrating a preset select screen 205A. The main character selected by the player, raised characters constituting the first inheritance group, raised characters constituting the second inheritance group, and support cards are displayed in the final confirmation screen 205. A preset display portion 205a is displayed in the final confirmation screen 205. The preset display portion 205a indicates a preset number currently selected.

Here, a preset is reservation information about the races in which the main character participates in the raising main game. The player can create a preset by selecting any desired races from all of the races. Multiple presets can be saved, and one preset can be selected from the stored presets in the final confirmation screen 205. Specifically, when the preset display portion 205a is tapped, a preset select screen 205A illustrated in FIG. 21B appears.

Preset read buttons 206a corresponding to the saved presets are displayed in the preset select screen 205A. The player can set a preset by tapping one of the preset read buttons 206a and then tapping a select operation portion 206c. When the select operation portion 206c is tapped, the preset select screen 205A closes, and the final confirmation screen 205 appears. When a cancel operation portion 206b in the preset select screen 205A is tapped, the preset select screen 205A appears without changing the preset.

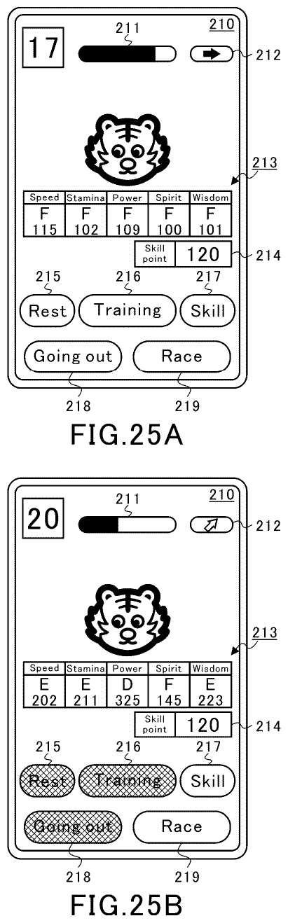

Here, when the cancel operation portion 205c in the final confirmation screen 205 is tapped, the support card formation screen 190 appears. Meanwhile, when a start operation portion 205b is tapped, a game screen 210 (FIG. 25A) is displayed on the display 26.

### <Registration of Special Characters>

After the main character, the inheritance characters, and the support cards are registered as described above, special characters are registered. In this embodiment, four characters are set in advance as the special characters.

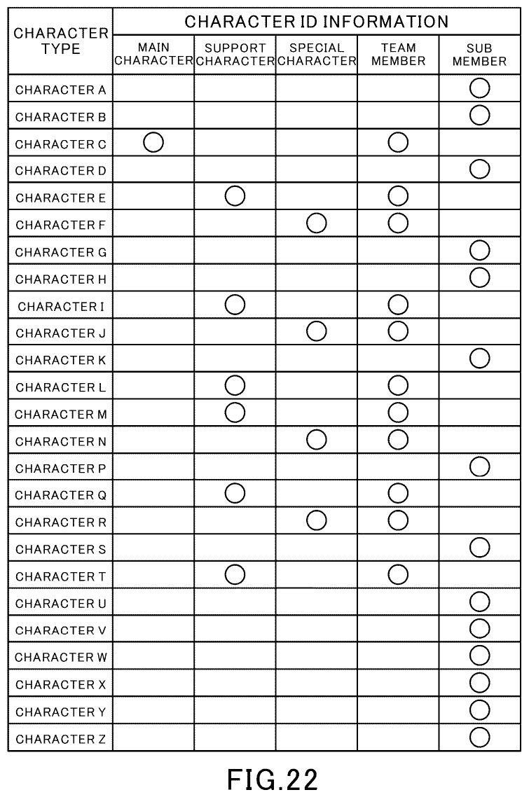

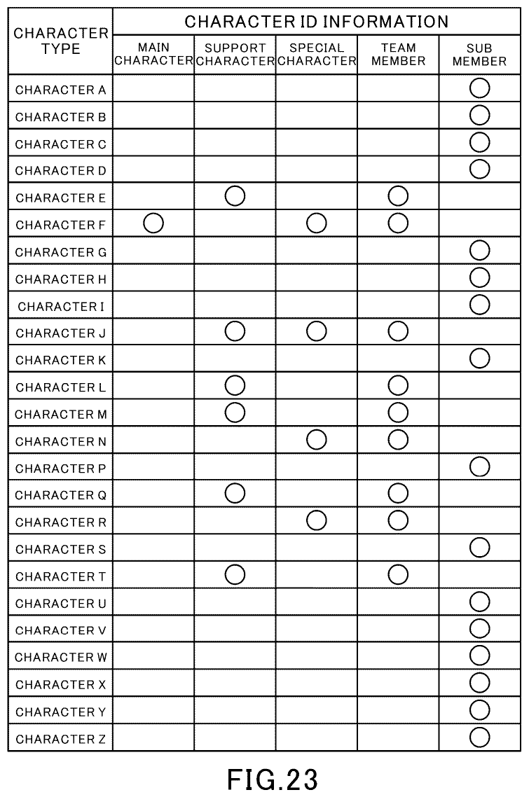

FIG. 22 is a first diagram illustrating a character identification information table. FIG. 23 is a second diagram illustrating the character identification information table. FIG. 22 indicates the case where a “character C” is registered as the main character, and a “character E”, a “character I”, a “character L”, a “character M”, a “character Q”, and a “character T” are registered as the support characters. FIG. 23 indicates the case where a “character F” is registered as the main character, and a “character E”, a “character J”, a “character L”, a “character M”, a “character Q”, and a “character T” are registered as the support characters.

In this embodiment, a limitation is imposed such that, at the time when the support cards are registered, the character type set as the main character does not overlap the character types set as the support characters.

In this embodiment, as illustrated in FIG. 22, a “character F”, a “character J”, a “character N”, and a “character R” are set as the special characters. When the player selects the main character from among multiple characters, the selected character is registered as the main character in the character identification information table.

When support cards are selected by operation of the player, the character identification information table is updated, and the characters corresponding to the selected support cards are registered as the support characters.

Furthermore, when information regarding the main character and the support cards is registered in the character identification information table, the information related to special characters are registered. Here, as illustrated in FIGS. 22 and 23, irrespective of the types of the main character and the support characters registered, a “character F”, a “character J”, a “character N”, and a “character R” are registered as the special characters.

### <Setting of Initial Character Identification Information>

After the main character, the inheritance characters, the support characters, and the special characters are registered as described above, team members and sub-members are registered. Although the detailed description is provided below, a battle game must be played by using the characters registered as the team members in the raising game. When a character registered as a sub-member satisfies a certain condition, that character is registered as a team member.

In this embodiment, the characters registered as the main character, the support characters, and the special characters in the character identification information table are registered as team members. In other words, in the case illustrated in FIG. 22, a “character C”, “a character E”, a “character F”, a “character I”, a “character J”, a “character L”, a “character M”, a “character N”, a “character Q”, a “character R” and a “character T” are registered as team members. In the case illustrated in FIG. 23, a “character E”, a “character F”, a “character J”, a “character L”, a “character M”, a “character N”, a “character Q”, a “character R”, and a “character T” are registered as team members.

In addition, in the character identification information table, among the characters or support cards (support characters) in the player's possession, those characters which are not registered as team members are registered as sub-members. Alternatively, all or lottery-selected some of the rest of characters not registered as team members among the predetermined characters may be registered as sub-members.

Here, the support characters and the special characters are registered as the team members from the start of the raising main game; alternatively, the support characters and the special characters may be registered as sub-members at the start of the raising main game and then registered as team members at a specified timing.

As such, when the information (initial character identification information) regarding the team members and the sub-members are stored in the character identification information table, the preparation stage process ends.

### <Raising Stage Process>

When the preparation stage process ends, the raising stage process starts. In the raising stage process, the characters registered as the main character and the team members can be raised. For the sake of ease of understanding, the basic flow of the raising main game is described below.

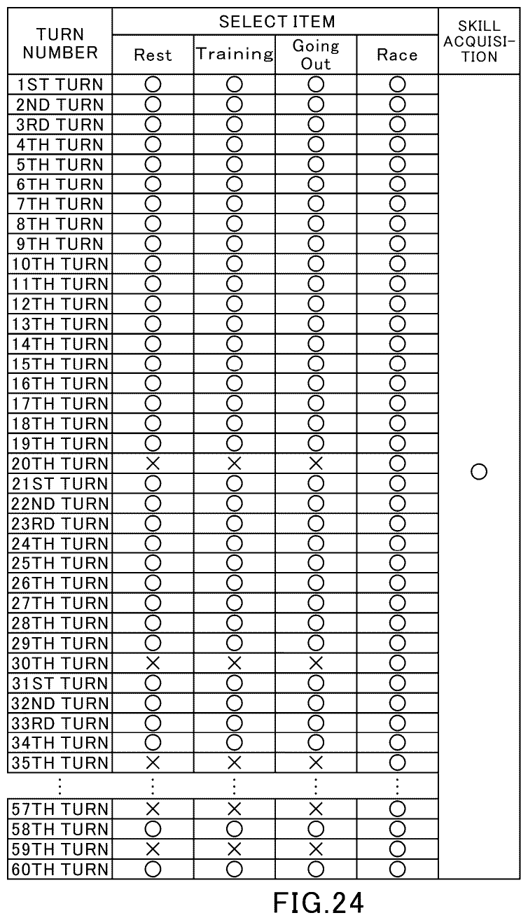

FIG. 24 is a diagram illustrating a selection item table. Here, a selection item table is provided with respect to the type of the main character. Alternatively, a common selection item table may be provided irrespective of the type of the main character. As illustrated in FIG. 24, the raising game is constituted by the 1st to 60th turns, and has a game element such that various parameters are updated according to the selection results of the player on each turn. In addition, according to the selection item table, items that the player can select are set in advance for each turn.

FIG. 25A is a first diagram illustrating the game screen 210. FIG. 25B is a second diagram illustrating the game screen 210. When the game transitions onto the raising stage process, the game screen 210 illustrated in FIGS. 25A and 25B is displayed on the display 26. A physical strength indicator 211 and a condition indicator 212 are displayed at the top of the game screen 210. The parameter “physical strength” is set for the main character. The “physical strength” parameter is mainly used to calculate the failure rate, which is the probability of failing the training described below. The physical strength indicator 211 is displayed so that the remaining “physical strength” of the current main character can be visually identified with respect to the upper limit of the “physical strength”.

The parameter “condition” is also set for the main character. The condition indicator 212 is displayed so that the “condition” of the current main character can be visually identified in multiple levels (five levels: very bad condition, bad condition, normal condition, good condition, very good condition). The higher the “condition” parameter, the more advantageous the race would develop for the main character and the larger the increase in value of the ability parameter by training.

As illustrated in FIGS. 25A and 25B, an image of the main character, a status display portion 213, and a skill point display portion 214 are displayed in the center portion of the game screen 210. In the status display portion 213, the status of the current main character is indicated by numerical values and in multiple ranks (16 stages: G⁺, F, F⁺, E, E⁺, D, D⁺, C, C⁺, B, B⁺, A, A⁺, S, SS, and SS⁺) Specifically, in this embodiment, the numerical values and ranks of the ability parameters, that is, “Speed”, “Stamina”, “Power”, “Spirit”, and “Wisdom” are indicated. Moreover, the remaining skill points of the main character in the raising game is indicated in a numerical value in the skill point display portion 214.

As illustrated in FIGS. 25A and 25B, a rest operation portion 215 indicated by “Rest”, a training operation portion 216 indicated by “Training”, a skill operation portion 217 indicated by “Skill”, a going-out operation portion 218 indicated by “Going Out”, and an individual race operation portion 219 indicated by “Race” are displayed in the lower portion of the game screen 210. The current turn number is displayed at the top of the game screen 210.

On each turn, the player can select one of “Rest” (rest operation portion 215), “Training” (training operation portion 216), “Going Out” (going-out operation portion 218), and “Race” (individual race operation portion 219). Here, as illustrated in FIG. 24, the items that can be selected are preliminarily set for each turn.

When the item “Rest” is selected, the physical strength is recovered, and when the item “Going Out” is selected, the condition improves. When the item “Training” is selected, the training described below becomes executable, and when the item “Race” is selected, the main character can participate in an individual race. When these items “Rest”, “Training”, “Going Out”, and “Race” are selected and the game results are derived, the current turn ends and the game transitions to a next turn.

In this embodiment, the turns on which the rest operation portion 215, the training operation portion 216, and/or the going-out operation portion 218 cannot be selected are set, such as on the 20th turn, the 30th turn, the 35th turn, the 57th turn, and the 59th turn as illustrated in FIG. 24. On such turns, as illustrated in FIG. 25B, the rest operation portion 215, the training operation portion 216, and the going-out operation portion 218 are grayed out and displayed, and the operation of the player cannot be accepted. Thus, in these turns, the player must select the individual race operation portion 219.

Meanwhile, the skill operation portion 217 is set as to be selectable at all times on all turns. Although detailed description is provided below, the turn does not end even when skills are acquired. In this embodiment, a team race is compulsorily executed after the end of the specified turn.

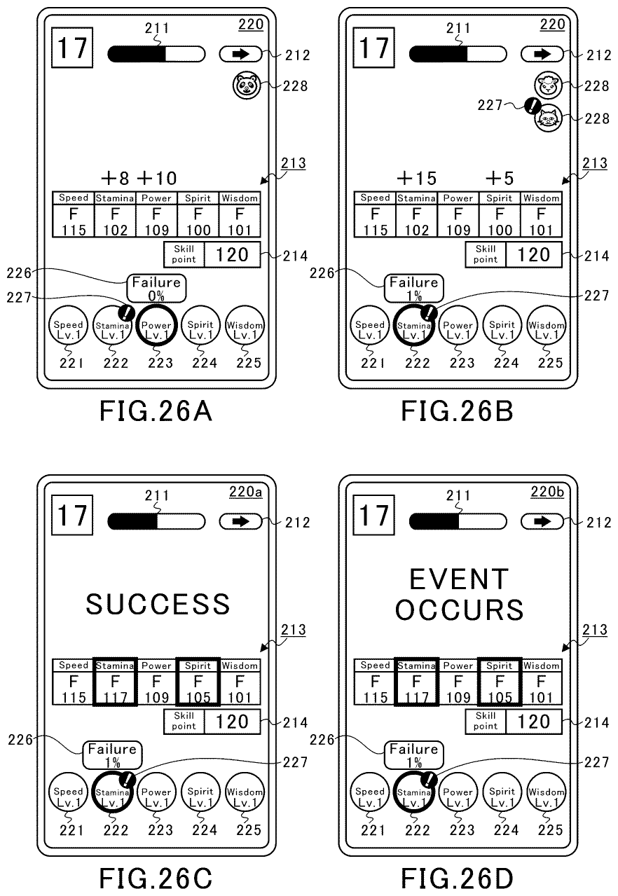

FIG. 26A is a first diagram illustrating a training screen 220. FIG. 26B is a second diagram illustrating the training screen 220. When the training operation portion 216 in the game screen 210 is operated, the training screen 220 is displayed on the display 26.

As illustrated in FIG. 26A, training items are displayed in the lower portion of the training screen 220. Here, a speed operation portion 221 indicated by “Speed”, a stamina operation portion 222 indicated by “Stamina”, a power operation portion 223 indicated by “Power”, a spirit operation portion 224 indicated by “Spirit”, and a wisdom operation portion 225 indicated by “Wisdom” are displayed.

When the player taps one of the operation portions 221 to 225 once, the training item corresponding to the tapped operation portion 221 to 225 is temporarily selected, and the operation portion 221 to 225 corresponding to the temporarily selected training item is highlighted. In FIG. 26A, a state in which the power operation portion 223 is temporarily selected is illustrated. In FIG. 26B, a state in which the stamina operation portion 222 is temporarily selected is illustrated.

In each of the operation portions 221 to 225, a training level for each training item is also displayed. The training level is a parameter that increases on the basis of the team ranking, and the higher the training level, the larger the value of increase in the ability parameter when the training is executed. The training level is initially set to level 1, and increases to level 5 at most.

Furthermore, near the temporarily selected operation portion 221-225, a failure rate display portion 226 indicated by “Failure” is displayed. The failure rate indicated by a numerical value in the failure rate display portion 226 is set to increase in inverse proportion to the remaining physical strength displayed in the physical strength indicator 211.

In addition, a value by which the ability parameter increases when the training corresponding to the temporarily selected operation portion 221-225 is successful is indicated in the status display portion 213. For example, in the example illustrated in FIG. 26A, the power operation portion 223 is temporarily selected, and “+8” is indicated on “Stamina”, and “+10” is indicated on “Power” in the status display portion 213. Moreover, in the example illustrated in FIG. 26B, the stamina operation portion 222 is temporarily selected, and “+15” is indicated on “Stamina”, and “+5” is indicated on “Spirit” in the status display portion 213.

Moreover, an event notification indicator 227 is displayed on the operation portion 221 to 225 corresponding to the training item for which a specified event will occur when the training is successfully executed. The event notification indicator 227 may be displayed differently according to the type of event.

As illustrated in FIG. 26B, an assigned character icon 228 of a character assigned to a training is displayed in an upper right portion of the training screen 220 for each of the items of the operation portions 221 to 225 that are temporarily selected. When a specified event corresponding to the character displayed in the assigned character icon 228 is to occur as a result of a successful training, the event notification indicator 227 is displayed on the corresponding assigned character icon 228. In the description below, the training to which a character is assigned is referred to as a “joint training”.

FIG. 26C is a diagram illustrating a training result notification screen 220a. When one of the temporarily selected operation portions 221 to 225 is tapped again, a training corresponding to the tapped operation portion 221 to 225 is executed. When the training is executed, the training result notification screen 220a that notifies whether the training was successful or was failure is displayed on the display 26. Here, the word “success” is displayed to notify the player that the training was successful.

Here, on the basis of the success in training, the ability parameter in the status display portion 213 is updated and displayed. In other words, the ability parameter (ability information) of the main character corresponding to the training item (raising item) selected by the player is updated.

Here, the value of the ability parameter that increases upon success of the training displayed in the status display portion 213 in FIG. 26A or 26B is added. Moreover, the display of the physical strength indicator 211 is updated according to the executed training item. When a training executed for one of speed, stamina, power, and spirit was successful, the physical strength decreases. In contrast, when a training executed for wisdom was successful, the physical strength recovers.

When the training was failure, a specified penalty is imposed. Specific examples of the content of the penalty include a decrease in physical strength, a decrease in numerical value of the ability parameter, and a decrease in condition. Here, for example, the penalty imposed when the failure rate is high can be set to be more disadvantageous (for example, the numerical value by which the physical strength decreases is large, the numerical value by which the ability parameter decreases is large, or the stage by which the condition decreases is large) than the penalty imposed when the failure rate is low.

The content of the penalty may be determined according to the training item. For example, when the training for speed has ended in failure, the value of the ability parameter for speed may decrease, and when the training for power has ended in failure, the value of the ability parameter for power may decrease. Moreover, for some training items (for example, wisdom), no penalty may be imposed even when the training ends in failure.

FIG. 26D is a diagram illustrating an event screen 220b. When the display of the training result notification screen 220a ends, an event screen 220b is sometimes displayed on the display 26. In the event screen 220b, various events are executed. There may be instances where multiple events would occur during one turn.

For example, when a hint event occurs, a hint regarding a skill is obtained. When a hint regarding a skill is obtained, the player can acquire this skill by spending skill points. Multiple types of skills are provided, and a specified ability may be activated for each skill. Each skill has its specified activation conditions and effects, and, when the activation conditions are established, the predetermined effects are exerted. A skill is sometimes activated during an individual race and a team race described below.

Events include an event by which a skill is acquired, an event in which physical strength is recovered, an event in which physical strength decreases, an event in which the ability parameter increases, an event in which the ability parameter decreases, an event in which the condition improves, and an event in which the condition deteriorates. Although the detailed description is provided below, there are a predetermined event for each turn and an event that occurs when a specified lottery is won. In addition, after all events occur and end, a game screen 210 related to a next turn is displayed.

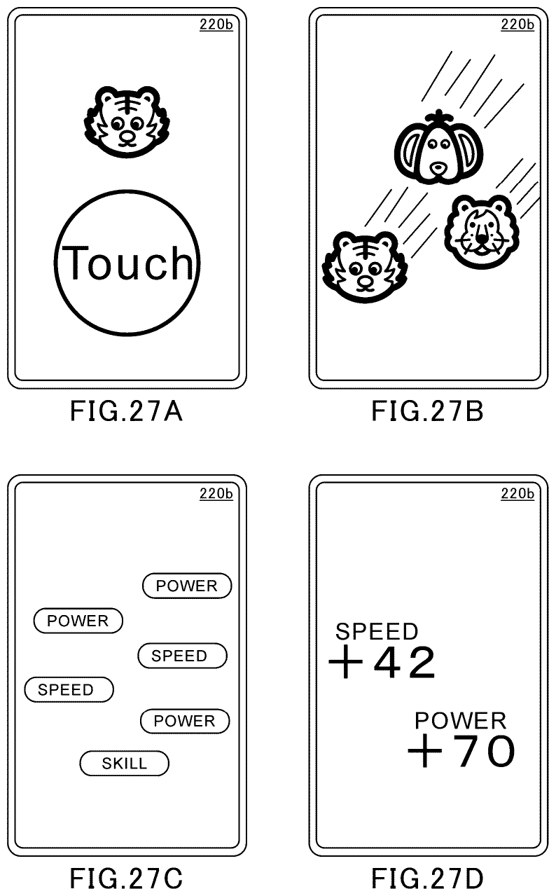

FIG. 27A is a first diagram illustrating an inheritance event. FIG. 27B is a second diagram illustrating the inheritance event. FIG. 27C is a third diagram illustrating the inheritance event. FIG. 27D is a fourth diagram illustrating the inheritance event. On the aforementioned factor activation turn, an inheritance event occurs as the turn begins. This inheritance event is a scenario common event described below, and always occurs during the same turn irrespective of the scenario selected by the player. In this embodiment, the 1st turn, the 30th turn, and the 54th turn are set as the factor activation turns; however, the case in which an inheritance event occurs on the 30th turn is described here.

As the 30th turn starts, first, as illustrated in FIG. 27A, the main character and the operation portion indicated by “Touch” are displayed in the event screen 220b. When the operation portion displayed in the event screen 220b is tapped, as illustrated in FIG. 27B, an amination image that includes the main character and two inheritance characters appears. In addition, when the operation portion is tapped, a factor activation lottery is carried out for each of the factors of a total of six raised characters of the inheritance first generation and the inheritance second generation.

Moreover, as illustrated in FIG. 27C, the factors that have won the factor activation lottery and have been determined to be activated are displayed, and then, as illustrated in FIG. 27D, the types of the ability parameters or aptitude parameters to be increased by the factor activation and the values by which the parameters increase are displayed, and the parameters are updated. After the inheritance event ends, the game screen 210 illustrated in FIG. 25A appears, and the player becomes able to select any of the items. Here, in the status display portion 213, the values of increase in the ability parameter and aptitude parameter displayed in the inheritance event are already added.

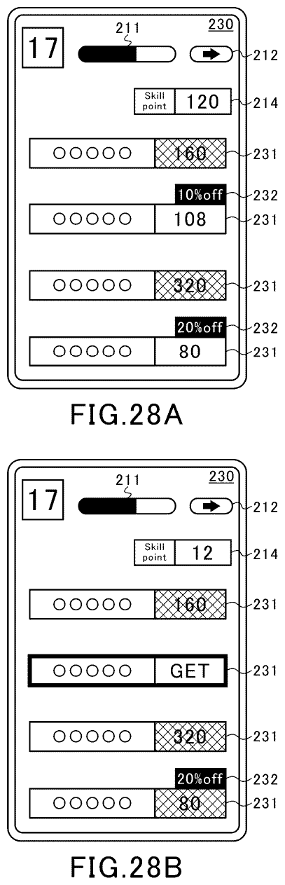

FIG. 28A is a first diagram illustrating a skill screen 230. FIG. 28B is a second diagram illustrating the skill screen 230. When the skill operation portion 217 in the game screen 210 is operated, the skill screen 230 illustrated in FIG. 28A is displayed on the display 26.

Skill display boxes 231 are displayed in the skill screen 230. In each skill display box 231, the acquired skills, the in-possession skills that have been preliminarily set for the main character, and the in-possession skills that came to the player's possession by occurrence of various events, etc., are displayed. In addition, when a hint event occurs with respect to an in-possession skill, skill points needed to acquire this in-possession skill are discounted. Here, for the in-possession skill for which a hint is acquired, the discounted skill points needed to acquire this skill are displayed. Here, a discount rate display icon 232 that indicates the discount rate is also displayed along with the skill display box 231.

For each of the skills displayed in the skill screen 230, the activation condition and the effects of the skill are displayed.

The physical strength indicator 211, the condition indicator 212, and the skill point display portion 214 are displayed in the upper portion of the skill screen 230. The current turn number is also displayed in the upper portion of the skill screen 230.

When an in-possession skill is acquired by spending skill points on the basis of the operation by the player, as illustrated in FIG. 28B, “GET” is displayed over the acquired skill to notify that the in-possession skill has been acquired, and, at the same time, the display of the skill points is updated by subtracting the spent skill points from the skill point that has been displayed in the skill point display portion 214.

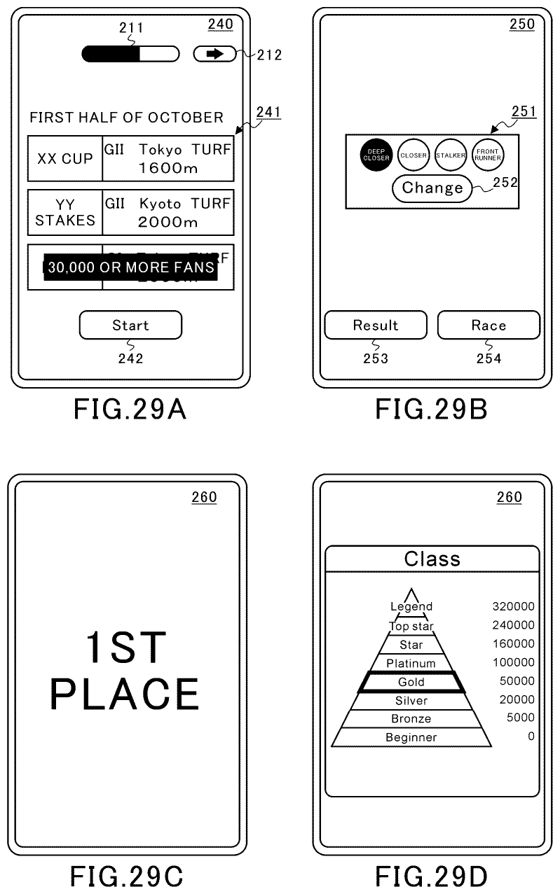

FIG. 29A is a first diagram illustrating an individual race select screen 240. When the individual race operation portion 219 in the game screen 210 is operated, the individual race select screen 240 illustrated in FIG. 29A appears. The individual race offers a game element in which the main character plays a race with a so-called non-player character (hereinafter referred to as an NPC).

The physical strength indicator 211 and the condition indicator 212 are displayed at the top of the individual race select screen 240. In addition, an individual race select operation portion 241 used to select the race in which the main character participates is displayed in the center portion of the individual race select screen 240. Furthermore, a start operation portion 242 indicated by “Start” is displayed in the lower portion of the individual race select screen 240. Here, the race that can be selected by the individual race select operation portion 241 in the individual race select screen 240 is preliminarily set for each turn.

For each of the races, the participation condition is preliminarily set, and the player can have the main character participate in the race only when the participation condition is satisfied. As mentioned above, in some races, the number of fans is specified as a participation condition. As illustrated in FIG. 29A, a participation condition is displayed in the individual race select operation portion 241 for the race for which the specified number of fans is not satisfied, thereby notifying the player that this race cannot be selected. Moreover, on the turn in which the subject race of a clear target is set, only the subject race is displayed to be selectable in the individual race select screen 240.

FIG. 29B is a diagram illustrating an individual race start screen 250. When the start operation portion 242 is operated in the state where the race type of the individual race to participate is selected in the individual race select operation portion 241, the individual race start screen 250 illustrated in FIG. 29B appears. A strategy display portion 251 is displayed in the center portion of the individual race select screen 250. In addition, in the strategy display portion 251, the strategy that is presently selected (deep closer, closer, stalker, or front runner) is highlighted, and a change operation portion 252 indicated by “Change” is displayed. When the change operation portion 252 is operated, a strategy change screen not illustrated in the drawing is displayed on the display 26. The player can freely change the strategy to be used in the individual race by operating on the strategy change screen.

In addition, a result operation portion 253 indicated by “Result” and a race operation portion 254 indicated by “Race” are displayed in the lower portion of the individual race start screen 250.

When the race operation portion 254 is operated, a race screen not illustrated in the drawing is displayed on the display 26. A video of race development (hereinafter may also be referred to as a race video) is displayed on the display 26.

FIG. 29C is a first diagram illustrating an individual race result screen 260. FIG. 29D is a second diagram illustrating the individual race result screen 260. When the aforementioned race video ends playing and when the result operation portion 253 is operated, the individual race result screen 260 is displayed on the display 26. As illustrated in FIG. 29C, the order of arrival of the main character in that individual race is displayed in the individual race result screen 260. As illustrated in FIG. 29D, the present class of the main character is displayed in the individual race result screen 260.

In this embodiment, the main character is classified according to the number of fans acquired. A range of the number of fans is set for each class, and, here, the main character is classified into one of eight classes according to the number of fans. In the individual race result screen 260, the number of fans acquired by the latest individual race, and the accumulated number of fans obtained by adding the number of newly acquired fans to the number of already acquired fans are displayed. Furthermore, the present class corresponding to the accumulated number of fans is displayed.

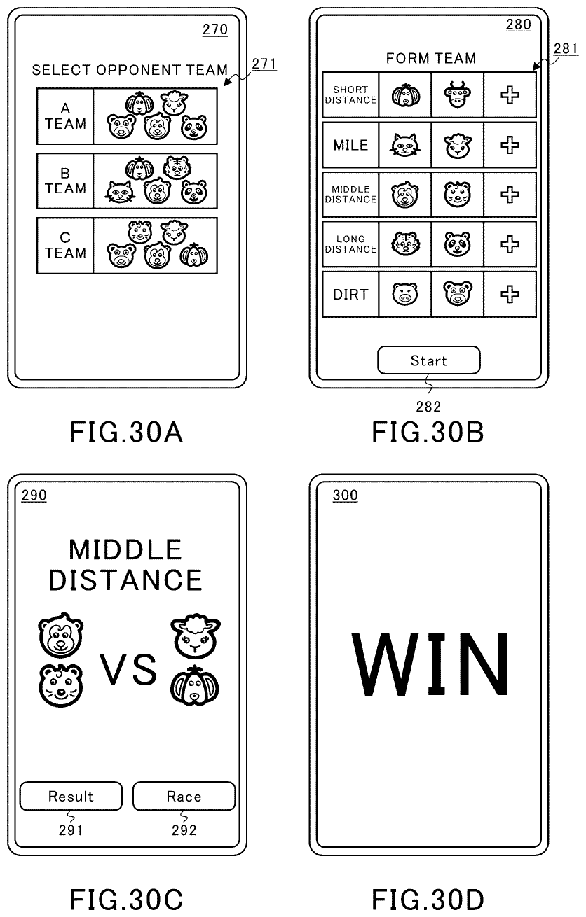

FIG. 30A is a diagram illustrating a team race select screen 270. As mentioned above, in this embodiment, a team race is compulsorily started after ending a specified turn. When the team race is started, the team race select screen 270 illustrated in FIG. 30A is displayed. An opponent team select operation portion 271 for selecting the opponent in the participating team race is displayed in the center portion of the team race select screen 270. The opponent can be an NPC. The opponent is not limited to the NPC and may be a team of another player. In such a case, an online match with the team of another player takes place.

Here, the character participating in the team race may be any as long as the character can be selected from the team members and does not have to include the main character. Furthermore, one team member can participate in multiple races in the team race.

FIG. 30B is a diagram illustrating a team formation screen 280. When the opponent team select operation portion 271 is operated, the team formation screen 280 is displayed on the display 26. A team formation operation portion 281 is displayed in the team formation screen 280. The player can organize characters used in the team race by using the characters registered as team members by operating the team formation operation portion 281. In this embodiment, five races, i.e., “short distance”, “mile”, “middle distance”, “long distance”, and “dirt”, take place in a team race. The game element is that the overall winning or losing of the team race is determined on the basis of the outcome of each race.

Specifically, when the player team wins more races out of five races than the opponent team does, the player team wins the team race comprehensively. Meanwhile, when the player team wins fewer races out of five races than the opponent team does, the player team loses the team race comprehensively. If the number of races the player team won is the same as the number of races the opponent team won, the team race is a draw.

Note that the player can have up to three types of characters organized into a team for each race from the team members. Here, it is not possible to use the same type of character in multiple races. Furthermore, a start operation portion 282 indicated by “Start” is displayed in the lower portion of the team formation screen 280.

FIG. 30C is a diagram illustrating a team race start screen 290. When the start operation portion 282 in the team formation screen 280 is operated, the team race start screen 290 illustrated in FIG. 30C appears. In this embodiment, five races take place in a team race, and the order in which these races take place may be predetermined or may be determined at random.

As illustrated in FIG. 30C, the characters of the opponent team and the characters of the team organized by the player for the upcoming race are displayed in the center portion of the team race start screen 290. This drawing illustrates the case in which the player has organized two characters and the opponent has organized two characters for a “middle distance” race.

In addition, as illustrated in FIG. 30C, a result operation portion 291 indicated by “Result” and a race operation portion 292 indicated by “Race” are displayed in the lower portion of the team race start screen 290. When the race operation portion 292 is operated, a race screen not illustrated in the drawing appears.

FIG. 30D is a diagram illustrating a team race midway result screen 300. When the aforementioned race video ends playing and when the result operation portion 291 in the team race start screen 290 is operated, the team race midway result screen 300 is displayed on the display 26. In the team race midway result screen 300, the outcome of that race (the “middle distance” race here) is displayed. Note that the method for determining winning and losing of each of the five races in the team race is not particularly limited. For example, the team to which a character that came in first place belongs may be designated as a winner. Alternatively, specified points may be given according to the order of arrival, and the team with the most acquired points may be designated as a winner.

After the display of the team race midway result screen 300 illustrated in FIG. 30D ends, the team race start screen 290 for the next race (for example, a “short distance” race) is displayed, and, subsequently, the team race start screen 290 and the team race midway result screen 300 are sequentially displayed in the same manner until all of the five races come to an end.

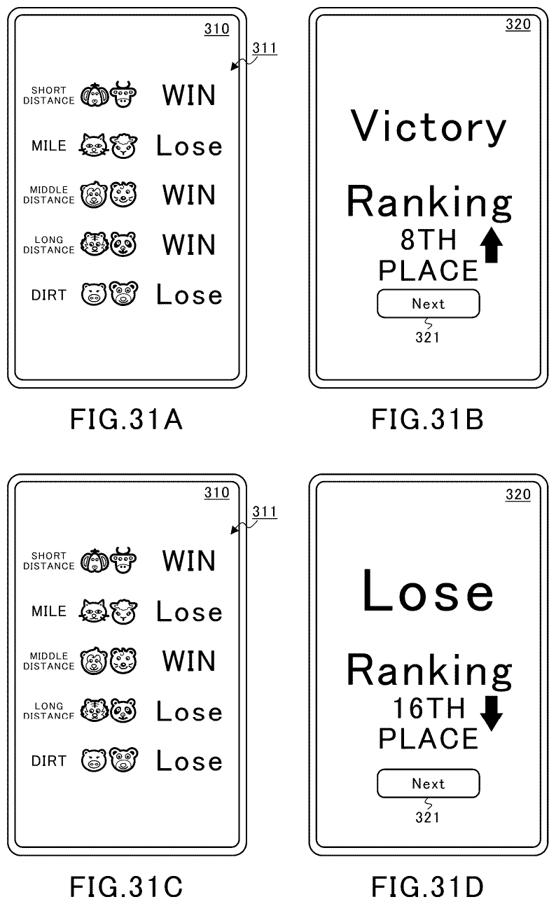

FIG. 31A is a first diagram illustrating a team race detailed result screen 310. As mentioned above, after the team race start screen 290 and the team race midway result screen 300 for all of the five races have been displayed, a team race detailed result screen 310 is displayed on the display 26. The winning/losing result display portion 311 is displayed in the center portion of the team race detailed result screen 310. The winning/losing result display portion 311 notifies the player of the outcome of each race. Here, as illustrated in FIG. 31A, the case in which three races are won and two races are lost is indicated.

FIG. 31B is a first diagram illustrating a team race comprehensive result screen 320. After the display of the winning/losing result display portion 311 has ended, the team race comprehensive result screen 320 is displayed on the display 26. The team race comprehensive result screen 320 notifies the player of the comprehensive outcome of the team race. As illustrated in FIG. 31A, when three races are won and two races are lost, the team race comprehensive result screen 320 notifies that the player has won the team race.

In addition, a team ranking is displayed in the team race comprehensive result screen 320. In this embodiment, the team ranking changes on the basis of the outcome of the team race. For example, when a team race is won, the team ranking goes up.

In addition, in the team race comprehensive result screen 320 that notifies that the team race has been won, a next operation portion 321 indicated by “NEXT” is displayed. When the next operation portion 321 in the team race comprehensive result screen 320 is operated, a game screen 210 of the next turn is displayed.

FIG. 31C is a second diagram illustrating the team race detailed result screen 310. Here, as illustrated in FIG. 31C, the case in which two races are won and three races are lost is indicated. FIG. 31D is a second diagram illustrating the team race comprehensive result screen 320. As illustrated in FIG. 31C, when two races are won and three races are lost, the team race comprehensive result screen 320 notifies that the player has lost the team race.

When a team race is lost, the team ranking goes down. However, irrespective of the outcome of the team race, the raising main game continues, and thus the next turn starts by tapping the next operation portion 321.

As described above, in the raising main game, a team race is executed every specified turns. Winning a team race gives benefits such as an increase in the ability parameters of the main character. Moreover, in the raising main game, a sub-member is promoted to a team member on a specified turn. Here, a particular number of sub-members are promoted to team members on the turn following the team race. As such, the game element of the raising game is to win a team tournament by gradually increasing the team members.

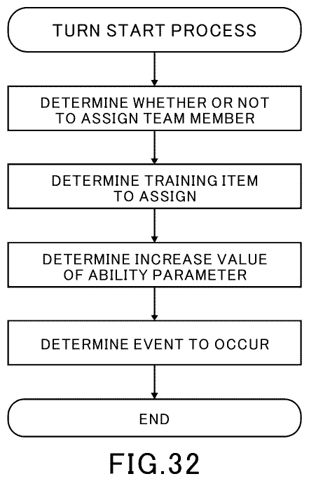

FIG. 32 is a flowchart roughly illustrating the flow of the turn start process. The raising stage process includes a turn start process executed at the start of each turn of the raising game. Although the details of the turn start process are described later, a rough flow of the turn start process is described here.

The turn start process includes a “process of determining whether to assign a team member”, a “process of determining the training item to be assigned”, a “process of determining the increase value of the ability parameter”, and a “process of determining the event to occur” illustrated in FIG. 32. Although various other processes are executed in the turn start process, the processes illustrated in FIG. 32 are sequentially described here.

### <Process of Determining Whether to Assign a Team Member>

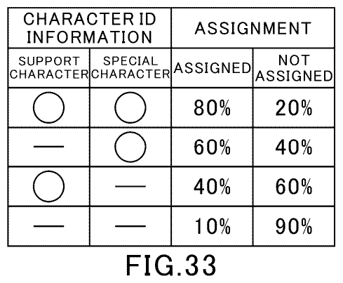

FIG. 33 is a diagram illustrating an assignment table. As illustrated in FIG. 33, the assignment table sets selection ratios involving whether a character is assigned or not (“Assigned” or “Not assigned”) with respect to character identification information of the character. In this embodiment, the assignment of all team members is determined by referring to the character identification information table illustrated in FIG. 22 or 23 above on the basis of the assignment table illustrated in FIG. 33.

Specifically, as illustrated in FIG. 33, in this embodiment, for a team member who has been registered as a “support character” and also as a “special character” in the character identification information, “Assigned” is selected with a probability of 80%. For a team member who has been registered as a “special character” but not as a “support character” in the character identification information, “Assigned” is selected with a probability of 60%.

For a team member who has been registered as a “support character” but not as a “special character” in the character identification information, “Assigned” is selected with a probability of 40%. For a team member who has not been registered as a “support character” or a “special character” in the character identification information, “Assigned” is selected with a probability of 10%.

As described above, a team member registered as a support character has a higher probability of becoming assigned to a training than a team member not registered as a support character. Moreover, a team member registered as a special character has a higher probability of becoming assigned to a training than a team member not registered as a special character.

### <Process of Determining the Training Item to be Assigned>

Next, for the team member determined to be assigned as described above, the training item to be assigned is determined from among “Speed”, “Stamina”, “Power”, “Spirit”, and “Wisdom”.

The method for determining the training item to be assigned is not particularly limited, and, for example, a lottery may be carried out such that each training item has the same winning chance. Alternatively, a character may be assigned to a training item preset for that character without conducting a lottery. Alternatively, for example, a lottery may be carried out such that the character is likely to be assigned to the character's favorite training (see FIG. 20A). In conducting a lottery, a lottery table in which the selection ratio in the lottery is predetermined may be stored in advance, or a lottery table may be newly generated every time a lottery is to be conducted.

### <Process of Determining the Increase Value of the Ability Parameter>

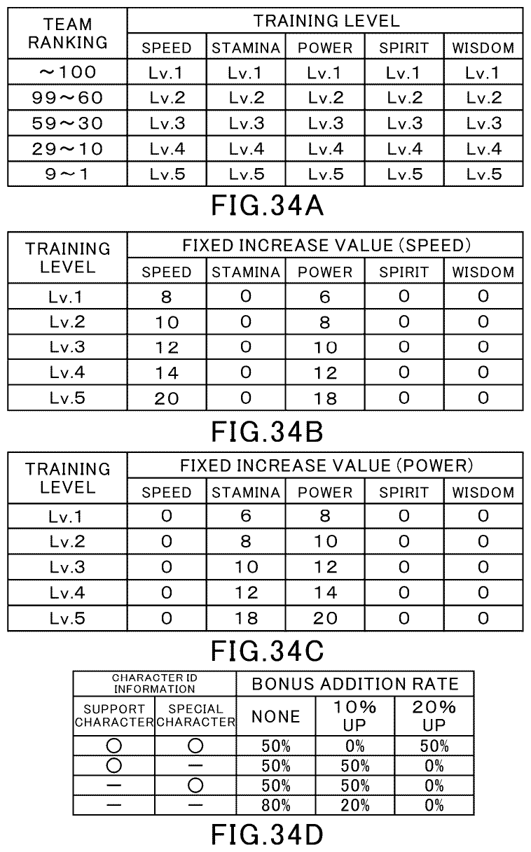

FIG. 34A is a diagram illustrating a training level table. As illustrated in FIG. 34A, the training levels are set such that the levels rise as the team ranking goes up. Specifically, when the team ranking is 100th or lower, the training levels for “Speed”, “Stamina”, “Power”, “Spirit”, and “Wisdom” are set to “level 1”, when the team ranking is 99th or higher and 60th or lower, the training level is set to “level 2”, when the team ranking is 59th or higher and 30th or lower, the training level is set to “level 3”, when the team ranking is 29th or higher and 10th or lower, the training level is set to “level 4”, and when the team ranking is 9th or higher, the training level is set to “level 5”.

In this embodiment, the training level is set to rise as the team ranking goes up; however, this is not limiting. For example, the favorite training of a team member may be counted for each training item, and the training level may be set to rise according to the counted value (count). Here, the training levels of all training items are set to be common with respect to the team ranking; alternatively, the training levels may differ for training items with respect to the same team ranking.

In this embodiment, when the training selected by the player has been successfully conducted, the value of the specified ability parameter increases according to the conducted training item.

Specifically, in this embodiment, when the “Speed” training has been successfully conducted, the values of the ability parameters of “Speed” and “Power” increase.

When the “Stamina” training has been successfully conducted, the values of the ability parameters of “Stamina” and “Spirit” increase.

When the “power” training has been successfully conducted, the values of the ability parameters of “Stamina” and “Power” increase.

When the “Spirit” training has been successfully conducted, the values of the ability parameters of “Speed”, “Power”, and “Spirit” increase.

When the “Wisdom” training has been successfully conducted, the values of the ability parameters of “Speed” and “Wisdom” increase.

In this embodiment, the value by which the ability parameter increases upon successful training is calculated by adding, to a fixed increase value determined according to the conducted training item and the training level, a value obtained by multiplying this fixed increase value by a bonus addition rate described below.

FIG. 34B is a diagram illustrating a fixed increase value (speed) table. FIG. 34C is a diagram illustrating a fixed increase value (power) table. In other words, FIG. 34B shows the fixed increase value when the training item is “Speed”. FIG. 34C shows the fixed increase value when the training item is “Power”.

As illustrated in FIGS. 34B and 34C, the fixed increase value tables store the fixed increase values determined according to the conducted training items and the training levels. As illustrated in FIGS. 34B and 34C, this embodiment is set so that the higher the training level, the larger the increase in ability parameter.

Although the description is omitted here, there are also fixed increase value tables that are used when “Stamina”, “Spirit”, and “Wisdom” are selected as the training items.

In addition to the fixed increase values, the bonus addition rate is determined on the basis of the character to be assigned to each training item and the character identification information table illustrated in FIG. 22 or 23.

FIG. 34D is a diagram illustrating a bonus addition rate table. In this embodiment, the bonus addition rate is determined on the basis of the character identification information of the character for which the assignment to each training has been determined.

Specifically, as illustrated in FIG. 34D, the bonus addition rate table includes settings of whether there is a bonus addition rate for each character identification information of the character and the selection ratio of the addition rate (up 10% or up 20%).

When a “support character” and a “special character” are registered as the character identification information, “None” is selected with a probability of 50%, and “up 20%” is selected with a probability of 50%.

When only a “support character” is registered as the character identification information, “None” is selected with a probability of 50%, and “up 10%” is selected with a probability of 50%.

When only a “special character” is registered as the character identification information, “None” is selected with a probability of 50%, and “up 10%” is selected with a probability of 50%.

When neither a “support character” nor a “special character” is registered as the character identification information, “None” is selected with a probability of 80%, and “up 10%” is selected with a probability of 20%.

Next, the fixed increase value determined by the fixed increase value table is multiplied by the bonus addition rate, and the result is derived as the bonus additional value. The sum of the bonus additional value and the fixed increase value is determined as the amount of increase in the value of the ability parameter in the event of successful training. Note that, for a training to which multiple characters are assigned, the bonus additional value of each of the multiple assigned characters is added to the fixed increase value. As such, the amount of increase in the ability parameter of the main character in the event of successful training is determined with respect to all of the training items.

### <Process of Determining the Event to Occur>

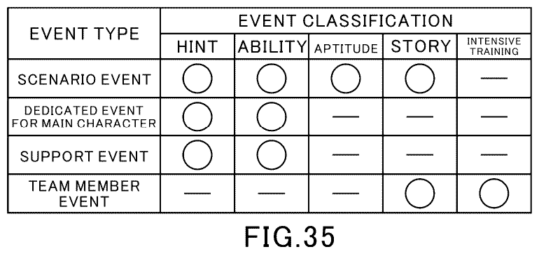

FIG. 35 is a diagram illustrating the types and classifications of the events. During the raising main game, a process of determining whether an event is to occur or not is executed on each turn. Events are roughly categorized into four types: a scenario event, the aforementioned dedicated event provided to each main character, a support event, and a team member event. Note that each of the scenarios predetermines the scenario event, the dedicated event, the support event, and the team member event that can occur during the raising main game.

A scenario event is an event set with respect to a scenario of the raising main game. In this embodiment, multiple scenarios are provided from which the player can select. A scenario event occurs in each scenario selected by the player. In other words, the scenario event that occurs in the raising main game is determined on the basis of the scenario selected by the player.

Note that a scenario unique event and a scenario common event may be provided as the scenario events. A scenario unique event is an event linked with only one scenario. For example, a scenario unique event linked with a first scenario occurs only when the first scenario is selected and never occurs when other scenarios are selected.

A scenario common event is an event that occurs in multiple scenarios in common. Thus, a scenario common event occurs when the first scenario is selected and when the second scenario is selected.

Here, it is assumed that a scenario unique event and a scenario common event are provided as the scenario events. Alternatively, only one of the scenario unique event and the scenario common event may be provided.

A dedicated event is an event that is preliminarily set for each character as described above. In the raising main game, a dedicated event of a character registered as the main character in the setting game, that is, the preparation stage process, occurs.

A support event is an event that is preliminarily set for each support card as described above. In the raising main game, a support event linked with a support card registered by the player in the setting game occurs. In addition, apart from the support event linked with the registered support card, for example, a support event linked with a team member sometimes occurs. However, the probability with which the support event linked with the support card registered by the player in the setting game is determined is set to be higher than the probability with which other support events are determined.

A team member event is an event that occurs mainly when a training to which a team member is assigned, that is, a joint training, is conducted. In addition, a team member event may occur irrespective of the training when a specified condition is met.

As such, whether a scenario event occurs or not is determined on the basis of the scenario. In addition, whether the dedicated event, the support event, or the team member event occurs or not is determined on the basis of the main character, the support card, or the team member. In other words, the event type is distinguished by the information that is referred in determining whether the event occurs or not.

In contrast, in the present embodiment, each event is classified into one of the five event classifications according to the content brought about by the occurrence of the event. Here, each event is classified into an event classification selected from a hint event, an ability event, an aptitude event, a story event, or an intensive training event.

As mentioned above, a hint event is an event by which a skill can be held in possession or acquired. An ability event is an event that increases or decreases the ability parameter of the main character. An aptitude event is an event that increases or decreases the aptitude parameter of the main character. A story event is an event that displays a story related to a character that appears in the raising game. Some story event not only displays a story but changes the ability parameter and/or the aptitude parameter. An intensive training event is an event that increases the ability parameter of a team member.

Here, scenario events include a hint event, an ability event, an aptitude event, and a story event. A dedicated event and a support event include a hint event and an ability event. Furthermore, a team member event includes a story event and an intensive training event. It should be noted here that the relationship between the event type and the event classification shown in FIG. 35 is merely one example. Thus, for example, a dedicated event may include a story event or an intensive training event.

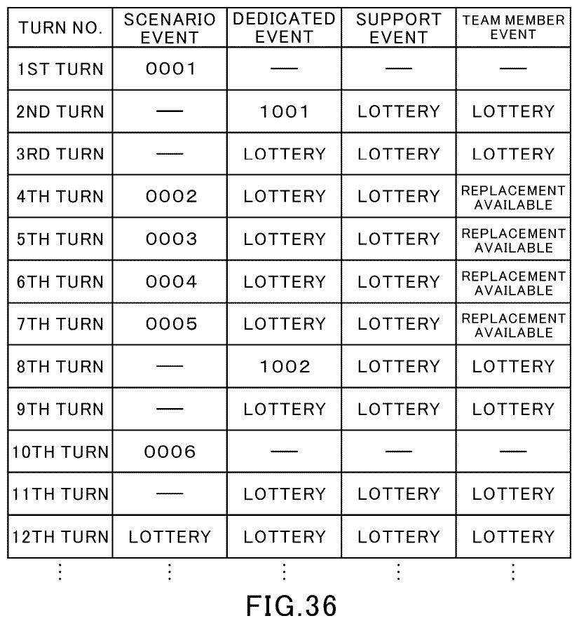

FIG. 36 is a diagram illustrating the relationship between the event type and the turn number. FIG. 36 illustrates one example in which a specified character is registered as the main character in conducting the raising main game. Whether an event occurs or not is determined on the basis of the event determination table provided for each scenario.

Here, the event determination table includes an event occurrence determination table and an event content determination table. In the event occurrence determination table, information indicating whether an event occurs or not and information indicating the probability of occurrence of the event are linked with each turn. Note that, here, it is assumed that the information indicating whether an event occurs or not and information indicating the probability of occurrence of the event etc. are specified with respect to each of the event type for all of the turns.

In addition, in the event content determination table, an event to occur or an event that can occur is preliminarily set for each turn and for each event type.

At the start of the turn, the event occurrence determination table is referred, and, first, whether an event is to occur or not is determined for each event type. Here, depending on the turn number and the event type, “occurrence” of an event is invariably determined. Furthermore, depending on the turn number and the event type, occurrence of an event with a probability of 50% is specified in some cases. In such a case, a lottery that determines the “occurrence” of the event with a probability of 50% is carried out.

Regarding the type of event determined to “occur”, the event content determination table is referred, and the content of the event to occur is determined. For example, according to the event occurrence determination table, it is set that a scenario event invariably occurs on the first turn. In addition, an event ID is allocated to each event. In the event content determination table, a scenario event having an event ID of 0001 is linked, with the first turn, as the event that can occur. Thus, when a raising main game is played, the scenario event having an event ID of 0001 invariably occurs on the first turn.

Similarly, according to the event determination table (event occurrence determination table and event content determination table), scenario events having event IDs of 0002, 0003, 0004, 0005, and 0006 are determined to occur on the fourth turn, the fifth turn, the sixth turn, the seventh turn, and the 10th turn, respectively.

Here, each event is roughly classified into a fixed event or a random event. A fixed event is an event that occurs on a fixed turn, in other words, an event that can occur on a particular turn but not on any other turn. Here, the scenario events having event IDs of 0001, 0002, 0003, 0004, 0005, and 0006 are all fixed events and scenario unique events.

In contrast, a random event is an event that has been determined to occur and that occurs when the event is determined to be an event to occur. FIG. 36 shows that, on the turn marked as “lottery”, whether an event occurs or not is determined by a lottery, and if it is determined to “occur”, then an event that wins a lottery among random events will occur.

Here, in the event content determination table, an event ID subject to a lottery is set for a turn on which an event that has won the lottery is to occur. For example, suppose that random events having event IDs of 0010, 0011, and 0012 are provided as the scenario events. Also suppose that, in the event content determination table, a scenario event having an event ID of 0010 is linked with the 12th turn.

In such a case, a lottery for determining whether the scenario event occurs is carried out at the start of the 12th turn. If the lottery is won, the scenario event having an event ID of 0010 occurs, and if the lottery is not won, the scenario event does not occur.

Also suppose that, for example, in the event content determination table, scenario events having event IDs of 0010, 0011, and 0012 are linked with the 15th turn. If the lottery of whether the event occurs or not is won, a scenario event to occur is determined by a lottery from among the events having event IDs of 0010, 0011, and 0012, and the scenario event that won the lottery occurs.

Note that, in the description heretofore, the case in which fixed events and random events are exclusively provided has been explained. However, when a scenario event to occur is determined by a lottery, fixed events may be set as the subject of the lottery in addition to the random events or instead of the random events.

Here, in this embodiment, the fourth to seventh turns are set as diverging turns. A diverging turn is a turn on which the content of the event is modified upon satisfying a specified condition. Here, the set specified condition is that a specified number of special characters are included in the team members, in other words, a specified number of special characters are included in the main character and the support characters.

Specifically, on the fourth turn, it is judged whether a specified number, which is four, of special characters are included in the team members. When four special characters are included in the team members, the scenario event is replaced by a team member event. A team member event includes a special character event set with respect to each special character. Here, when special characters are included in the team members, the scenario event is replaced by a special character event on the diverging turn.

Similarly, on the fifth, sixth, or seventh turns, it is judged whether a specified number, which is three, two, or one, of special characters are included in the team members. When the specified number of special characters are included in the team members on each turn, the scenario event is replaced by a special character event.

Specifically, scenario events having event IDs of 0002, 0003, 0004, and 0005 are story events. In these story events, a story is played in which although the team members try to come up with the team name, no team name is ultimately proposed, ending the story. Thus, if special characters are not included in the team members, no team name is proposed for four consecutive turns.

In contrast, when special characters are included in the team members, as many scenario events as the number of special characters are replaced by special character events. A special character event is a story event. The story played in the special character event is that a team name is proposed by a special character. There are four special characters, and a different team name is proposed by each special character. Thus, if special characters are included in the team members, as many team names as the number of special characters will be proposed on the fourth to seventh turns.

A scenario event having an event ID of 0006 occurring on the 10th turn is a story event. In this story event, a story that allows the player to select a team name is played. Here, a total of five team names, that is, four team names respectively proposed by the four special characters and one team name preliminarily set as a default, are provided.

If no special character is included in the team members and no team name is proposed during the fourth to seventh turns, the only team name that the player can select on the 10th turn is the default team name. In such a case, the player must select the default team name. Furthermore, for example, when two team names are proposed during the fourth to seventh turns, the player can select one from a total of three team names, that is, two proposed team names and one default team name.

The team name selected by the player on the 10th turn is registered as an official team name and used hereafter in a variety of scenes until the raising main game ends. It should be noted that a benefit corresponding to the registered team name may be given to the player at a specified timing before the end of the raising main game. Examples of the benefit given to the player include acquisition of a skill corresponding to the registered team name, increases in ability parameters and aptitude parameters, and acquisition of in-game currency.

As such, the scenario events having event IDs of 0002, 0003, 0004, 0005, and 0006 and the special character events used as replacements during the fourth to seventh turns are all scenario unique events. A scenario ID is linked with an event ID that can occur and administered. Accordingly, the scenario events and the special character events that occur during the fourth to seventh turns and on the 10th turn are linked with only one scenario ID.

Moreover, according to the event determination table, dedicated events having event IDs of 1001 and 1002 occur on the second turn and the eighth turn. In addition, according to the event determination table, whether a dedicated event occurs or not or which dedicated event is to occur are determined by a lottery on the third to seventh turns, the ninth turn, the 11th turn, and the 12th turn.

Here, the dedicated event differs for each character. The relationship between the turn number and the dedicated event to occur is set with respect to each character. Thus, the turn on which a dedicated event occurs and the dedicated event that occurs in each turn differ according to the character registered as the main character.

In addition, as illustrated in FIG. 36, the event determination table sets whether a support event occurs or not on a specified turn and sets that the content of the support event to occur is determined by a lottery. It should be noted that for a support event also, the event ID that can win the lottery may differ for each turn or may be the same throughout all of the turns.

The probability with which “occurrence” wins a lottery for determining whether a support event occurs or not is not affected by the registered support cards. In other words, the probability with which occurrence of a support event is determined on each turn is the same regardless of the registered support cards. Meanwhile, when “occurrence” of a support event is determined, the content of the support event is determined, and, here, the probability with which the content of the support event would be determined changes depending on the registered support cards.

Specifically, when “occurrence” of a support event is determined, the event IDs of the support events that can occur on that turn are extracted on the basis of the event content determination table. Then, on the basis of the extracted event IDs, a lottery table is generated, and one event ID is determined on the basis of the generated lottery table.

Here, the extracted event IDs may include an event ID of a support event linked with a registered support card and an event ID of a support event not linked with a registered support card. In such a case, in the lottery table, the winning probability of the event ID of the support event linked with the registered support card is set to be higher than the winning probability of the event ID of the support event not linked with the registered support card. In this manner, the support event linked with the registered support card has a higher occurrence probability than other support events.

As such, on each turn, the support event occurrence probability is not affected by the registered support cards, but the content of the support event to occur is affected by the registered support cards.

However, the probability with which a support event occurs or the content (type) of a support event to occur may change depending on the registered support cards. In other words, the number of events that occur and the occurrence probability of events during the raising main game may differ depending on the registered support cards.

On each turn, whether a team member event occurs or not, etc., is determined by a lottery. The team member event determined by the lottery is limited to an intensive training event. Hereinafter, the intensive training event is described in detail.

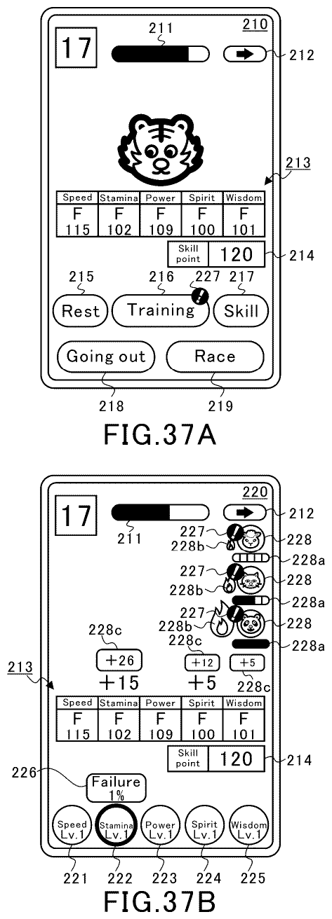

FIG. 37A is a third diagram illustrating the game screen 210. FIG. 37A illustrates the case in which an intensive training event occurs on this turn. In this case, as illustrated in FIG. 37A, an event notification indicator 227 is displayed near the training operation portion 216 in the game screen 210.

FIG. 37B is a third diagram illustrating the training screen 220. When the training operation portion 216 in the game screen 210 is operated, the training screen 220 is displayed on the display 26. When an intensive training event corresponding to the character displayed in the assigned character icon 228 in the training screen 220 is to occur, the event notification indicator 227 is displayed near the assigned character icon 228 of the corresponding character.

As illustrated in FIG. 37B, a bond gauge 228a and a special icon 228b are displayed for each assigned character icon 228 of the character assigned to the training. The bond gauge 228a indicates a parameter (hereinafter referred to as the bond parameter) that increases according to the number of times joint training with the corresponding team member characters is conducted. This bond parameter is initially set to 0 and increases up to 100. The bond gauge 228a visually indicates the value of the bond parameter.

The special icon 228b indicates the number of times the intensive training event related to the corresponding team member character is conducted. Although detailed descriptions are provided below, the special icon 228b is displayed in a display mode corresponding to the number of times the character of the displayed assigned character icon 228 for which the special icon 228b is displayed has undergone the intensive training event.

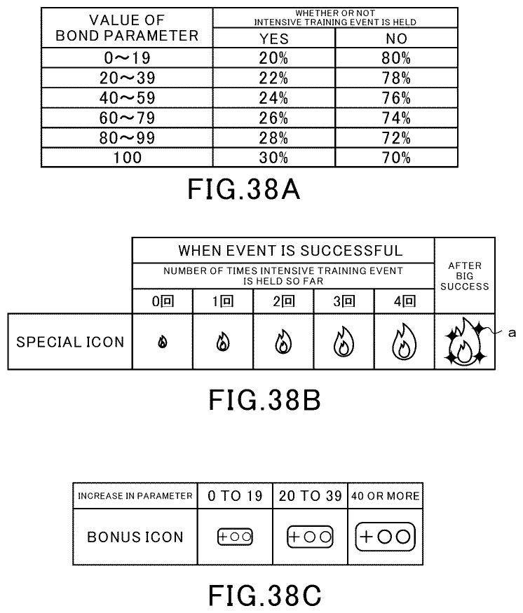

FIG. 38A is a diagram illustrating a table that determines whether an intensive training event will be held or not. When assignment of team members to the training items is determined, whether a special event will be held is determined by a lottery for each team member assigned to the training item on the basis of the table that determines whether an intensive training event will be held or not illustrated in FIG. 38A. Hereinafter, the team member determined to undergo an intensive training event may also be referred to as an intensive training subject team member.

Specifically, as illustrated in FIG. 38A, the selection probability of whether an intensive training event is held or not is set on the basis of the value of the bond parameter of the intensive training subject team member. Here, the selection probability is set so that the larger the value of the bond parameter, the more likely the intensive training event would be held. Here, the intensive training event can occur as many times as the number of the team members winning the lottery. However, for one training item, there may be a limit to the number of team members subject to intensive trainings that can occur simultaneously.

FIG. 38B is a diagram illustrating a special icon determination table. The intensive training event includes a “success” pattern and a “big success” pattern. When the fifth-time intensive training event is held for each intensive training subject team member, this intensive training event is invariably held in the “big success” pattern. Meanwhile, when an intensive training event other than the fifth time is held for each intensive training subject team member, that intensive training event is invariably held in the “success” pattern. In other words, for one intensive training subject team member, an intensive training event in the “big success” pattern can be held only once. Here, the event notification indicator 227 may be displayed in different modes depending on the content of the intensive training event to be held (“success” pattern or “big success” pattern) or the number of team members for which the intensive training events have been determined to be held.

As illustrated in FIG. 38B, when the number of times the intensive training event related each intensive training subject team member is held is 0 to 4, in other words, when the intensive training event in the “big success” pattern has not yet been held, the special icon 228b is displayed in a bigger size as the number of times the intensive training event is held increases.

It should be noted that whether the intensive training event is held in the “big success” pattern or the “success” pattern may be determined by a lottery. In this case, the lottery probability may be set such that the larger the number of times the intensive training event for the intensive training subject team member is held, the more likely the “big success” pattern is selected. In such a case, the bigger the special icon 228b, the more likely the “big success” pattern would be selected, and thus, the special icon 228b suggests the likelihood of selecting the “big success” pattern.

After the intensive training event is held in the “big success” pattern, that is, when the number of times the intensive training event is held on the intensive training subject team member is 5 or more, the special icon 228b is displayed in a bigger size than when the number of times the intensive training event is held on the intensive training subject team member is 0 to 4. Furthermore, as illustrated in FIG. 38B, a suggestion indicator a that suggests that the intensive training event has already been held in the “big success” pattern is displayed.

When an intensive training event occurs and when the intensive training event is in the “success” pattern, the ability parameters of the intensive training subject team member and the ability parameters of the main character increase within a specified range. When an intensive training event occurs in the “big success” pattern, the ability parameters of the intensive training subject team member and the ability parameters of the main character increase beyond the specified range.

As illustrated in FIG. 37B, when it is determined that an intensive training event will be held, a bonus icon 228c indicating the value of increase in the ability parameter of the main character by the intensive training event is displayed in the status display portion 213 in the training screen 220.

FIG. 38C is a diagram illustrating a bonus icon determination table. The bonus icon 228c is displayed in a size that changes according to the value by which the ability parameter of the main character increases as a result of the intensive training event. Here, the bonus icon 228c is displayed in a larger size when the value by which the ability parameter of the main character increases as a result of the intensive training event is 20 to 39 than when the value is 0 to 19. The bonus icon 228c is displayed in a larger size when the value by which the ability parameter of the main character increases as a result of the intensive training event is 40 or more than when the value is 20 to 39.

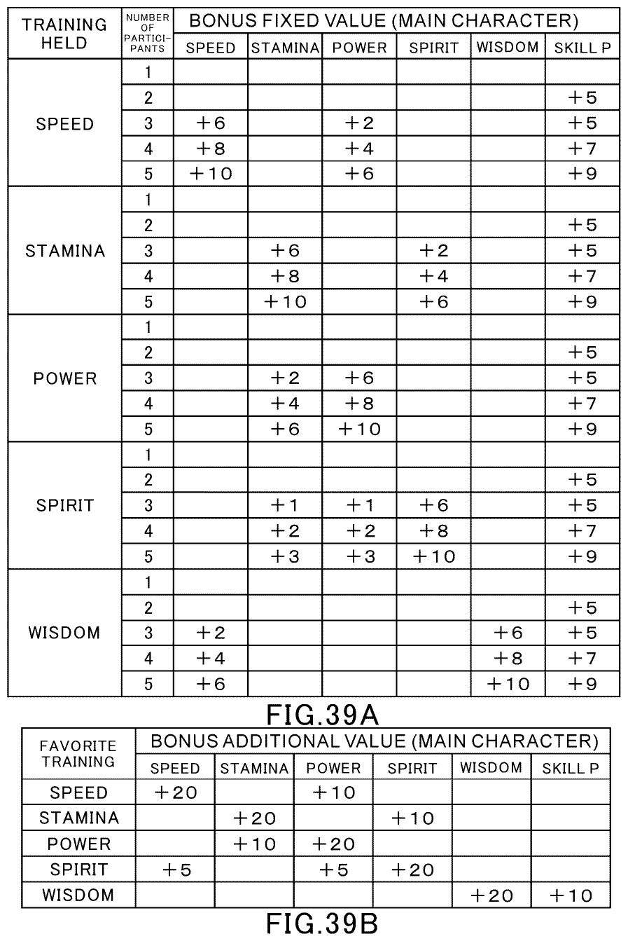

FIG. 39A is a diagram illustrating a bonus fixed value (main character) table. When the aforementioned intensive training event is held, the value by which the ability parameter of the main character increases as a result of the intensive training event is determined according to the number of team members for which the intensive training event is determined to be held. Here, as illustrated in FIG. 39A, the larger the number of team members for which the intensive training event is determined to be held, the larger the value (bonus fixed value) by which the ability parameter of the main character increases as a result of the intensive training event.

FIG. 39B is a diagram illustrating a bonus additional value (main character) table. When an intensive training event is held in the “big success” pattern, in addition to the aforementioned bonus fixed value, the value (bonus additional value) by which the ability parameter of the main character increases as a result of the intensive training event in the “big success” pattern is determined. Here, as illustrated in FIG. 39B, the value (bonus additional value) by which the ability parameter of the main character increases is set with respect to the favorite training of the team member for which the intensive training event is to be held in the “big success” pattern. That is, the value by which the ability parameter of the main character increases as a result of the intensive training event is the sum of the aforementioned bonus fixed value and the bonus additional value.

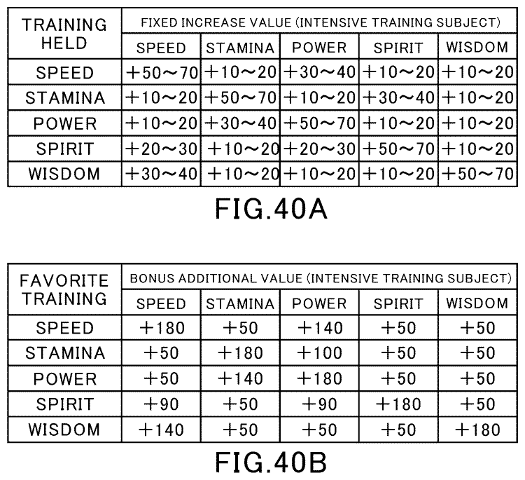

FIG. 40A is a diagram illustrating a fixed increase value (intensive training subject) table. When the aforementioned intensive training event is to be held, the value (fixed increase value) by which the ability parameter of an intensive training subject team member increases as a result of the intensive training event is determined. Here, as illustrated in FIG. 40A, the range of the value (fixed increase value) by which the ability parameter of the intensive training subject team member increases is set with respect to the type of the training held. Here, the value (fixed increase value) within the range set in FIG. 40A is determined by a lottery.

FIG. 40B is a diagram illustrating a bonus increase value (intensive training subject) table. When an intensive training event is to be held in the “big success” pattern, in addition to the fixed increase value described above, the value (bonus increase value) by which the ability parameter of the intensive training subject team member increases as a result of the intensive training event is determined. Here, as illustrated in FIG. 40B, the value (bonus increase value) by which the ability parameter of the intensive training subject team member increases is set with respect to the favorite training of the intensive training subject team member for which the intensive training event is to be held in the “big success” pattern.

Note that, when an intensive training event is to be held in the “big success” pattern, a boosting event that further increases the ability parameter of the intensive training subject team member or the ability parameter of the main character may be held according to the number (the number of times) of the simultaneously held intensive training events in the “big success” pattern. For example, the value by which the ability parameter of the intensive training subject team member or the ability parameter of the main character increases may be further increased as the number (the number of times) of the simultaneously held intensive training events in the “big success” pattern increases.

As mentioned above, when an intensive training event occurs, the ability parameters of the main character and the intensive training subject team members increase. Here, when the main character or the intensive training subject team member is a special character, the fixed increase value or the bonus increase value may be multiplied by a specified addition rate. That is, when the main character or the intensive training subject team member is a special character, the ability parameter increases by a larger value than when the main character or the intensive training subject team member is not a special character.

As mentioned above, in the raising main game, the player can increase the number of team members as the turns progress. In addition, the player can increase the ability parameters of the main character and the team members as the turns progress. The ability parameter increases as a result of a successful training or occurrence of various events. As mentioned above, in the training, a bonus additional value is added when a special character is assigned to the training item.

Although the detailed description is omitted, when the main character or the support character is a special character, a specified bonus additional value is added upon occurrence of the ability event. Thus, the player can have the raising main game progress favorably by registering a special character as the main character or the support character.

When a special character is included in the team members, a special character event occurs on a diverging turn. Thus, the player can increase the number of choices that can be made during the game and can make the game more exciting by registering a special character as the main character or the support character.

When all of the turns in the aforementioned raising main game end, the raising game ends. If the target set with respect to each character could not be attained during the raising main game, the raising game ends at that time point.

Here, when the raising game ends, the main character raised in the raising game is stored as a raised character. To be more precise, information regarding the raised character raised in the raising game (hereinafter referred to as the raised character information) is linked with the player ID and stored. Here, the raised character information is stored in both the player terminal 1 and the server 1000. The raised character information linked with the player ID and stored includes the ability parameters, the aptitude parameters, the acquired skills, inheritance information, etc.

When the raising game ends, the score of the raised character is calculated. Here, the score is calculated on the basis of the ability parameters, the aptitude parameters, the acquired skills, the record of the individual races, the record of the team raises, etc., at the end point of the raising game. The method for calculating the score, in other words, the calculation formula used to calculate the score, is prepared in advance, and the score is calculated on the basis of the specified calculation formula. However, the score calculation method and calculation formula are not particularly limited. For example, the score may be calculated solely on the basis of the parameters, such as the ability parameters, the aptitude parameters, and the acquired skills at the end point of the raising game, that will affect race results when the raised character participates in races in a team competition game and other race games.

A raising rank is set to the raised character on the basis of the score. The raising rank is an indicator of the strength of the raised character, and each raising rank is associated with a score range. For example, a raised character with a score of 13000 to 14499 is given the “A+” raising rank, and a raised character with a score of 14500 to 15499 is given the “S” raising rank. As such, when a raising rank is given on the basis of the score, the rough estimate of the strength of the raised character is easily identifiable. Note that the raised character information includes the score and the raising rank.

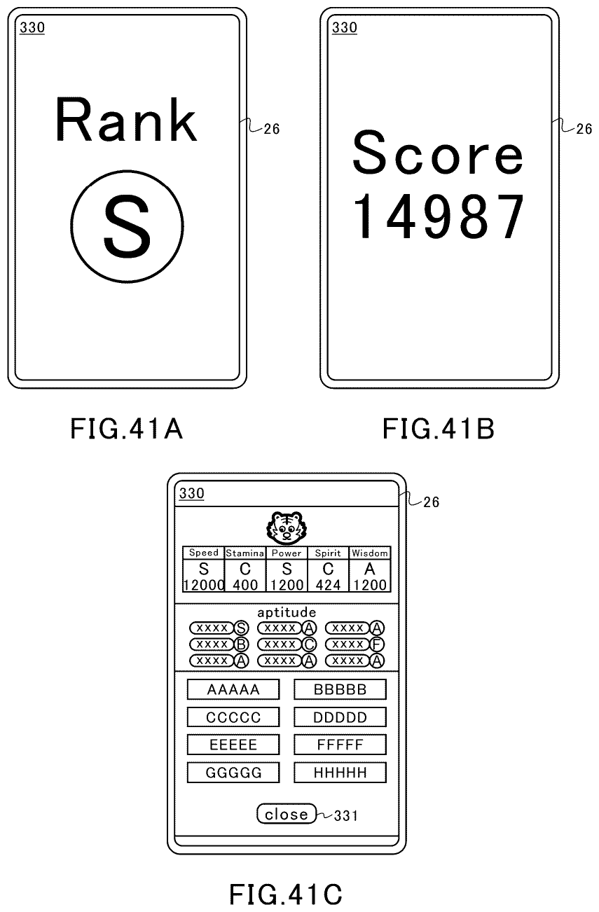

FIG. 41A is a first diagram illustrating a raising complete screen 330. FIG. 41B is a second diagram illustrating the raising complete screen 330. FIG. 41C is a third diagram illustrating the raising complete screen 330. When the raising game ends, as illustrated in FIG. 41A, the raising complete screen 330 appears on the display 26. In the raising complete screen 330, the raising rank of the raised character is displayed first, and then the score is displayed as illustrated in FIG. 41B.

In addition, after a specified time has elapsed since the display of the score, as illustrated in FIG. 41C, the ability parameters, the aptitude parameters, and the acquired skills of the raised character are displayed in the raising complete screen 330. Here, a close operation portion 331 is provided in the raising complete screen 330. When the close operation portion 331 is tapped, the raising complete screen 330 disappears, and the home screen 100 appears on the display 26.

Note that, once the raising game ends, a lottery of a factor to be acquired by the main character is carried out, and the raised character is linked with the factor information and stored. Although not illustrated in the drawing, the player can make the factor information acquired by the raised character appear in the raising complete screen 330.

The raised character generated as described above can now participate in various races other than the raising game. In this embodiment, race games that the raised character can participate are a team competition game, a practice match, a room match, a daily race, and an event race (second game).

### (Team Competition Game)

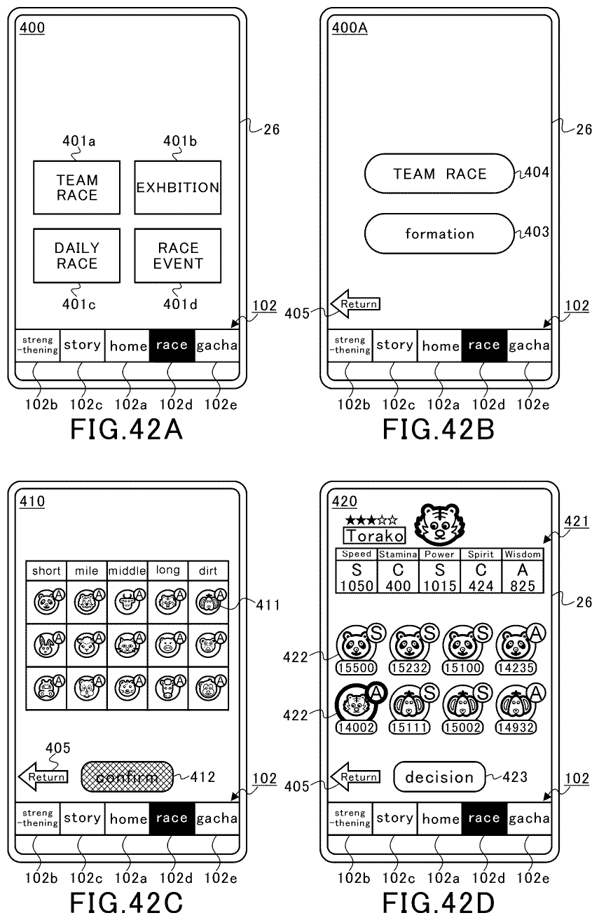

FIG. 42A is a diagram illustrating a race game select screen 400. FIG. 42B is a diagram illustrating a team competition race screen 400A. When the race game select operation portion 102d is tapped, the race game select screen 400 illustrated in FIG. 42A appears. In the race game select screen 400, a team competition game select operation portion 401a, a practice race select operation portion 401b, a daily race select operation portion 401c, and a race event select operation portion 401d are displayed.

When the team competition game select operation portion 401a is tapped, the team competition race screen 400A illustrated in FIG. 42B appears. In the team competition race screen 400A, a formation select operation portion 403, a team competition game start operation portion 404, and a return operation portion 405 are displayed. When the return operation portion 405 is tapped, the screen transitions onto the race game select screen 400 illustrated in FIG. 42A. When the formation select operation portion 403 is tapped, the team formation screen 410 is displayed on the display 26.

FIG. 42C is a diagram illustrating the team formation screen 410. In the team formation screen 410, the player can form a team used in a team competition game. The team competition game includes five types of races: a short distance race, a mile race, a middle distance race, a long distance race, and a dirt race. Each race is carried out in the form of a match between a team (hereinafter referred to as the player team) formed by the player and a team (hereinafter referred to as the opponent team) selected as the opponent by the player. In each of the five types of races, the team to which the raised character winning the first place belongs wins the race. In addition, the player wins when the player team wins more races than the opponent team.

In the team formation screen 410, the player can form a short distance team corresponding to the short distance race, a mile team corresponding to the mile race, a middle distance team corresponding to the middle distance race, a long distance team corresponding to the long distance race, and a dirt team corresponding to the dirt race. The maximum number of raised characters that can be registered for each team is three. The player can register the raised characters raised by the player into the team. Hereinafter, a raised character registered into a team is referred to as a registered character.

As illustrated in FIG. 42C, character icons 411 corresponding to registered characters are displayed team-by-team in the team formation screen 410. When a character icon 411 is tapped, the registered character corresponding to the tapped character icon 411 enters a temporary selected state, and a raised character list screen 420 appears on the display 26.

FIG. 42D is a diagram illustrating the raised character list screen 420. In the raised character list screen 420, the player can select a registered character. Specifically, an image of the raised character in the temporary selected state and an ability parameter display box 421 are displayed in the upper portion of the raised character list screen 420. The ability parameters of the raised character in the temporary selected state are displayed in the ability parameter display box 421.

Raised character icons 422 corresponding to the raised characters in the player's possession are displayed below the ability parameter display box 421. When a raised character icon 422 is tapped, the raised character corresponding to the tapped raised character icon 422 enters a temporary selected state. As such, when the raised character in the temporary selected state is changed, what is displayed in the ability parameter display box 421 also changes simultaneously.

A determination operation portion 423 is provided in the raised character list screen 420. In the raised character list screen 420, when the determination operation portion 423 is tapped after a raised character different from the registered character has entered a temporary selected state, the registered character is changed. When the registered character is changed, a team formation screen 410 illustrated in FIG. 42C appears. Here, character icons 411 corresponding to registered characters after the change are displayed in the team formation screen 410.

A confirmation operation portion 412 is provided in the team formation screen 410. In the state where the registered characters are not changed, the confirmation operation portion 412 is grayed out as illustrated in FIG. 42C. In this state, the operation on the confirmation operation portion 412 is disabled. Meanwhile, in the state where the registered characters are changed, the operation on the confirmation operation portion 412 is enabled. When the confirmation operation portion 412 accepts the operation, the change of the registered character is finalized.

The return operation portion 405 is provided in the team formation screen 410 and the raised character list screen 420. When the return operation portion 405 is tapped in the team formation screen 410, the team competition race screen 400A illustrated in FIG. 42B appears. Note that, when the return operation portion 405 is tapped in the team competition race screen 400A in a state where the registered characters are changed, the change of the registered characters is cancelled. Thus, in such a case, the registered characters remain unchanged, and the team formation screen 410 is displayed.

In addition, when the return operation portion 405 is tapped in the raised character list screen 420, the raised character list screen 420 illustrated in FIG. 42C appears. Note that, when the return operation portion 405 is tapped in the raised character list screen 420 in a state where the registered characters are changed, the change of the registered characters is cancelled. Thus, in such a case, the registered characters remain unchanged, and the team formation screen 410 is displayed.

Furthermore, when a character icon 411 in the team formation screen 410 is tapped and held and when a raised character icon 422 in the raised character list screen 420 is tapped and held, the character detail dialogue 185A appears on the display 26.

Furthermore, when the team competition game start operation portion 404 in the team competition race screen 400A illustrated in FIG. 42B is tapped, an opponent team select screen 440 appears. Although the detailed description is provided below, when the team competition game start operation portion 404 is tapped, opponent teams are extracted in the server 1000.

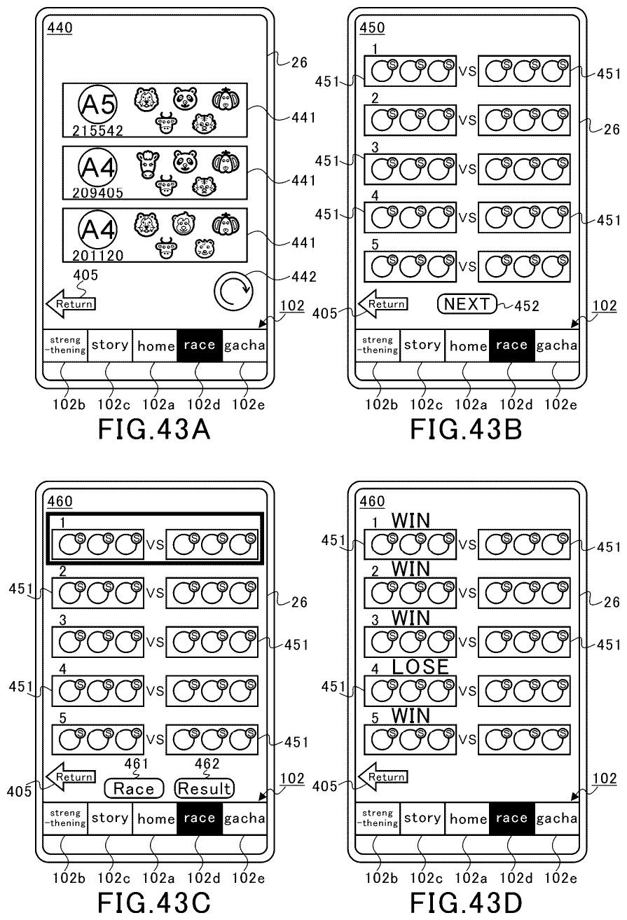

FIG. 43A is a diagram illustrating the opponent team select screen 440. In the opponent team select screen 440, opponent team icons 441 corresponding to the opponent teams are displayed. Here, three opponent teams are extracted in the server 1000. Thus, in the opponent team select screen 440, three opponent team icons 441 are displayed. For each of the opponent team icons 441, a total score of the team and a rank corresponding to the total score are indicated. The total score is calculated as a total of the scores of all registered characters in the team, various aptitudes, etc.

In the server 1000, opponent teams are extracted on the basis of the total score of the player team currently set. Here, one team is extracted from teams that have higher scores than the total scores of the player team within a first range (for example, in the range of +8000 to 10000 points), one team is extracted from teams that have scores different from the total score of the player team within a second range (for example, in the range of −2000 to +2000 points), and one team is extracted from the teams that have scores lower than the total score of the player team within a third range (for example, in the range of −8000 to −10000 points). Note that the teams extracted as the opponent teams at this stage are the teams that have been set as the player teams by other players.

In the opponent team icon 441, character images of leaders of five teams respectively corresponding to the five types of races are displayed. In the team formation screen 410, a registered character corresponding to a character icon 411 displayed at the top row of each team is the leader.

A reload operation portion 442 is provided in the lower part of the opponent team select screen 440. When the reload operation portion 442 is tapped, three opponent teams are again extracted in the server 1000, and the opponent team icons 441 are changed. Note that when the return operation portion 405 in the opponent team select screen 440 is tapped, the team competition race screen 400A illustrated in FIG. 42B appears. When one of the opponent team icons 441 is tapped in the opponent team select screen 440, a start confirmation screen 450 appears. Here, the player can play a team competition game by spending a specified value (for example, 1) of race playing points. Specified race playing points (for example, +1) are given to the player every specified period of time (for example, 2 hours). The upper limit (for example, 5) is set for the race playing points the player can keep, and the player can keep the race playing points within the upper limit.

FIG. 43B is a diagram illustrating the start confirmation screen 450. In the start confirmation screen 450, team icons 451 indicating the participating characters are displayed with respect to the five types of races: a short distance race, a mile race, a middle distance race, a long distance race, and a dirt race. A team icon 451 is provided for each of the player team and the opponent teams. Here, the team icons 451 of the player teams are displayed on the left side of the start confirmation screen 450, and the team icons 451 of the opponent teams are displayed on the right side of the start confirmation screen 450.

The return operation portion 405 and a start operation portion 452 are provided in the lower part of the start confirmation screen 450. When the return operation portion 405 is tapped, the team competition race screen 400A illustrated in FIG. 42B appears. However, even when the screen has transitioned onto the team competition race screen 400A, the player cannot cancel the opponent team once selected. Thus, when the return operation portion 405 is tapped in the start confirmation screen 450, the opponent teams are saved. Furthermore, when the team competition game start operation portion 404 in the team competition race screen 400A is tapped in a state where the opponent teams are saved, the start confirmation screen 450 illustrated in FIG. 43B appears again.

Here, when the start operation portion 452 in the start confirmation screen 450 is tapped, a result list screen 460 appears.

FIG. 43C is a first diagram illustrating the result list screen 460. FIG. 43D is a second diagram illustrating the result list screen 460. As in the start confirmation screen 450, in the result list screen 460 also, the team icons 451 are displayed with respect to the race type, and the team icons 451 of the race for which the race results are to be displayed are highlighted. In FIG. 43C, the team icons 451 of the first race displayed at the top of the column are highlighted.

A race video play select portion 461 and a result display select portion 462 are provided in the lower part of the result list screen 460. When the race video play select portion 461 is tapped, the race video of the highlighted race plays. When the race video ends playing, as illustrated in FIG. 43D, whether the player team has won or lost is identified and displayed. When the result display select portion 462 is tapped, the race video does not play, and only the race results are displayed as illustrated in FIG. 43D. When the race results are displayed, the order of arrival of each of the participant registered characters is displayed in the team icon 451.

Note that, in a team competition race, the aforementioned five types of races are held, and the order in which these races are held is determined at random by a lottery. The race results (the order of arrival of the raised characters and the outcome of each race) of each of the race types are derived in the determined order. When the race results of the five types of races are displayed in the result list screen 460, a comprehensive race result screen 470 appears.

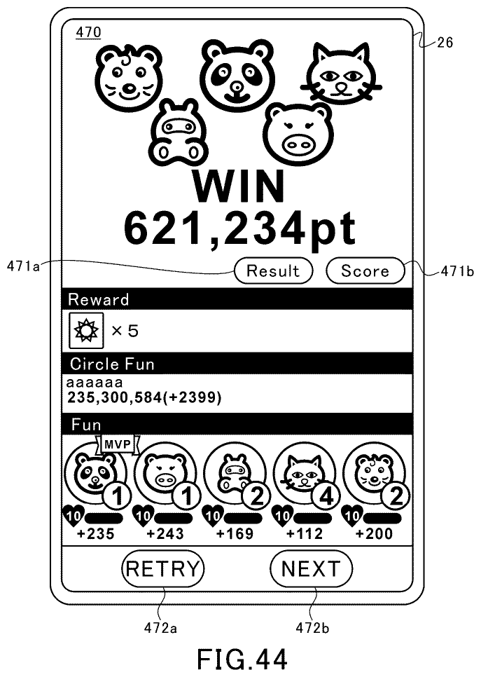

FIG. 44 is a diagram illustrating the comprehensive race result screen 470. Character images of the leaders of the five teams are displayed in the upper portion of the comprehensive race result screen 470, and, under these character images, the win/lose of the team and the total race points of the player team are displayed. Although the detailed description is omitted, in the team competition game, race points are determined for each registered character participating in the race according to the preset point granting terms.

Examples of the point granting terms include various terms to be attained during the race, such as the order of arrival and the number of skills activated during the race. In addition, for example, a point granting term that grants race points on the basis of the position among the characters of the same running style at a specified timing during the race is set. The race points are determined with respect to each registered character, and race-type race points, which are a total of the race points of the registered characters participated in the same race type, are calculated with respect to each race type. Then the race points of all registered characters are totaled, and specified bonus points etc. are added thereto to calculate total race points.

As for the point granting terms for the bonus points, for example, a consecutive winning bonus may be set so that bonus points corresponding to the number of consecutive wins are granted to the team that achieved consecutive wins. In addition, for example, specified bonus points may be granted as the leader bonus to the race points of the registered character serving as the leader of the team. Furthermore, for example, bonus points may be granted as the opponent bonus according to the total score of the opponent team. Furthermore, for example, bonus points may be granted as the support rooting bonus according to the level of the support cards in the player's possession.

Note that, when a team competition race is held, a reward may be granted to the player. In the comprehensive race result screen 470, the rewards granted to the player are displayed. Moreover, when a team competition race is held, the registered characters that have participated in the race acquire fans. When the player belongs to a circle, the total number of fans acquired by the registered characters is added to the number of fans of that circle. In the comprehensive race result screen 470, the number of fans of the circle and the number of fans acquired by this team competition race are displayed.

Furthermore, for each of the registered characters that have participated in the race, the icon indicating the registered character, the order of arrival, the number of fans acquired, and the affection level meter are displayed in the lower portion of the comprehensive race result screen 470. Note that, in FIG. 44, only five registered characters are displayed; however, the player can confirm the information of all registered characters by scrolling the screen in vertical directions.

In the team competition race, the registered character that has acquired the most race points is selected as an MVP. In the comprehensive race result screen 470, the icon marking “MVP” is superimposed on the icon of the registered character that has acquired the MVP.

In the comprehensive race result screen 470, a race result display icon 471a and a score display icon 471b are provided. When the race result display icon 471a is tapped, the result list screen 460 illustrated in FIG. 43D appears. When the score display icon 471b is tapped, a score list screen 480 appears.

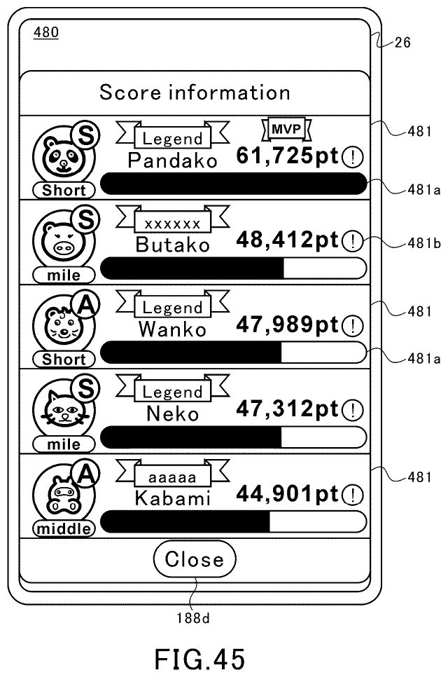

FIG. 45 is a diagram illustrating the score list screen 480. In the score list screen, a score display box 481 is displayed for each registered character that has participated in the race. In the score display box 481, the icon corresponding to the registered character, the raising rank, the participated race type are identified and displayed. Furthermore, the nickname and character name of the registered character are displayed. In each score display box 481, the race points acquired by the registered character are displayed.

In the score list screen 480, the score display boxes 481 of the registered characters are displayed in the descending order of the acquired race points. Each score display box 481 includes a meter 481a that indicates the proportion of the race points acquired by the corresponding registered character by assuming the highest race points acquired by the registered character, i.e., the race points acquired by the registered character displayed in the top box, to be 100.

In the score display box 481, a detail icon 481b is provided near the race point. When the detail icon 481b is tapped, a score detail screen not illustrated in the drawing appears. In the score detail screen, the breakdown of the race points, that is, the detail information about which point granting terms have been achieved to acquire the race points, is displayed.

Referring back to FIG. 44, a retry operation portion 472a and a next operation portion 472b are provided at the bottom of the comprehensive race result screen 470. When the retry operation portion 472a is tapped, the opponent team is redrawn, and the opponent team select screen 440 illustrated in FIG. 43A appears. When the next operation portion 472b is tapped, the team competition race ends, and the team competition race screen 400A illustrated in FIG. 42B appears.

As described above, in the team competition game, the player can form a team by using the raised characters and can have the team compete with a team formed by another player. Since the comprehensive race points acquired by this competition are used to complete for the ranking with other players, a motivation for raising stronger raised characters is given to the player.

Here, in order to raise a stronger raised character in a raising game, more appropriate support cards and inheritance characters need to be selected. Thus, it is desirable that the player collect information for raising stronger raised characters. In this embodiment, in the team competition game, the player can browse the character detail dialogue 185A of the registered character of the opponent team by tapping and holding the team icon 451 of the opponent team displayed in the result list screen 460.

In this manner, for example, the player can confirm the inheritance information and the raising information regarding a raised character with a high score and, based on this knowledge, can raise a raised character similar to the registered character of the opponent team. However, a raised character with a high score does not always increase the win rate in the team competition game, and it is difficult to acquire information for forming an optimum team. If it is difficult to acquire appropriate information, the eagerness of the player to play the game is degraded.

To address this, in this embodiment, the player can carry out a practice match in which raised characters raised by other players participate. In this practice match, the player can have a raised character in the player's possession and raised characters in other player's possession participate in a desired race, and can confirm what the race result would be. In this manner, the player easily acquires information for raising stronger raised characters. The practice match will now be described.

### (Practice Match)

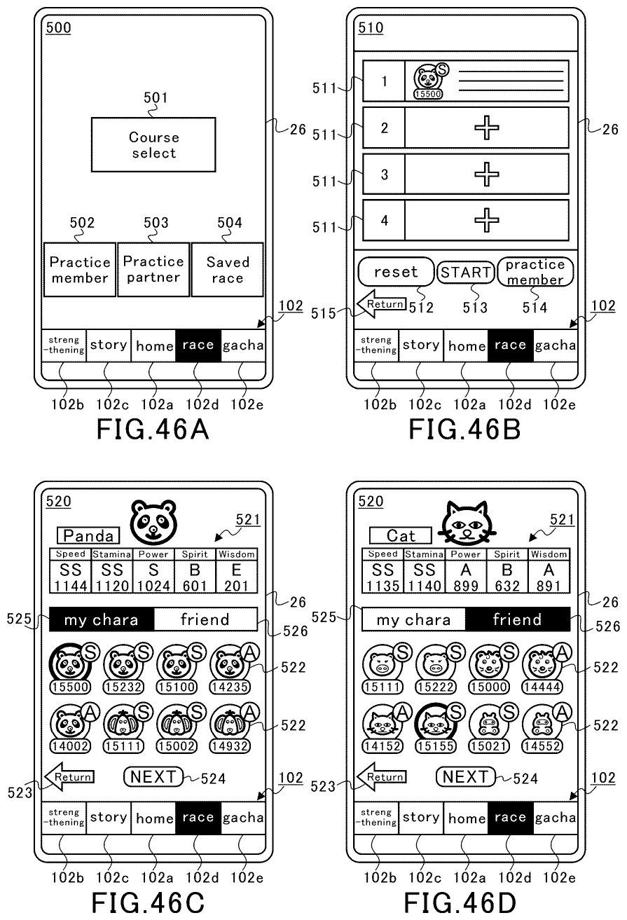

FIG. 46A is a diagram illustrating a practice match top screen 500. When a practice race select operation portion 401b in the race game select screen 400 illustrated in FIG. 42A is tapped, an exhibition select screen not illustrated in the drawing appears. In the exhibition select screen, the player can select a practice match or a room match. When a practice match is selected in the exhibition select screen, the practice match top screen 500 illustrated in FIG. 46A appears.

From the practice match top screen 500, the player can set such items as various race conditions such as courses and raised characters participating in the race. When a course select operation portion 501 in the practice match top screen 500 is tapped, a race condition setting screen not illustrated in the drawing appears.

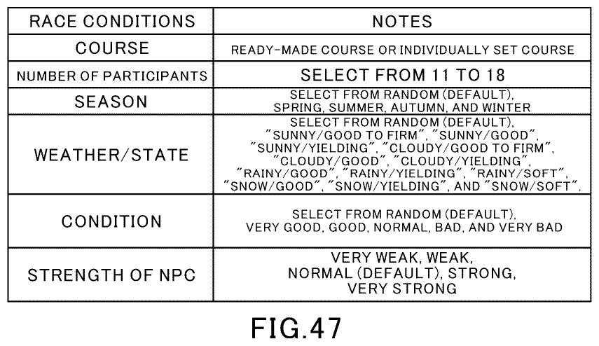

FIG. 47 is a diagram illustrating race conditions. In the race condition setting screen, the player can freely set the race conditions. Specifically, the player can select the course to participate from existing courses or can separately set up a course. The player can set the number of participants within the range of 11 to 18. Furthermore, the player can set the season to be random, spring, summer, autumn, or winter. When the season is set to be random, the season is determined by a lottery at random at the start of the race.

Furthermore, the player can set the weather/state to one of random and twelve patterns illustrated in the drawing. When random is selected, the weather/state is determined at random by a lottery at the start of the race. Furthermore, the player can set the condition to be random or any one of five patterns illustrated in the drawing. When random is selected, the condition is determined by a lottery at random at the start of the race. When one of the patterns other than random is determined, the conditions of all participant characters are uniformly set to the selected condition. Furthermore, the player can set the strength of the NPC to any one of the five patterns illustrated in the drawing.

FIG. 46B is a diagram illustrating a participant character setting screen 510. Once the race conditions are set in the race condition setting screen, the participant character setting screen 510 is displayed on the display 26. In the participant character setting screen 510, a character setting tab 511, a reset operation portion 512, a start operation portion 513, a practice member display operation portion 514, and a return operation portion 515 are displayed. As many character setting tabs 511 as the number of participants set in the race condition setting screen are displayed. At the start of the display of the participant character setting screen 510, all of the character setting tabs 511 are displayed as blanks. When a character setting tab 511 is tapped, a participant character select screen 520 appears.

FIG. 46C is a first diagram illustrating the participant character select screen 520. FIG. 46D is a second diagram illustrating the participant character select screen 520. In the participant character select screen 520, the player can select raised characters that participate in a practice match. Specifically, the image of the raised character in the temporary selected state and an ability parameter display box 521 are displayed in the upper portion of the participant character select screen 520. The ability parameters of the raised character in the temporary selected state are displayed in the ability parameter display box 521.

Raised character icons 522 corresponding to the raised characters in the player's possession are displayed below the ability parameter display box 521. When a raised character icon 522 is tapped, a raised character corresponding to the tapped raised character icon 522 enters a temporary selected state. As such, when the raised character in the temporary selected state is changed, what is displayed in the ability parameter display box 521 also changes simultaneously.

A return operation portion 523 and a next operation portion 524 are provided in the participant character select screen 520. When the return operation portion 523 is tapped, the participant character setting screen 510 illustrated in FIG. 46B appears. In such a case, the raised character in the temporary selected state is cancelled. When the next operation portion 524 is tapped, the raised character in the temporary selected state is set as a participant character. In such a case, the screen transitions from the participant character select screen 520 onto the participant character setting screen 510. Here, as illustrated in FIG. 46B, the information regarding the raised characters set as the participant characters are displayed in the character setting tabs 511.

In the participant character select screen 520, a my character display tab 525 and a rental character display tab 526 are provided. In a state where the my character display tab 525 is tapped, as illustrated in FIG. 46C, raised character icons 522 corresponding to the raised characters in the player's possession are displayed. In a state where the rental character display tab 526 is tapped, as illustrated in FIG. 46D, a raised character icon 522 corresponding to a representative character of a friend or a character registered as a practice partner described below is displayed.

The player can freely select multiple characters to participate in the practice match from among the raised characters raised by the player, the representative characters of friends, and the practice partners. When a specified number (two or more) of characters are set as the participant characters, it becomes possible to hold a practice match. The specified number of characters may be any combination of any one or more of the raised characters raised by the player, the representative characters of friends, and practice partners. As such, in the participant character select screen 520, the player can make not only the raised characters in the player's possession but also the raised characters raised by other players participate in the practice match.

Here, in the participant character select screen 520, when a raised character icon 522 is tapped and held, the aforementioned character detail dialogue 185A appears. Thus, the player can also confirm the detail information of the raised character from the participant character select screen 520.

As described above, in the participant character select screen 520, the player can select, one-by-one, as many raised characters as the number of participants to participate in the practice match. When the reset operation portion 512 illustrated in FIG. 46B is tapped, the raised characters set as the characters to participate in the practice match are cancelled. When the start operation portion 513 is tapped in a state where as many raised characters as the number of participants are set, the practice match starts. When the return operation portion 515 is tapped, the set raised characters are cancelled, and the race condition setting screen appears.

As described above, it is cumbersome to set one-by-one as many raised characters as the number of participants to participate in the practice match. Thus, this embodiment provides a practice member registration function with which practice members including multiple raised characters are registered and the registered practice members are read-out as the raised characters to participate in the practice match. When the practice member display operation portion 514 in the participant character setting screen 510 is tapped, a practice member select screen 530 appears.

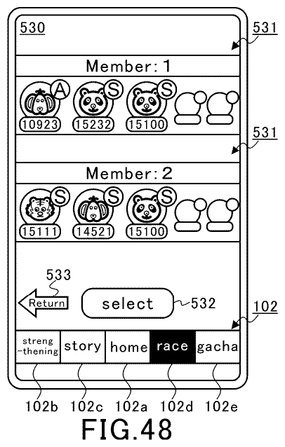

FIG. 48 is a diagram illustrating the practice member select screen 530. Although the details are described below, the player can register, in batch, the characters that have participated in the practice match as the practice members. In the practice member select screen 530, practice member display boxes 531 are displayed. The practice member display box 531 is displayed with respect to the registered practice members. In the practice member display box 531, an icon corresponding to a character included in the practice members is displayed. When this icon is tapped and held, the character detail dialogue 185A is also displayed as described above.

When the practice member display box 531 is tapped, the practice member corresponding to that practice member display box 531 enters a temporary selected state. When any one of the practice members is in the temporary selected state and a select operation portion 532 provided in the practice member select screen 530 is tapped, the raised character included in the practice member in the temporary selected state is set as a participant character of the practice match. To be more specific, all of the raised characters constituting the practice members are set as the participant characters. In such a case, the screen transitions from the practice member select screen 530 onto the participant character setting screen 510. Note that when the return operation portion 533 in the practice member select screen 530 is tapped, practice members in the temporary selected state are cancelled, and the participant character setting screen 510 appears.

In addition, as illustrated in FIG. 46A, a practice member operation portion 502, a practice partner operation portion 503, and a saved race operation portion 504 are provided in the practice match top screen 500. When the practice member operation portion 502 is tapped, a practice member list screen not illustrated in the drawing appears. The practice member list screen displays a list of the registered practice members.

Furthermore, as described above, this embodiment provides a practice partner registration function by which the raised characters raised by other players, such as friends, can be registered as practice partners. The raised characters of other players registered as the practice partners by the practice partner registration function are displayed in the participant character select screen 520.

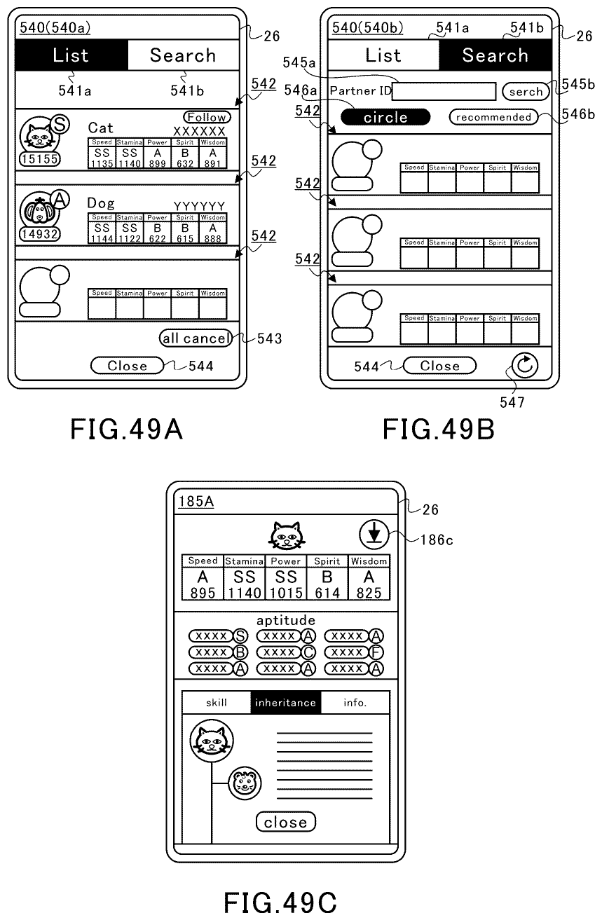

FIG. 49A is a first diagram illustrating a practice partner screen 540. FIG. 49B is a second diagram illustrating the practice partner screen 540. FIG. 49C is a fourth diagram illustrating the character detail dialogue 185A. When the practice partner operation portion 503 in the practice match top screen 500 illustrated in FIG. 46A is tapped, the practice partner screen 540 appears. The practice partner screen 540 includes a practice partner list screen 540a and a practice partner search screen 540b. When the screen transitions onto the practice partner screen 540, the practice partner list screen 540a appears on the display 26.

The practice partner screen 540 includes a list tab 541a and a search tab 541b. When the list tab 541a is tapped, the practice partner list screen 540a appears, and when the search tab 541b is tapped, the practice partner search screen 540b appears. In the practice partner list screen 540a, an information display box 542 is displayed with respect to each of the characters (hereinafter referred to as partner characters) currently registered as the practice partners.

In the information display box 542, the character image of the partner character, the score, the rank, the character name, the ability parameters, and the name of the player that raised the partner character are displayed. Furthermore, for example, when this other player has a specified relationship, such as follower, with the player, the information indicating the relationship with the player is displayed. For example, in the information display box 542 at the top of the FIG. 49A, “Follow” is displayed. This means that the partner character is raised by a player set as a follower.

Note that a cancel operation portion 543 is provided below the information display boxes 542. The player can cancel the registration of the partner character by tapping the cancel operation portion 543. In addition, when the close operation portion 544 in the practice partner screen 540 is tapped, the practice partner screen 540 closes, and the screen transitions onto the practice match top screen 500.

In addition, as illustrated in FIG. 49B, an input box 545a to which the partner ID can be input and a search operation portion 545b are provided in the practice partner search screen 540b. Although the details are described below, a partner ID is given to a raised character that one player has permitted another player to register this raised character as a practice partner. When the input box 545a is tapped, an input screen (not illustrated) to which numbers can be input appears. A partner ID can be input to the input box 545a through operation input to the input screen. When the search operation portion 545b is tapped in the state where the partner ID is input to the input box 545a, the information regarding the raised character to which that partner ID has been given appears in the information display box 542.

In the practice partner search screen 540b, a circle tab 546a and a recommendation tab 546b are provided. When the circle tab 546a is tapped, the information regarding the representative characters of other players belonging to the same circle as the player appears in the information display box 542. When the recommendation tab 546b is tapped, the information regarding the raised characters in other players' possession is displayed in the information display box 542 according to a specified search condition. Here, the search condition is not particularly limited, and, for example, raised characters in the friends' possession may be searched for.

In the practice partner search screen 540b, a reload operation portion 547 is provided. When the reload operation portion 547 is operated, for example, search is carried out again under changed search conditions.

When the information display box 542 in the practice partner screen 540 is tapped, as illustrated in FIG. 49C, the character detail dialogue 185A appears. The character detail dialogue 185A displayed here is, for example, the same as when the team icon 451 of the opponent team is tapped and held in the result list screen 460 (see FIG. 43D) displayed in the team competition game, for example.

Here, the character detail dialogue 185A is displayed not only when the raised character raised by the player is selected but also when the raised character raised by another player is selected. Here, the icon displayed in the character detail dialogue 185A differs depending on whether the raised character is raised by the player or by another player.

Specifically, a partner registration icon 186c is displayed in the character detail dialogue 185A of the raised character raised by another player. The player can register this raised character as a partner character by tapping the partner registration icon 186c.

In contrast, a share icon not illustrated in the drawing is displayed in the character detail dialogue 185A of the raised character raised by the player. The share icon is provided so that other players can register this raised character as a practice partner.

Referring back to FIG. 46B, in the participant character setting screen 510, in the state where all participant characters are set as described above, the practice match starts by tapping the start operation portion 513. When the start operation portion 513 is tapped, the simulation results of the race are derived on the basis of the ability parameters of the participant characters, etc. Then a race video is played on the basis of the derived simulation results. Note that, as with the team competition game described above, the player can select whether to play the race video or display only the race results for the practice match also.

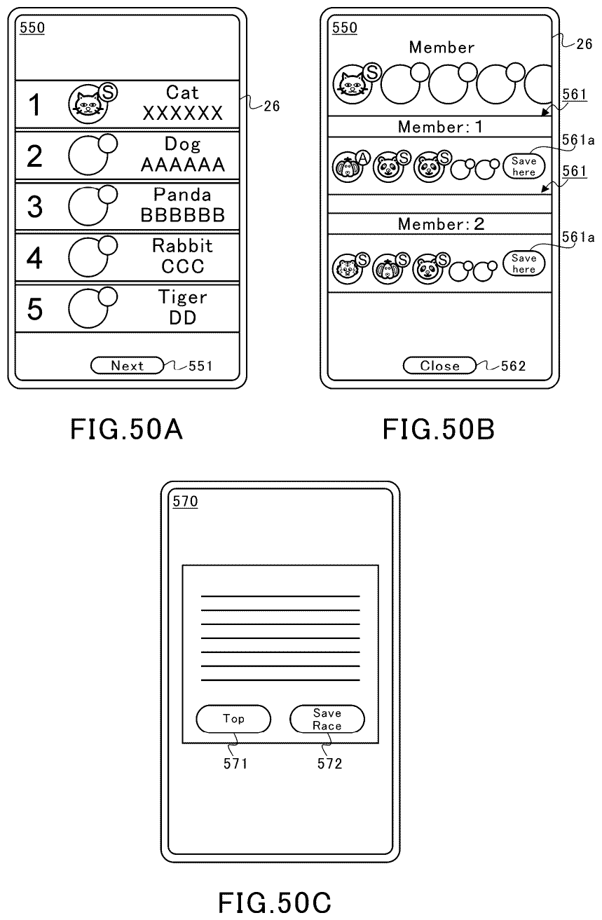

FIG. 50A is a diagram illustrating a practice match result screen 550. When the race video ends playing or when an operation input that causes the race result to be displayed is carried out, the practice match result screen 550 illustrated in FIG. 50A appears. As illustrated in the drawing, the order of arrival of the participant characters is indicated in the practice match result screen 550. When a next operation portion 551 provided in the practice match result screen 550 is tapped, a practice member registration screen 560 appears.

FIG. 50B is a diagram illustrating the practice member registration screen 560. At the top of the practice member registration screen 560, icons of the characters that have participated in the latest practice match, that is, all of the raised characters included in the latest practice members, are displayed. Furthermore, practice member display boxes 561 are displayed in the practice member registration screen 560. The practice member display box 561 is displayed with respect to the registered practice members. In the practice member display boxes 561, icons corresponding to the raised characters included in the practice members are displayed. When this icon is tapped and held, the character detail dialogue 185A is also displayed as described above.

Furthermore, a save operation portion 561a is provided in each practice member display box 561. When the save operation portion 561a is tapped, the currently registered practice members are overwritten by the latest practice members. Specifically, in FIG. 50B, the practice member display box 561 at the top corresponds to the currently registered first practice members, and the practice member display box 561 thereunder corresponds to the currently registered second practice members different from the first practice members. When the save operation portion 561a in the practice member display box 561 at the top is tapped, the latest practice members are registered as new first practice members. Similarly, when the save operation portion 561a in the practice member display box 561 thereunder is tapped, the latest practice members are registered as new second practice members.

As such, after the practice match ends and the practice match result screen 550 is displayed, the player can register the practice members used in the latest practice match. When the close operation portion 562 in the practice member registration screen 560 is tapped, the practice member registration screen 560 closes, and a race result save dialog 570 appears.

FIG. 50C is a diagram illustrating the race result save dialog 570. In the race result save dialog 570, an end button 571 and a race result save button 572 are provided. In addition, a message informing that the race results can be saved is displayed in the race result save dialog 570. When the race result save button 572 is tapped, the race results of the latest practice match are saved.

The player can repeatedly confirm the saved race results by tapping the saved race operation portion 504 in the practice match top screen 500 illustrated in FIG. 46A. Here, information regarding the participant characters, simulation results, etc., are included in the race results, and the player can confirm just the race results or can play the race video. Note that when the end button 571 in the race result save dialog 570 is tapped, the race results of the latest practice match are cancelled, and the practice match top screen 500 appears.

As described above, by holding a practice match, the player can acquire information for raising stronger raised characters. In addition, since the raised characters raised by other players can be made to compete against each other in a practice match, there is no need for the player to have a strong raised character in possession. Thus, information is acquired evenly among the players, and all players can equally access necessary information.

### (Room Match)

This embodiment provides a room match, which is a race in which the raised characters raised by the player can participate. A room match is a match race in which a raised character raised by the player plays against raised characters of multiple other players.

In this embodiment, the players can make entries into multiple match races. Here, “entries” to the match races are roughly categorized into “hosting” and “joining”. “Hosting” means that the player holds its own match race. “Joining” means that the player is participating in a match race hosted by another player.

Note that “joining” includes a “participate” mode meaning that the player has its raised character participate in a match race hosted by another player and a “watch” mode meaning that the player does not have the player's raised character participate in the match race but simply watches the match race hosted by another player. In addition, here, when “hosting” a match race, the player must have the player's raised character participate in the race. Alternatively, the player may get to select between “participate” and “watch” in the case of “hosting” a match race also.

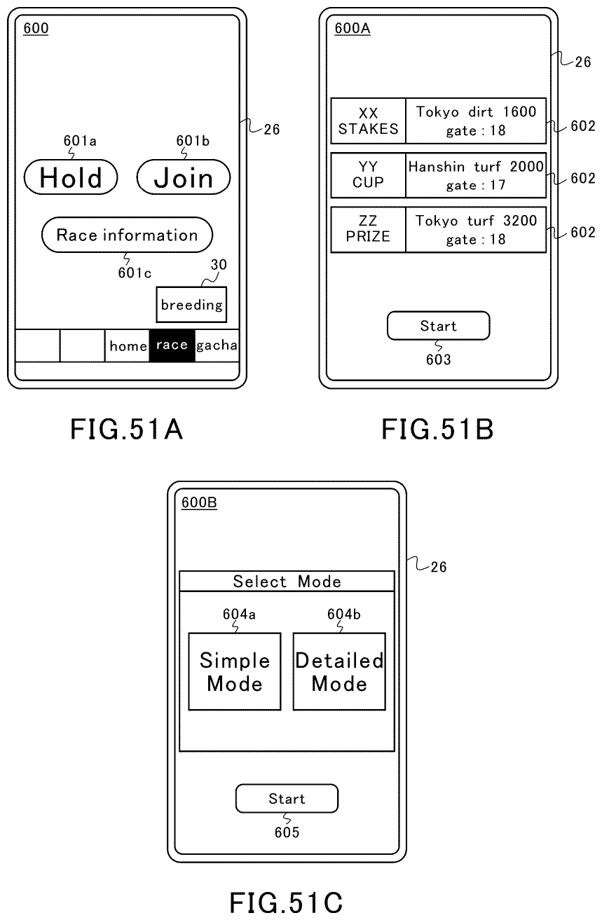

FIG. 51A is a diagram illustrating a room match top screen 600. As described above, when the practice race select operation portion 401b in the race game select screen 400 illustrated in FIG. 42A is tapped, an exhibition select screen not illustrated in the drawing appears. When a room match is selected in the exhibition select screen, the room match top screen 600 illustrated in FIG. 51A appears.

In the room match top screen 600, a hosting tab 601a, a joining tab 601b, and an entry information tab 601c are provided. The hosting tab 601a is an operation portion for hosting a match race, and when the hosting tab 601a is operated, a host race select screen 600A illustrated in FIG. 51B appears.

FIG. 51B is a diagram illustrating the host race select screen 600A. In the host race select screen 600A, multiple candidate race images 602 indicating the race types that can be hosted are displayed. In the candidate race images 602, information regarding the races are displayed. In each race, the race name, the course, the racetrack, the distance, the maximum number of participants, etc., are set in advance. When a candidate race image 602 in the host race select screen 600A is tapped, the tapped race enters a temporary selected state. Then, when the start button 603 displayed in the host race select screen 600A is tapped in the state where the race is in a temporary selected state, the temporarily selected race is determined to be the host race.

Hereinafter, the player who hosts a match race may be referred to as the host player, and a match race hosted by the host player may be referred to as the host race from the viewpoint of the host player. In addition, a player that joins the match race hosted by another player is referred to as a guest player.

FIG. 51C is a diagram illustrating a mode select screen 600B. When the host race is determined in the host race select screen 600A, the mode select screen 600B appears. This embodiment provides a simple mode and a detail mode as the mode of the host race. The simple mode is a mode where the hosting conditions outlining the host race and the race conditions such as conditions of the host race are default conditions prepared in advance. Meanwhile, the detail mode is a mode where the hosting conditions and the race conditions can be freely set by the player.

In the mode select screen 600B, a simple mode select operation portion 604a and a detail mode select operation portion 604b are displayed. When the simple mode select operation portion 604a is tapped, the simple mode is temporarily selected, and when the detail mode select operation portion 604b is tapped, the detail mode is temporarily selected. When a start button 605 displayed in the mode select screen 600B is tapped in the state where the mode is temporarily selected, the temporarily selected mode is officially determined.

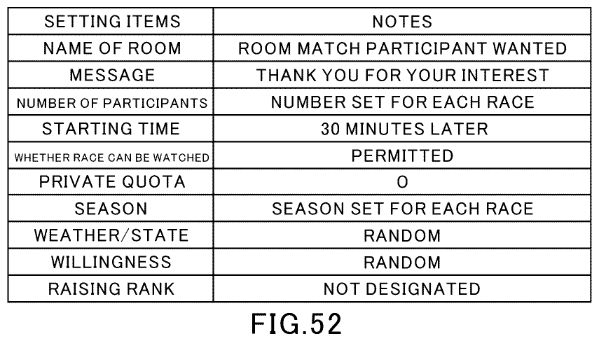

FIG. 52 is a diagram illustrating the simple mode. When the simple mode is officially determined, a simple mode setting screen not illustrated in the drawing appears. The player can input a room name and a message in the simple mode setting screen. The room name and the message are the information that can be viewed when other players search for the match races to participate in. Note that, in the simple mode setting screen, the room name is set to “room match participant wanted” and the message is set to “thank you for your interest” as the initial setting. The player can edit and register these room name and message in the simple mode setting screen.

Here, for the host race, the number of participants, the starting time, whether the race can be watched, and the private quota are set as the hosting conditions.

The number of participants are the number of raised characters participating in the host race. Here, when the number of raised characters registered as the participants is less than the number of participants of the host race, NPCs are added to offset the deficiency. Thus, a match race in the room match is always held with the set number of participants. Alternatively, the match race may be held only by the raised characters that the player made participate. Alternatively, when the number of the raised characters registered as participants is less than the specified number, the host race may be called off.

A predetermined number is set as the number of participants in each of the candidate race types. When the simple mode is selected, the number determined in advance for each candidate race type is set as the number of participants.

The starting time is the information indicating the time when the host race starts. More specifically, the starting time is the information indicating the time when the race results are derived. Here, the time taken until the race results are derived, in other words, the remaining time, is set as the starting time. Once the starting time is set, the remaining time decreases with the passage of time thereafter, and when the remaining time is zero, the race results are derived. Alternatively, a starting time-of-day may be set instead of the starting time, and the race results may be derived at the starting time-of-day. Alternatively, the starting time or the starting time-of-day may be set depending on the race type. When the simple mode is selected, “30 minutes later” is set as the starting time. In the description below, the starting time may be described as a remaining time.

Whether the race can be watched indicates that whether the race can be watched and listened to by a third party that does not have characters participating therein. When the simple mode is selected, whether the race can be watched is set to “permitted”, and the third party can watch the race.

The private quota is a special participation quota for the player that has a specified relationship with the host player. Although the detailed description is omitted, a player having a particular relationship is, for example, a player set by the host player to be a friend such as a follower and a player that belongs to the same circle as the host player.

For example, in a match race where the number of participants is 18, suppose that the private quota is set to “3”. In this match race, only up to fifteen raised characters of players that do not have a specified relationship with the host player can participate. As such, the private quota is set to ensure the participation quota for a player that has a specified relationship with the host player. When the simple mode is selected, the private quota is set to “0”.

For the host race, season, weather/state, willingness, and raising rank are set as the race conditions.

The season is one of spring, summer, autumn, and winter, and the set season can affect the race results. In other words, the season is one of the parameters that derive the race results. A predetermined season is set for each race type, and, when the simple mode is selected, the predetermined season determined in advance for each race type of the host race is set.

The weather/state indicates the weather during the race and the state of the racetrack, and the set weather/state affects the race results. In other words, weather/state is one of the parameters that derive the race results. When the simple mode is selected, the weather/state is determined at random by a lottery at the start of the host race. Alternatively, the weather/state may be determined not at the start of the host race but at a specified timing before the start of the host race.

Willingness is the “condition” of the character participating in the race, and, as with the raising game described above, five levels of willingness are provided: “very good condition”, “good condition”, “normal condition”, “bad condition”, and “very bad condition”. Since willingness is calculated as a variable of the ability parameters of the character participating in the race, willingness affects the race results. When the simple mode is selected, the willingness is determined at random by a lottery at the start of the host race. Alternatively, the willingness may be determined not at the start of the host race but at a particular timing before the start of the host race. The willingness may be determined for each participant character, or the determined willingness may be uniformly set for all of the characters.

Raising rank is a parameter for classifying the ability of the character, and is derived on the basis of the ability parameter etc. In the host race, the player can set the raising rank of the character that can participate in the match race to, for example, a particular rank or higher. However, when the simple mode is selected, “none specified” is set for the raising rank. This “none specified” means that characters of all raising ranks can participate in the host race.

As described above, when the simple mode is selected, the hosting conditions and the race conditions are set to initial conditions. When the host player had the host race set in the simple mode, the room name and the message can be changed later but the hosting conditions and the race conditions cannot be changed later.

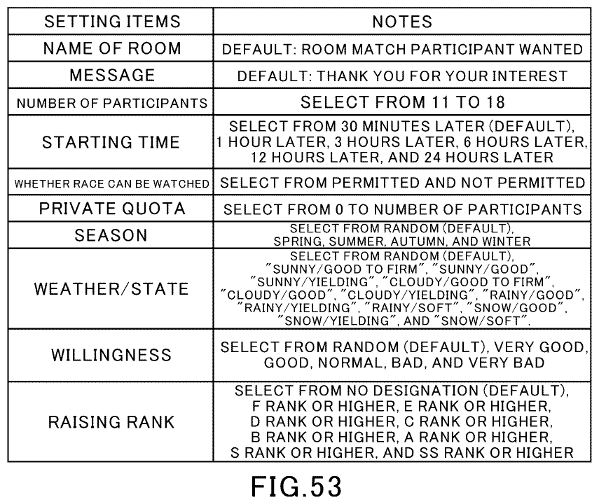

FIG. 53 is a diagram illustrating the detail mode. When the detail mode is officially determined, a detail mode setting screen not illustrated in the drawing appears. The player can input a room name and a message in the detail mode setting screen. Note that, in the detail mode setting screen also, the room name is set to “room match participant wanted” and the message is set to “thank you for your interest” as the initial setting. The player can edit and register these room name and message in the detail mode setting screen.

In the detail mode, the player can freely set the aforementioned hosting conditions. Specifically, the player can set the number of participants to any number within the range of 11 to 18. In addition, the player can select the starting time from among 30 minutes later, 1 hour later, 3 hours later, 6 hours later, 12 hours later, and 24 hours later. Furthermore, the player can select whether the race can be watched from “permitted” and “not permitted”. When “not permitted” is selected, a third party cannot watch or listen to the race. In addition, the player can set the private quota in the range of 0 to the preselected number of participants.

In the detail mode, the player can freely set the aforementioned race conditions. Specifically, the player can set the season to be random, spring, summer, autumn, or winter. When the season is set to be random, as with the simple mode, the season is determined by a lottery at random at the start of the race.

Furthermore, the player can set the weather/state to one of random and twelve patterns illustrated in the drawing. When random is selected, as with the simple mode, the weather/state is determined at random by a lottery at the start of the race.

Furthermore, the player can set the willingness to any one of random and five patterns illustrated in the drawing. When random is selected, as with the simple mode, the willingness is determined by a lottery at random at the start of the race. When one of the patterns other than random is determined, the willingness of all participant characters is uniformly set to the selected willingness.

The player can set the raising rank of the character that can participate in the host race. Here, the raising rank of the character that can participate may be set to any one of those illustrated in the drawing.

As mentioned above, when various settings are completed in the simple mode setting screen or the detail mode setting screen, a room match participant character select screen 610 is displayed on the display 26. The host player can select the raised characters that participate in the host race through the room match participant character select screen 610.

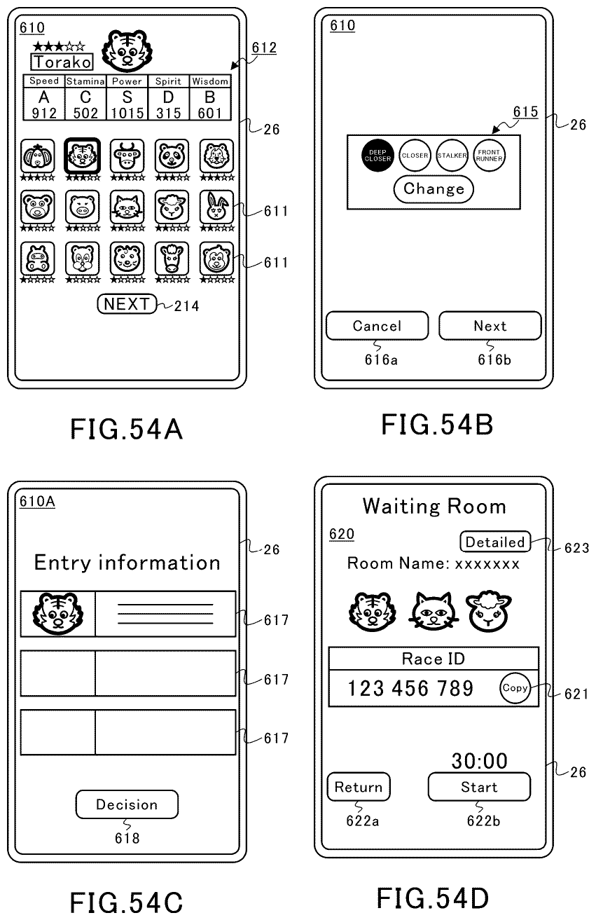

FIG. 54A is a diagram illustrating the room match participant character select screen 610. As illustrated in FIG. 54A, character icons 611 corresponding to raised characters raised by the player are displayed in the room match participant character select screen 610. When a character icon 611 is tapped, the raised character corresponding to the character icon 611 is temporarily selected, and the ability parameters of this raised character are displayed in an ability parameter display box 612. The player can confirm the ability parameters displayed in the ability parameter display box 612 and then select the raised character to participate in the race.

When a select operation portion 613 displayed in the room match participant character select screen 610 is operated in a state where one of the raised characters is temporarily selected, a strategy select tab 615 is displayed on the display 26.

FIG. 54B is a diagram illustrating the strategy select tab 615. In the strategy select tab 615, the player can set the strategy of the raised character. Note that a cancel operation portion 616a and an update operation portion 616b are displayed under the strategy select tab 615. When the cancel operation portion 616a is operated, the room match participant character select screen 610 appears, and when the update operation portion 616b is operated, an entry information screen 610A appears.

FIG. 54C is a diagram illustrating the entry information screen 610A. In the entry information screen 610A, participant character information tabs 617 are displayed. In the participant character information tabs 617, information about the raised characters selected by the player is indicated. Here, the player can have up to three raised characters participate in one host race. In the entry information screen, three participant character information tabs 617 are displayed, and, in the state where one raised character is selected, as illustrated in FIG. 54C, the information regarding this raised character is indicated in the uppermost participant character information tab 617.

When a participant character information tab 617 not indicating information regarding a raised character is tapped, the room match participant character select screen 610 illustrated in FIG. 54A appears, and, as described above, a raised character can be added. In the entry information screen 610A, a decision button 618 is provided, and when the decision button 618 is operated, the registration process regarding hosting the match race in the room match is completed. In other words, by operating the decision button 618, the hosting conditions of the match race to be hosted, the race conditions, the characters participating in the host race, and the strategies of these characters are finalized.

Upon completion of the registration process regarding hosting of the match race, a race ID is issued in the server 1000. The race ID is provided for each match race, and a room is created in the server 1000 along with issuing of the race ID. Here, a room means an ID that can be linked with multiple player IDs and administered to hold a room match, a storage region in the server 1000, and data. From the player's viewpoint, a room can be considered a virtual space where characters and players participating in the match race come together. In this embodiment, one match race is held in one room, and thus a race ID is synonymous with a room ID. When a room is created, a waiting room screen 620 is displayed on the display 26 of the host player hosting the match race.

FIG. 54D is a diagram illustrating the waiting room screen 620 of the host player. As illustrated in FIG. 54D, in the waiting room screen 620, the room name set by the host player, the images of the raised characters participating in the match race, and the race ID are displayed. A copy button 621 is provided near the race ID. Although the detailed description is omitted, when the copy button 621 is operated, the race ID is copied. By copying the race ID, the player can easily send the race ID to other players by using the function inside or outside the game application.

In addition, in the waiting room screen 620 of the host player, a return operation portion 622a and a start operation portion 622b are provided. When the return operation portion 622a is operated, the screen transitions onto a specified screen, such as the home screen 100 or the room match top screen 600.

The remaining time until the start of the match race is displayed near the start operation portion 622b. In the player terminal 1 of the host player, the start operation portion 622b is enabled regardless of the remaining time. When the start operation portion 622b is operated, the match race can start regardless of the remaining time. To be more specific, the host player can derive the race results of the host race by operating the start operation portion 622b without waiting for the starting time. When the race results are derived, a race screen is played on the display 26.

Note that, when the entry information tab 601c in the room match top screen 600 illustrated in FIG. 51A is operated, a list of the match races for which entries are made is displayed. The waiting room screen 620 can be displayed again by tapping the match race displayed here. Thus, the host player can hold the host race at a desired timing after registration of the hosting of the match race while checking how other players are joining.

In addition, in the waiting room screen 620, a detail display button 623 is provided. When the detail display button 623 is operated, a race detail screen 630 appears on the display 26.

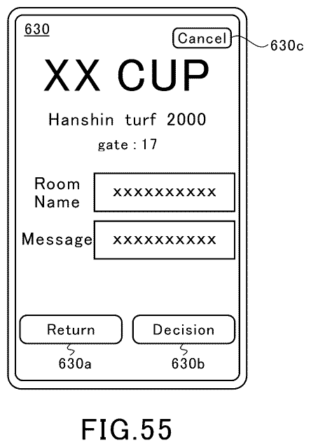

FIG. 55 is a diagram illustrating the race detail screen 630. In the race detail screen 630 displayed on the player terminal 1 of the host player, the hosting conditions and the race conditions of the match race, etc., are displayed. In addition, in the race detail screen 630, the host player can edit the room name and the message. In other words, the host player can change the room name and the message of the host race afterward in the race detail screen 630. Note that, here, the host player cannot change the hosting conditions and the race conditions afterward; alternatively, one or both of the hosting conditions and the race conditions may be made changeable afterward.

In addition, in the race detail screen 630, a return operation portion 630a, a decision operation portion 630b, and a hosting cancel operation portion 630c are provided. When the return operation portion 630a is operated, the screen transitions onto a specified screen such as the waiting room screen 620 or the room match top screen 600. In addition, the decision operation portion 630b is enabled when the room name or the message is input. When the decision operation portion 630b is operated, the changed room name or message is registered.

The host player can cancel the host race by operating the hosting cancel operation portion 630c. However, the host race can be cancelled until 15 minutes before the start. Thus, if the remaining time to the start of the host race is 15 minutes or more, the hosting cancel operation portion 630c is enabled, and if the remaining time is less than 15 minutes, the hosting cancel operation portion 630c is disabled.

As described above, when a race ID is issued and the hosting of the match race is scheduled, other players can start making entries. In the description below, the operation in the case where the player joins, as a guest player, a match race hosted by another player is described.

The joining tab 601b in the room match top screen 600 illustrated in FIG. 51A is an operation portion used to join a match race hosted by another player. When the joining tab 601b is operated, a room search screen 640 appears.

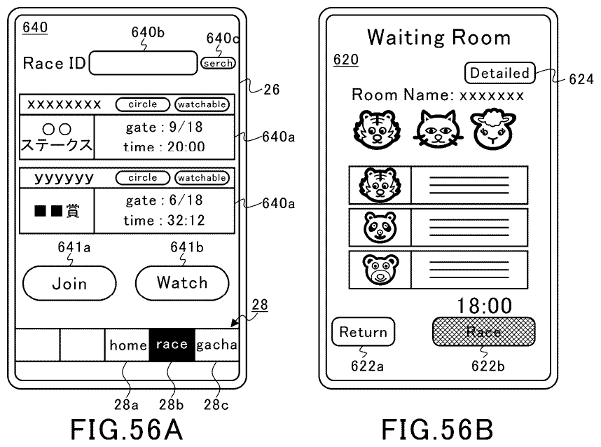

FIG. 56A is a diagram illustrating the room search screen 640. In the room search screen 640, a specified number of rooms randomly extracted, that is, scheduled match races that can be joined are listed and displayed. Specifically, in the room search screen 640, match race information interfaces 640a corresponding to the match races extracted by the search are displayed. In each of the match race information interfaces 640a, various pieces of information, such as the room name, whether a private quota is set or not, whether the race can be watched or not, the race type, the number of currently registered participant characters relative to the number of participants, and the remaining time to the start of the match race, are displayed.

In addition, in the room search screen 640, an input box 640b to which the race ID can be input and a search start button 640C are provided. When the search start button 640c is operated after input of the race ID to the input box 640b, the match race information interface 640a corresponding to the input race ID appears. When the search start button 640c is operated without inputting the race ID to the input box 640b, a search term input screen not illustrated in the drawing appears. A search term can be input to the search term input screen, and it becomes possible to search for match races that meet the search term.

When, for example, the match race information interface 640a in the room search screen 640 is tapped and held, the detail information of that match race is displayed. When the match race information interface 640a is tapped, that match race enters a selected state.

In the room search screen 640, a participation reservation operation portion 641a and a race watching reservation operation portion 641b are provided. When the participation reservation operation portion 641a is operated in the state where any one of the match races is selected, the registration process for a character to participate as a guest player in the selected match race starts.

In the registration process for the character to participate as a guest player, as with the registration process regarding hosting of the match race by the host player, the room match participant character select screen 610 illustrated in FIG. 54A, the strategy select tab 615 illustrated in FIG. 54B, and the entry information screen 610A illustrated in FIG. 54C are displayed. As with the host player, the guest player can determine the character that participates in the match race, and the strategy. Then, when the decision button 618 in the entry information screen 610A is operated, the registration process of “participation” as the guest player is completed, and the waiting room screen 620 of the guest player is displayed.

FIG. 56B is a diagram illustrating the waiting room screen 620 of the guest player. As illustrated in FIG. 56B, in the waiting room screen 620 of the guest player, the room name, information regarding the characters scheduled to participate in the match race determined by the guest player, etc., are displayed. In addition, in the waiting room screen 620 of the guest player, a return operation portion 622a and a start operation portion 622b are provided. When return operation portion 622a is operated, the screen transitions onto a particular screen, such as the home screen 100 or the room match top screen 600.

The remaining time until the start of the match race is displayed near the start operation portion 622b. In the player terminal 1 of the guest player, the start operation portion 622b is disabled until the starting time. The start operation portion 622b is enabled at the starting time, and when the enabled start operation portion 622b is operated, a race screen of the match race is displayed.

In the waiting room screen 620 of the guest player, a detail display button 624 is provided. When the detail display button 624 is operated, the screen transitions onto a race detail screen 630 that displays the detail information of the match race. In the race detail screen 630 displayed on the player terminal 1 of the guest player, the entry to the match race can be cancelled. Although the detailed description is omitted, the guest player can cancel the entry to the match race only until 15 minutes before the start of the match race. Alternatively, the guest player may be able to cancel the entry to the match race irrespective of the remaining time.

When the race watching reservation operation portion 641b is operated in the state where one of the match races is selected, race watching of the selected match race is reserved. When race watching is reserved, information regarding the characters scheduled to participate etc., are displayed in the waiting room screen 620. In this case also, a start operation portion 622b is provided in the waiting room screen 620, and the race screen can be watched when it is the starting time. In addition, the guest player can cancel race watching from the waiting room screen 620.

As described above, in this embodiment, the player can have raised characters participate in the match races carried out among multiple players and can watch the match races through room matches.

### (Daily Race)

This embodiment also provides a daily race, which is a race in which the raised character raised by the player can participate. The purpose of the daily race is to have the raised character raised by the player participate in the race and acquire specified rewards. A daily race can be held by spending a daily ticket. A specified number of (for example, three) daily tickets are distributed to the player every day. The player can hold as many daily races as the number of daily tickets.

Here, the player can purchase daily tickets by spending in-game currency. By purchasing daily tickets, the player can hold more daily races than the number of daily tickets distributed in a day.

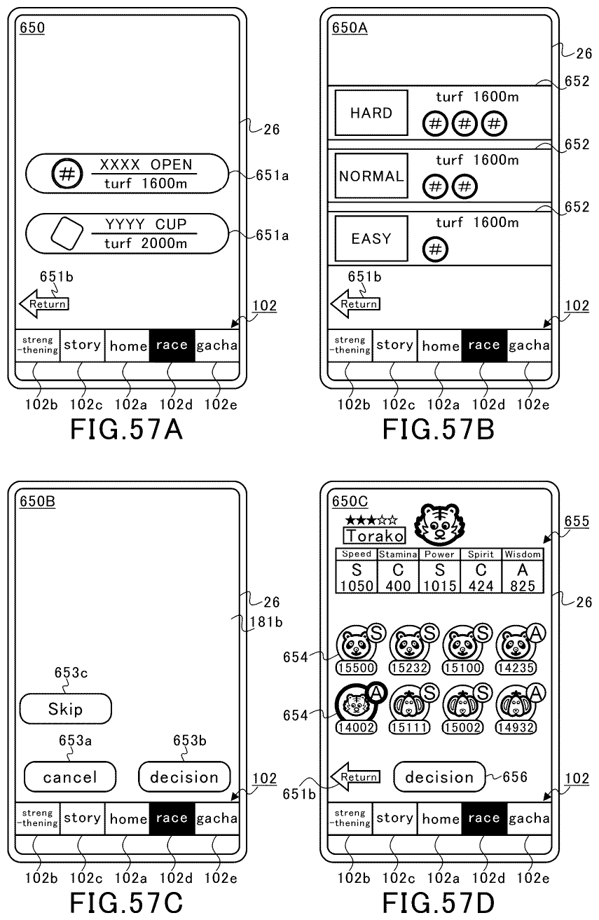

FIG. 57A is a diagram illustrating a daily race screen 650. When a daily race select operation portion 401c in the race game select screen 400 illustrated in FIG. 42A is tapped, the daily race screen 650 appears. In the daily race screen 650, daily race select boxes 651a are displayed. Here, a total of two race types are provided: a first daily race and a second daily race, and one daily race select box 651a is displayed for each race type.

The reward that the player can acquire differs between the first daily race and the second daily race. In the daily race select box 651a, an icon indicating the reward that can be acquired by that daily race is indicated. In the daily race select box 651a, the race name, the racetrack, and the distance are indicated. Note that, in the daily race screen 650, a return operation portion 651b is provided, and when the return operation portion 651b is tapped, the race game select screen 400 appears.

Here, the same daily tickets can be used in the first daily race and the second daily race. Thus, the player can select the first daily race or the second daily race within the range of the daily tickets that the player has.

FIG. 57B is a diagram illustrating a difficulty level select screen 650A. When one of the daily race select boxes 651a is tapped, the difficulty level select screen 650A illustrated in FIG. 57B appears. In the difficulty level select screen 650A, three difficulty level select boxes 652 are displayed. For the first daily race and the second daily race, three difficulty levels are provided: hard, normal, and easy. The three difficulty level select boxes 652 respectively correspond to hard, normal, and easy.

The player can select one raised character and have the selected raised character participate in a daily race. Here, the higher the order of arrival of the raised character of the player, the more reward can the player acquire. In addition, the higher the difficulty level of the selected daily race, the more reward can the player acquire. When one of the difficulty level select boxes 652 is tapped, a play mode select screen 650B appears.

FIG. 57C is a diagram illustrating the play mode select screen 650B. In the play mode select screen 650B, a cancel operation portion 653a, a decision operation portion 653b, and a skip operation portion 653c are provided. When the cancel operation portion 653a is tapped, the difficulty level select screen 650A illustrated in FIG. 57B appears.

Here, a regular mode and a skip mode are provided as the play mode of the daily races. When the decision operation portion 653b is tapped, the daily race is held in the regular mode, and when the skip operation portion 653c is tapped, the daily race is held in the skip mode. The regular mode is a play mode in which one daily race is held at a time. When the regular mode is selected, a race video of one daily race can be played or race results of one daily race can be displayed without playing the race video.

In contrast, the skip mode is a play mode in which multiple daily races are held in batch. In the skip mode, the race videos cannot be played, and race results of the multiple daily races are displayed. When the decision operation portion 653b or the skip operation portion 653c is tapped, a daily race participant character select screen 650C illustrated in FIG. 57D appears.

FIG. 57D is a diagram illustrating the daily race participant character select screen 650C. In the daily race participant character select screen 650C, character icons 654 corresponding to raised characters raised by the player are displayed. When a character icon 654 is tapped, the raised character corresponding to the character icon 654 is temporarily selected, and the ability parameters of this raised character are displayed in an ability parameter display box 655. The player can confirm the ability parameters displayed in the ability parameter display box 655 and then select the raised character to participate in the race.

When a select operation portion 656 displayed in the daily race participant character select screen 650C is operated in a state where one of the raised characters is temporarily selected, the screen transitions as follows depending on the selected play mode. Specifically, when the select operation portion 656 is operated in the state where the regular mode is selected, an item select screen not illustrated in the drawing is displayed. In this item select screen, items used in the daily race can be selected. With these items, for example, the parameters of the raised character of the player participating in the daily race can be increased. Subsequently, when a specified operation is carried out in the item select screen, the player can select whether to play the race video or to display the race results.

In contrast, when the select operation portion 656 is operated in the state where the skip mode is selected, a skip setting screen 660 appears.

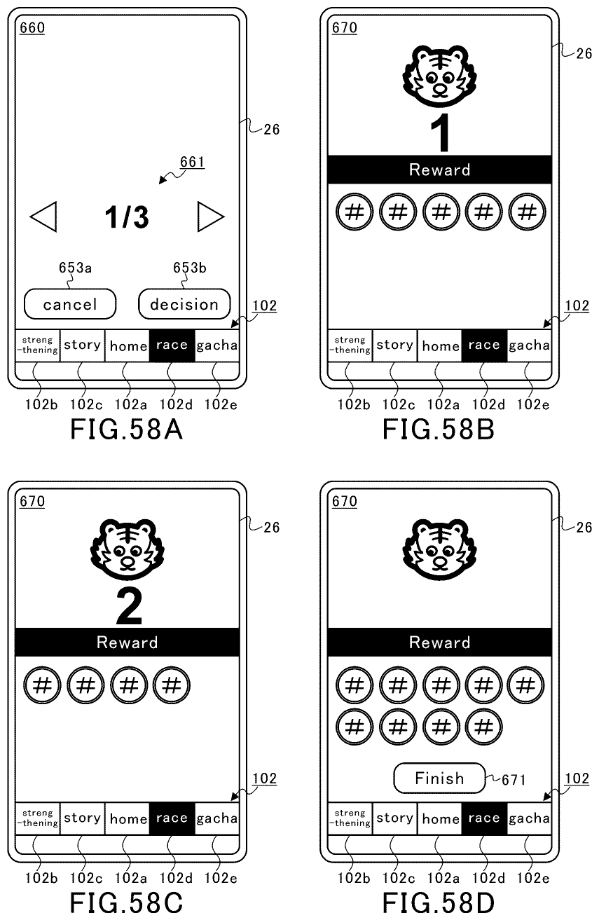

FIG. 58A is a diagram illustrating the skip setting screen 660. In the skip setting screen 660, a skipping number input interface 661 is provided. In the skipping number input interface 661, a fraction is indicated in which the number of daily tickets that the player has is displayed as the denominator and the number of times of skipping is displayed as the numerator. In the skipping number input interface 661, the number of times of skipping can be increased by tapping the right side of the fraction, and the number of times of skipping can be decreased by tapping the left side of the fraction.

Note that, in the skip setting screen 660, a cancel operation portion 653a and a decision operation portion 653b are displayed. When the cancel operation portion 653a is tapped, the daily race participant character select screen 650C appears. When the decision operation portion 653b is tapped, a skip result display screen 670 appears.

FIG. 58B is a first diagram illustrating the skip result display screen 670. FIG. 58C is a second diagram illustrating the skip result display screen 670. FIG. 58D is a third diagram illustrating the skip result display screen 670. In the skip result display screen 670, the race results of the daily race No. 1 are displayed. Here, the order of arrival is indicated under the character image of one raised character that has participated in the daily race. In addition, the reward acquired by this daily race is displayed in the skip result display screen 670.

In addition, when the operation input is made on the skip result display screen 670 in the state illustrated in FIG. 58B, the race results of the daily race No. 2 are displayed in the skip result display screen 670 as illustrated in FIG. 58C. As such, in the skip result display screen 670, the race results are displayed for each daily race. In addition, when the race results are displayed as many times as the number of times of skipping, as illustrated in FIG. 58D, a list of the rewards acquired by all of the daily races that have taken place is displayed. Here, in the skip result display screen 670, a finish operation portion 671 is displayed. When the finish operation portion 671 is tapped, the screen transitions onto a specified screen such as the difficulty level select screen 650A.

### (Event Race)

In this embodiment, special event races are held irregularly. While a special event race is being held, the special event icon 108 displayed in the home screen 100 is enabled. The player can play the event race by tapping the special event icon 108.

In the event race, the player can challenge an event race in which one raised character can participate. The game element of the event race is that the raised character plays the race against an NPC. The purpose of the event race is to have the raised character raised by the player participate in the race and acquire a specified reward.

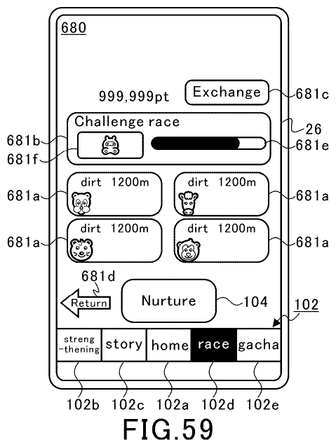

FIG. 59 is a diagram illustrating a special event race screen 680. When the special event icon 108 displayed in the home screen 100 is tapped, the special event race screen 680 illustrated in FIG. 59 appears. In the special event race screen 680 illustrated in FIG. 59, a regular race select operation portion 681a, an irregular race select operation portion 681b, the raising game operation portion 104, a point exchange select operation portion 681c, and a return operation portion 681d are displayed.

Event races include two types of races: regular event races and irregular event races. A regular event race is displayed as selectable by the player at all times during the event holding period. A regular event race is a game in which the player selects one NPC from four NPCs, and one raised character of the player runs a race against the selected NPC to compete for ranking.

An irregular event race is displayed as selectable by the player only when irregular conditions are satisfied. An irregular event race is a game in which the player plays a race against an NPC stronger than NPCs that appear in regular event races to compete for ranking when irregular conditions are satisfied. In the irregular event race, one NPC is set in advance, and one raised character of the player plays a race against the set NPC to compete for ranking. The details of the irregular event race are described below.

The player can select a regular event race by tapping the regular race select operation portion 681a. In addition, the player can select an irregular event race by tapping a race start operation portion 681f described below in the irregular race select operation portion 681b.

When the regular race select operation portion 681a is tapped, an event race participant character select screen not illustrated in the drawing appears. In the event race participant character select screen, multiple character icons corresponding to the raised characters raised by the player as illustrated in FIG. 57D are displayed.

The player can select one raised character in the event race participant character select screen and have the selected raised character participate in an event race. When a character icon is tapped, the raised character corresponding to the character icon is temporarily selected, and the ability parameters of this raised character are displayed. The player can confirm the ability parameters of the raised character and then select the raised character to participate in the race.

When the select operation portion displayed in the event race participant character select screen is operated in the state where one raised character is temporarily selected, the simulation results of the event race are derived on the basis of the ability parameters of the participant character, etc. Here, as in the team competition game, the player can play a regular event race by spending a particular value (for example, 1) of the race playing points. Then the event race video is played on the basis of the derived simulation results. When the event race video ends playing, the event race results are displayed, and the order of arrival (place) of the participant raised character is displayed.

In the event race, event points to be given to the raised character that has participated in the event race are determined according to the preset point granting terms. Examples of the point granting terms include various conditions to be achieved during the event race, such as the order of arrival and the number of skills activated during the event race. In addition, for example, a point granting term that grants event points on the basis of the position among the characters of the same running style at a specified timing during the event race is set. For the event points, total event points obtained by totaling the event points of the raised characters that have participated in the event races, and integrated event points obtained by considering specified bonus points etc., are calculated. Furthermore, for example, bonus points may be granted as the support rooting bonus according to the level of the support cards in the player's possession. Event points are points that are provided only in the event races.

Note that, when an event race is held, a reward is granted to the player. Here, the higher the order of arrival of the raised character of the player, the more reward can the player acquire. In addition, when an event race is held, the aforementioned event points are granted to the player. The event points acquired by the player are totaled, and the player can acquire various items on the basis of the accumulated value of the event points. Note that, when the event points have reached the specified upper limit, that is, when all of the items that can be acquired on the basis of the event points have been acquired, event points may no longer be granted. In such a case also, a specified reward may be additionally granted according to the event points that could have been acquired. The event points granted to the player are displayed in the special event race screen 680. In addition, the player can acquire various items by spending the acquired event points. In other words, the player can exchange event points with various items.

In the irregular race select operation portion 681b, an event gauge 681e is displayed. When the player clears the regular event race, the event gauge 681e increases. The value of the event gauge 681e is initially set to 0 and increases up to 100.

The player can, for example, acquire the gauge value of the event gauge 681e according to the order of arrival in the participated regular event race. Specifically, a higher gauge value can be acquired when the order of arrival is high (as the position is closer to the first place). The event gauge 681e visually indicates the value of the event gauge 681e.

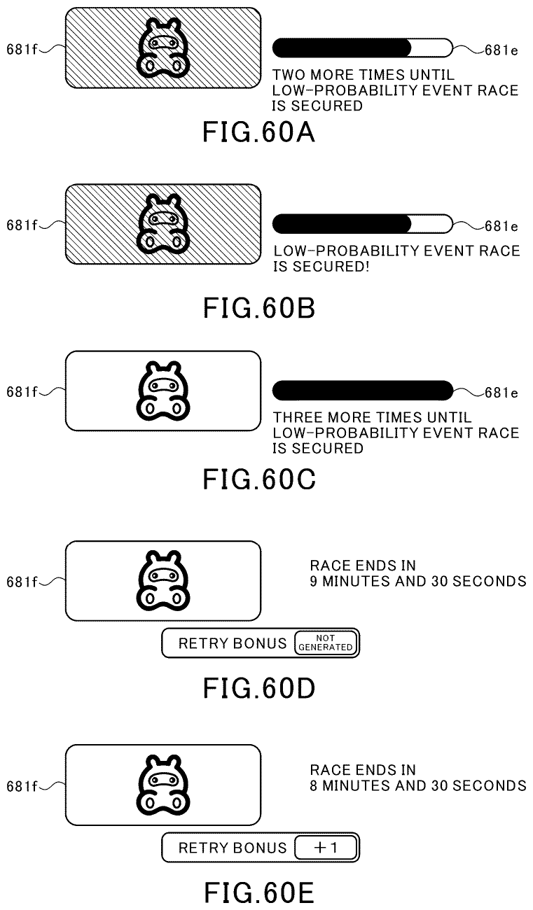

FIG. 60A is a first diagram illustrating a display example of the irregular race select operation portion 681b. FIG. 60B is a second diagram illustrating a display example of the irregular race select operation portion 681b. FIG. 60C is a third diagram illustrating a display example of the irregular race select operation portion 681b. FIG. 60D is a fourth diagram illustrating a display example of the irregular race select operation portion 681b. FIG. 60E is a fifth diagram illustrating a display example of the irregular race select operation portion 681b.

As illustrated in FIG. 60A, the irregular race select operation portion 681b includes the event gauge 681e and the race start operation portion 681f. An explanatory note of the irregular condition is provided under the event gauge 681e. Here, the irregular event races include high-probability event races and low-probability event races that occur with specified probabilities. A low-probability event race occurs with a lower probability than a high-probability event race, and rare rewards can be acquired in the low-probability event race.

In a low-probability event race, an NPC stronger than the NPCs in high-probability event races emerges, and the raised character plays a race against this NPC and competes for ranking. When the event gauge 681e reaches the maximum value, one of a high-probability event race and a low-probability event race is selected by a lottery with a specified probability from among the irregular event races.

However, since the irregular event race is determined by a lottery with a specified probability after the event gauge 681e has reached the maximum value, it is possible that the player has no chances of playing low-probability event races. To address this, this embodiment provides irregular conditions for the irregular event races. An irregular condition is, for example, that high-probability event races are selected a particular number of times in a row by a lottery. When the event gauge 681e reaches the maximum value in the state where the irregular conditions are established, a low-probability event race occurs without fail.

Specifically, when high-probability event races are selected by a lottery three times in a row, the irregular conditions are established, and when the event gauge 681e reaches the maximum value in the state where the irregular conditions are established, a low-probability event race occurs without fail. In the example illustrated in FIG. 60A, the displayed explanatory note of the irregular conditions is “Two more times until a low-probability event race is ensured”, and the player can thereby figure out that, if high-probability event races are selected by a lottery two more times in a row, a low-probability event race will occur without fail.

The race start operation portion 681f is displayed to be selectable by the player when the event gauge 681e reaches the maximum value. In the example illustrated in FIG. 60A, the event gauge 681e has not yet reached the maximum value, and thus the race start operation portion 681f is grayed out as indicated by hatching and displayed to be un-selectable by the player. In other words, the player cannot play an irregular event race in the state where the event gauge 681e has not reached the maximum value.

As illustrated in FIG. 60B, when the irregular conditions are established, an explanatory note that reads “Low-probability event ensured!” is indicated under the event gauge 681e. The player can figure out by reading this explanatory note that a low-probability event race will occur without fail when the event gauge 681e reaches the maximum value.

As illustrated in FIG. 60C, when the event gauge 681e reaches the maximum value, the race start operation portion 681f becomes selectable. When the race start operation portion 681f is tapped, the irregular event race starts. Here, as in the team competition game, the player can play an irregular event race by spending a particular value (for example, 1) of the race playing points. The process after the race start operation portion 681f is tapped is the same as that for the regular event race described above, and thus the detailed description is omitted.

Note that a time limit is set for the irregular event race. Thus, the irregular event race ends when a particular time has passed since the start of the irregular event race. The particular time is, for example, 10 minutes. The player can play the irregular event race as many times as desired until a particular position (for example, the first place) is won within the time limit of the irregular event race.

As illustrated in FIG. 60D, when the irregular event race starts, the event gauge 681e and the explanatory note regarding the irregular conditions are no longer displayed, and the remaining time until the end of the irregular event race is displayed. The player can figure out the remaining time to the end of the irregular event race by looking at the remaining time.

In addition, the difficulty level of the irregular event race is set to be higher than the regular event race. Thus, depending on the degree of raising of the raised character of the player, it may be difficult to obtain a high place in the irregular event race. In addition, unlike the regular event race, when the raised character could not win the first place in the irregular event race, no reward is granted. In other words, when the raised character came in second or lower, the player cannot obtain the reward.

Thus, in this embodiment, when the specified place (for example, the first place) could not be obtained in the irregular event race, a retrial bonus is given. The retrial bonus is a parameter (correction value) given to the ability parameters of the raised character when, for example, the player could not win the first place in the irregular event race and is trying to play the irregular event race again.

In the example illustrated in FIG. 60D, the state where the order of arrival in the irregular event race is not yet definitive and the retry bonus is not yet given is illustrated. Here, the explanatory note for the retry bonus indicates “Not generated”, and the player can figure out by looking at this explanatory note that the retry bonus has not yet been generated. Subsequently, when the order of arrival in the irregular event race has become definite and when the raised character could not win the first place in the irregular event race, a first retry bonus is generated.

As illustrated in FIG. 60E, when the first retry bonus is generated, the explanatory note for the retry bonus indicates “+1”, and the player can figure out by looking at this explanatory note that the first retry bonus has been generated. A maximum value is set for the number of times the retry bonus is generated. The maximum value of the number of times the retry bonus is generated is, for example, 10. The values of the parameters given to the raised character increase with an increase in the number of times the retry bonus is generated.

For example, when the number of times the retry bonus is generated is 1 to 10, the parameters given to the ability parameters of the raised character are, respectively, 5%, 10%, 20%, 30%, 40%, 50%, 60%, 70%, 80%, and 90%.

When the player could not win the first place in the irregular event race, re-simulation of the event race is carried out in the server 1000 as the retrial bonus. By carrying out the re-simulation, the probability with which the raised character wins the first place in the irregular event race can be increased. Note that the number of times the re-simulation of the event race is carried out in the server 1000 changes according to the number of times the player re-tried the irregular event race (in other words, the number of times of the retry bonus is generated). The re-simulation ends when the simulation results in which the raised character wins the first place in the irregular event race are derived.

For example, when the number of rematches is 1 to 10, the numbers of re-simulations are, respectively, 0, 1, 1, 2, 3, 4, 5, 6, 7, and 8. Note that the player is not informed of the re-simulation results. Thus, the player cannot know how many times re-simulation has been carried out in the server 1000.

Referring back to FIG. 59, when the point exchange select operation portion 681c is tapped, an event point exchange screen not illustrated in the drawing appears. In the event point exchange screen, the player can exchange the event points with any desired reward.

When the return operation portion 681d is tapped, the screen transitions onto the home screen 100.

In this embodiment, when an event race is executed, the raised character acquires an event skill factor according to the order of arrival with a specified probability. In other words, an event skill factor is a factor that is given to the raised character in the event race by a lottery with a specified probability. One of multiple stages is set for the event skill factor. Here, five stages of the factor level are provided as the stages of the event skill factor: level 1, level 2, level 3, level 4, and level 5. Regarding the factor level, level 5 has the highest effect, and level 1 has the lowest effect.

Note that the event skill factor is not given redundantly. For example, an event skill factor of a factor level 1 is not given to the raised character already having an event skill factor of the same factor level 1.

The probability of winning the event skill factor changes depending on the simulation results (order of arrival) in the event race. Here, the event skill factor winning probability is set according to the order of arrival in the event race.

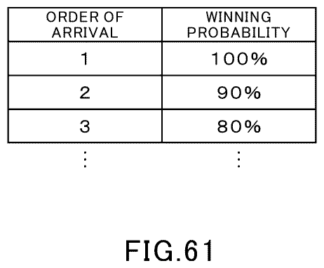

FIG. 61 is a diagram illustrating the event skill factor winning probability. As illustrated in FIG. 61, when the order of arrival of the raised character is the first place, the probability of winning the event skill factor is 100%. When the order of arrival of the raised character is the second place, the probability of winning the event skill factor is 90%. When the order of arrival of the raised character is the third place, the probability of winning the event skill factor is 80%. As such, the probability of winning the event skill factor increases as the order of arrival in the event race is higher.

The acquired event skill factor is linked as the factor information of the raised character and stored. Note that, in the lineage of inheritance, the character identification of the raised character is linked with the character identifications of inheritance characters (for example, raised characters of the inheritance first generation and raised characters of the inheritance second generation). Here, the character identification of a raised character of the inheritance first generation is also linked with character identifications of the raised characters of the inheritance second generation. Moreover, the character identification of each of the inheritance characters is linked with the same factor information or the factor information having the same content. Here, for example, if a raised character of the inheritance second generation has participated in an event race and acquired an event skill factor, the factor information about the acquired event skill factor is also reflected onto the raised character of the inheritance second generation linked with the raised character of the inheritance first generation and the raised character of the inheritance second generation linked with the raised character of the present generation. In other words, when one raised character acquires an event skill factor, the raised characters of all inheritance generations also mutually acquire the same event skill factor. As such, for example, when an inheritance character of a parent generation acquires an event skill factor, the inheritance characters and raised characters of child generations can also acquire the event skill factor. However, the event skill factor acquired by the raised character does not affect the ability of this raised character or the event race. In other words, the event skill factor is never used in the simulation that determines the order of arrival or the race development.

The event skill factor of the raised character affects only the main character to be raised (the raising-subject game medium) when the raised character is set as an inheritance character. In other words, the event skill factor takes an effect when a raising game in which the raised character having that event skill factor serves as an inheritance character is played.

When the raising game operation portion 104 in the special event race screen 680 or in the home screen 100 is tapped, the aforementioned raising game starts. As described above, in the raising game, the inheritance events illustrated in FIGS. 27A to 27D occur on a specified factor activation turn after start of the raising stage process after completion of the preparation stage process. The specified factor activation turn is, for example, the first turn. The event skill factor is activated in an inheritance event on this first turn, and the raised character can acquire the event skill set for this event skill factor.

However, when the inheritance character is a representative character of another player and this representative character has an event skill factor, that event skill factor is invalidated or removed in the inheritance event. In other words, even when the representative character of another player actually has an event skill factor, that representative character is treated as not having the event skill factor. This is to prevent the raised character of the player from acquiring an event skill factor or an event skill without participating in the event race.

It should be noted that, when a regular skill factor is activated at a specified timing under specified activation conditions, an in-possession skill is acquired, and this in-possession skill turns into an acquired skill by spending skill points. In contrast, an event skill turns into an acquired skill when the event skill factor is activated, and this happens without spending skill points. Moreover, the event skill factor activation probability is 100%, and thus a raised character having the event skill factor can always automatically acquire the event skill during the inheritance event on the first turn. However, the conditions and timing for acquiring the event skill are not limited to these, and the event skill may be acquired under other specified conditions at other specified timing during the raising game.

One of multiple stages is set for an event skill. Here, five stages of the skill level are provided as the stages of the event skill: level 1, level 2, level 3, level 4, and level 5. Regarding the skill level, level 5 has the highest effect, and level 1 has the lowest effect.

The skill level at the time of acquiring the event skill is determined according to the factor level of the event skill factor. Here, the factor level of the event skill factor and the skill level of the event skill correspond to each other. In other words, when the factor level of the event skill factor is level 1, the skill level of the acquired event skill is level 1.

When the factor level of the event skill factor is level 2, the skill level of the acquired event skill is level 2. When the factor level of the event skill factor is level 3, the skill level of the acquired event skill is level 3. When the factor level of the event skill factor is level 4, the skill level of the acquired event skill is level 4. When the factor level of the event skill factor is level 5, the skill level of the acquired event skill is level 5. As such, the event skill and the event skill factor are at the same level. However, the conditions for improving the level of the event skill are not limited to this, and the level may be improved by other specified conditions during the raising game.

Note that, when the first inheritance group and the second inheritance group include multiple inheritance characters having event skill factors, only the event skill factor with the highest factor level is referred among the multiple event skill factors. The raised character can acquire an event skill with a skill level corresponding to the event skill factor with the highest factor level among multiple event skill factors.

Specifically, when the first inheritance group and the second inheritance group include an inheritance character having a factor level 1 event skill factor and an inheritance character having a factor level 2 event skill factor, only the factor level 2 event skill factor is referred. Thus, the raised character can acquire an event skill with skill level 2 corresponding to the factor level 2.

An event skill corrects the event points acquired by an event race. Here, with an event skill, a correction value is added to the event points or the event points are multiplied by a correction value. Note that the event skill does not affect the ability parameters of the raised character. Alternatively, the event skill may affect the ability parameters of the raised character.

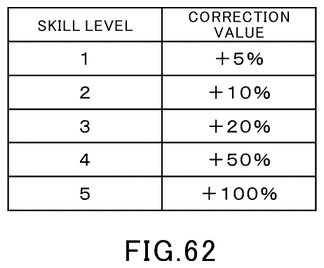

FIG. 62 is a diagram illustrating correction values provided by event skills to the event points. As illustrated in FIG. 62, the correction value for the event points changes according to the skill level of the event skill. For example, at skill level 1, the correction value for the event points is +5%.

Furthermore, at skill level 2, the correction value for the event points is +10%. At skill level 3, the correction value for the event points is +20%. At skill level 4, the correction value for the event points is +50%. At skill level 5, the correction value for the event points is +100%. As such, the higher the skill level, the larger the correction value for the event points.

As described above, when an event race is held, the raised character acquires an event skill factor with a specified probability according to the order of arrival. Here, when the raised character has an event skill, the raised character can acquire an event skill factor of the factor level on the basis of the skill level of the event skill of the raised character.

Here, the event skill factor to be acquired by the raised character is an event skill factor having a factor level equal to a value obtained by adding a specified value to a value of the skill level of the event skill of the raised character. The specified value is, for example, +1. Specifically, when the raised character has an event skill of skill level 1, the factor level of the event skill factor to be acquired by the raised character is “2”, which is the value obtained by adding “+1” to the value “1” of the skill level. Note that, when the raised character has no event skill and acquires an event skill factor in an event race, the factor level of that acquired event skill factor is 1.

Note that, when an event race is held, the raised character having an event skill acquires an event skill factor without fail. However, this is not limiting, and, alternatively, the raised character having an event skill may acquire an event skill factor with a specified probability according to the order of arrival as described above.

As such, the raised character can acquire an event skill factor in the event race. In the raising game, a raised character of the next generation can acquire an event skill corresponding to the factor level of the event skill factor by using, as an inheritance character, a raised character having an event skill factor.

Then, in an event race, a raised character having an event skill can acquire an event skill factor of a factor level on the basis of the skill level of the event skill.

Thus, the event skill factor and the event skill can be sequentially improved by raising a next-generation raised character by using a raised character having an event skill factor and by having the next-generation raised character participate in an event race. Improving the event skill provides advantages in acquiring event points in an event race.

As such, in this embodiment, a raised character that has parameters advantageous for acquiring event points in an event race can be generated. The player can efficiently make progress in event games by alternatingly play an event race and a raising game, and thus the eagerness to play the game can be improved.

Next, the functional structures of the player terminal 1 and the server 1000 for holding the raising game and the event race described above are described.

### (Functional Structure of Player Terminal 1)

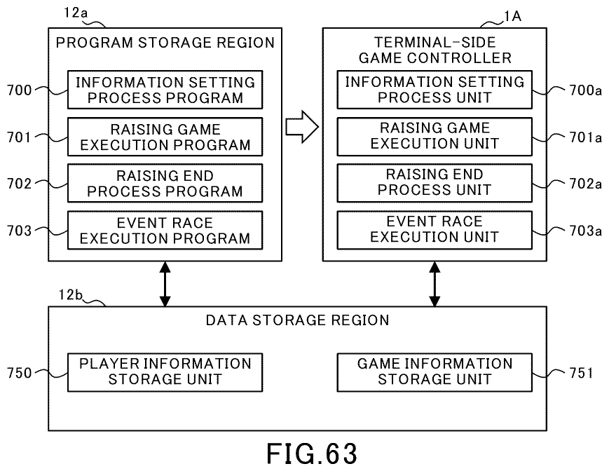

FIG. 63 is a diagram illustrating the structure of a memory 12 in the player terminal 1 and the function as a computer. The memory 12 includes a program storage region 12a and a data storage region 12b. A CPU 10 stores terminal-side game control programs (modules) in the program storage region 12a when a game starts.

The terminal-side game control programs include an information setting process program 700, a raising game execution program 701, a raising end process program 702, and an event race execution program 703. The programs listed in FIG. 63 are merely examples, and a large number of other programs are provided as the terminal-side game control programs.

The data storage region 12b includes, as the storage units where the data is stored, a player information storage unit 750 and a game information storage unit 751. Note that the data storage region 12b also includes a large number of other storage units. Here, information directly related to the games (hereinafter referred to as the game information), such as the raising game and the event race, are stored in the game information storage unit 751.

Various pieces of information during the progress of games such as a raising game are also temporarily stored in the game information storage unit 751. Thus, all pieces of information regarding the raised characters raised in the raising game are stored in the game information storage unit 751. Furthermore, for example, all pieces of information other than the game information, such as information regarding the player or other players and setting information of the player terminal 1, are deemed as the player information. The player information is stored in the player information storage unit 750.

The CPU 10 runs the programs stored in the program storage region 12a and updates the data in each storage unit in the data storage region 12b. The CPU 10 runs the programs stored in the program storage region 12a so that the player terminal 1 (computer) functions as a terminal-side game controller 1A. The terminal-side game controller 1A includes an information setting process unit 700a, a raising game execution unit 701a, a raising end process unit 702a, and an event race execution unit 703a.

Specifically, the CPU 10 runs the information setting process program 700 so that the computer functions as the information setting process unit 700a. In the same manner, the CPU 10 runs the raising game execution program 701, the raising end process program 702, and the event race execution program 703 so that the computer functions as the raising game execution unit 701a, the raising end process unit 702a, and the event race execution unit 703a.

When various pieces of information are set in the player terminal 1, the information setting process unit 700a stores information regarding the settings as the player information in the player information storage unit 750. In addition, the information setting process unit 700a transmits the update information to the server 1000 when the information in the player information storage unit 750 is updated.

The raising game execution unit 701a executes all processes regarding the raising game. Specifically, the raising game execution unit 701a executes a preparation stage process and a raising stage process.

The raising end process unit 702a stores, at the end of the raising game, raised character information that includes ability parameters, aptitude parameters, and acquired skills of the raised character, inheritance information, factor information, types of characters used in raising, etc.

The event race execution unit 703a executes all processes regarding the event race.

### (Functional Structure of Server 1000)

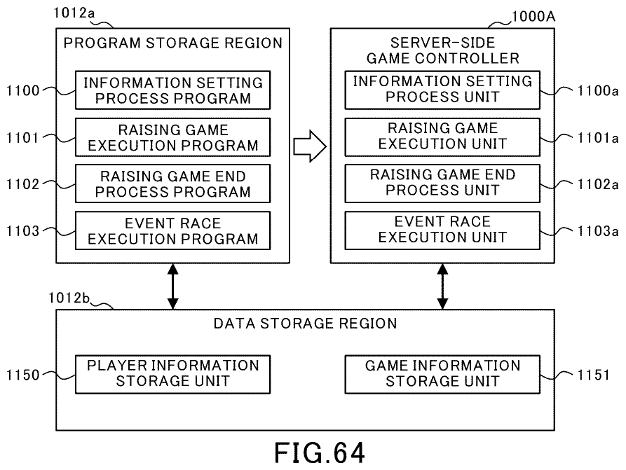

FIG. 64 is a diagram illustrating the structure of a memory 1012 in the server 1000 and the function as a computer. The memory 1012 includes a program storage region 1012a and a data storage region 1012b. A CPU 1010 stores server-side game control programs (modules) in the program storage region 1012a when a game starts.

The server-side game control programs include an information setting process program 1100, a raising game execution program 1101, a raising game end process program 1102, and an event race execution program 1103. The programs listed in FIG. 64 are merely examples, and a large number of other programs are provided as the server-side game control program.

The data storage region 1012b includes, as the storage units where the data is stored, a player information storage unit 1150 and a game information storage unit 1151. Note that the data storage region 1012b also includes a large number of other storage units. Here, the game information of all players is linked with the player IDs and is stored in the game information storage unit 1151. In addition, the player information of all players is linked with the player IDs and is stored in the player information storage unit 1150.

The CPU 1010 runs the programs stored in the program storage region 1012a and updates the data in each storage unit in the data storage region 1012b. The CPU 1010 runs the programs stored in the program storage region 1012a so that the server 1000 (computer) functions as a server-side game controller 1000A. The server-side game controller 1000A includes an information setting process unit 1100a, a raising game execution unit 1101a, a raising game end process unit 1102a, and an event race execution unit 1103a.

Specifically, the CPU 1010 runs the information setting process program 1100 so that the computer functions as the information setting process unit 1100a. In the same manner, the CPU 1010 runs the raising game execution program 1101, the raising game end process program 1102, and the event race execution program 1103 so that the computer functions as the raising game execution unit 1101a, the raising game end process unit 1102a, and the event race execution unit 1103a.

When various pieces of information are set in the player terminal 1, the information setting process unit 1100a updates the player information in the player information storage unit 1150 on the basis of the update information received from the player terminal 1. In addition, the information setting process unit 1100a counts the time and updates the game points of each player.

The raising game execution unit 1101a executes all processes regarding the raising game.

When the raising game ends, the raising game end process unit 1102a derives the score, the raising rank, etc., of the raised character. In addition, the raising game end process unit 1102a determines, by a lottery, the factor to be acquired by the raised character. Furthermore, the raised character information including the ability parameters, the aptitude parameters, and the acquired skills of the raised character, inheritance information, factor information, and types of characters used in raising is linked with the player IDs and is stored in the game information storage unit 1151.

The event race execution unit 1103a simulates the race results of the event race and derives the order of arrival of the raised character as the race results. In addition, the event race execution unit 1103a calculates the event points according to the order of arrival of the raised character and the event skills. The event race execution unit 1103a also gives an event skill factor to the raised character.

Note that the information setting process unit 700a in the player terminal 1 and the information setting process unit 1100a in the server 1000 have the common feature in that both store the player information; however, the specific contents of the processes and the ranges of the player information stored are different. Furthermore, the raising game execution unit 701a in the player terminal 1 and the raising game execution unit 1101a in the server 1000 have the common feature in that both execute processes related to the raising game; however, the roles of these units, in other words, the assigned ranges, are different.

The processes to be performed by the individual function units in the player terminal 1 and the server 1000 described above will now be described by using flowcharts.

### (Processes in Player Terminal 1 and Server 1000)

### <Processes Related to Raising Game>

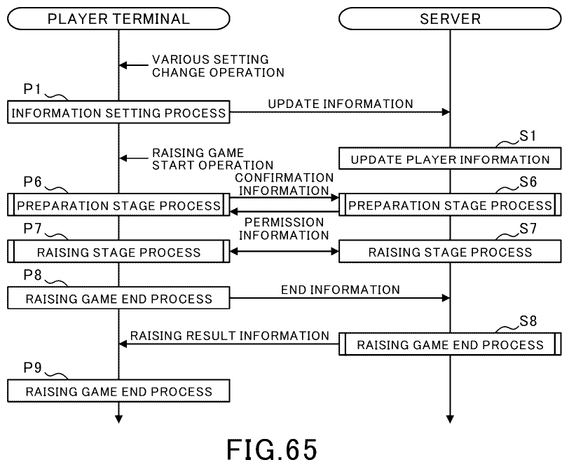

FIG. 65 is a sequence diagram illustrating the raising game-related processes in the player terminal 1 and the server 1000. In the description below, a process performed in the player terminal 1 is denoted as Pn (n is any desired integer). Furthermore, a process performed in the server 1000 is denoted as Sn (n is any desired integer).

When the player performs various types of setting change operations in the player terminal 1, the information setting process unit 700a in the player terminal 1 performs an information setting process (P1) for updating the player information storage unit 750 on the basis of the operation inputs of the player. In this information setting process, the update information is transmitted to the server 1000. When the server 1000 receives the update information, the information setting process unit 1100a updates the player information in the player information storage unit 1150 (S1).

Here, one example of the player information updated in P1 and S1 is profile information that can be set by the player. In addition, for example, when an operation of adding another player to a friend or an operation of cancelling a friend is input as the setting change operation, friend information, which is information regarding friends, is updated. In P1 and S1, the information setting process unit 700a and the information setting process unit 1100a each administer the game points to be spent in executing the raising game. The information setting process units 700a and 1100a count time and give a specified value of game points to the player every specified time when the game points are less than the upper limit.

When the raising game start operation for starting a raising game is input in the player terminal 1, the raising game execution unit 701a executes a preparation stage process (P6). During this preparation stage process, a communication process is performed between the player terminal 1 and the server 1000. In the server 1000, the raising game execution unit 1101a executes the preparation stage process (S6) on the basis of the information received from the player terminal 1.

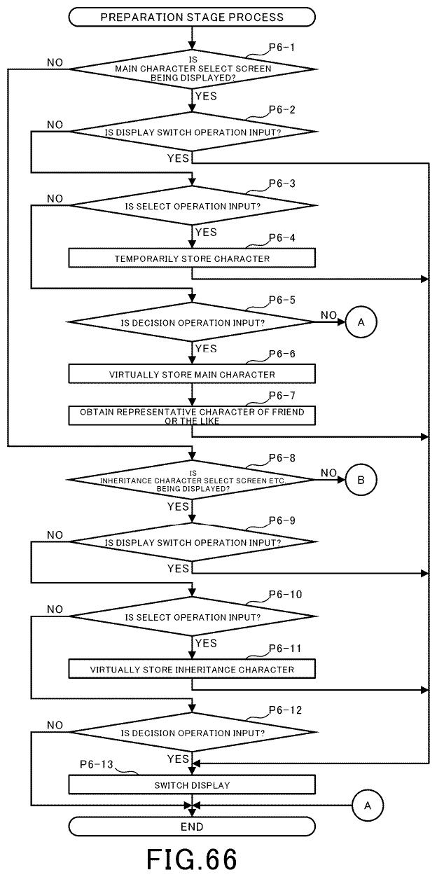

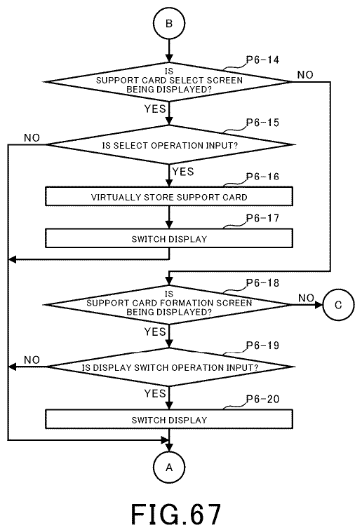

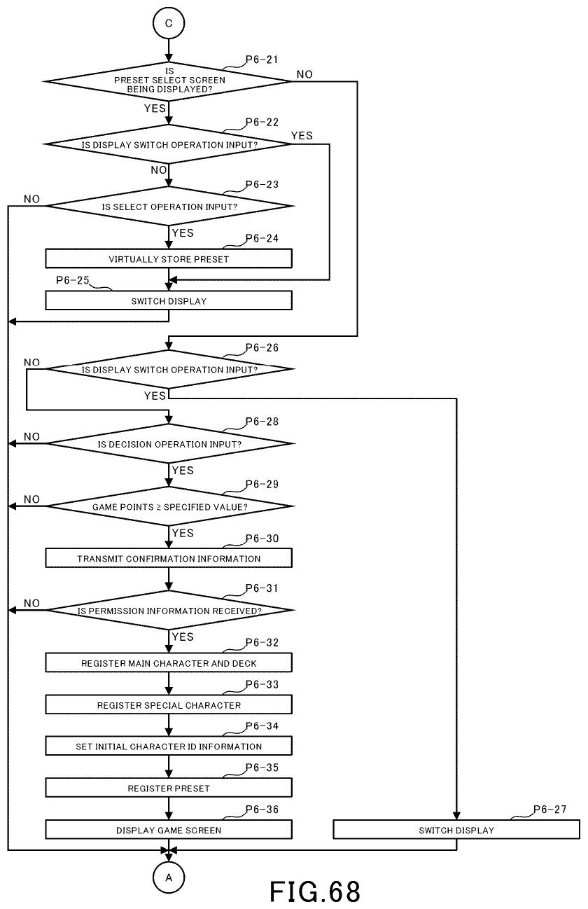

FIG. 66 is a first flowchart illustrating the preparation stage process (P6) in the player terminal 1. FIG. 67 is a second flowchart illustrating the preparation stage process (P6) in the player terminal 1. FIG. 68 is a third flowchart illustrating the preparation stage process (P6) in the player terminal 1. The raising game execution unit 701a in the player terminal 1 determines whether or not the display 26 is displaying the main character select screen 150 (P6-1).

When the main character select screen 150 is being displayed (YES in P6-1) and a display switch operation of switching the screen display is input (YES in P6-2), the raising game execution unit 701a switches the screen displayed on the display 26 (P6-13).

In addition, when a select operation (tapping a character icon 151) is input in the main character select screen 150 (YES in P6-3), the raising game execution unit 701a virtually stores the character corresponding to the character icon 151 for which the select operation has been input (P6-4), and switches the display screen (P6-13).

In addition, when a decision operation (tapping the next operation portion 154) is input in the main character select screen 150 (YES in P6-5), the raising game execution unit 701a virtually registers the virtually stored character in P6-4 described above as the main character (P6-6). In addition, the raising game execution unit 701a acquires, from the server 1000, the information extracted according to a specified extraction condition and related to a representative character, such as a representative character of a friend (P6-7) and switches the display screen (P6-13).

When the inheritance character select screen 170 or the raised character list screen 180 is being displayed (YES in P6-8) and when a display switch operation of switching the screen display is input (YES in P6-9), the raising game execution unit 701a switches the screen displayed on the display 26 (P6-13).

Here, examples of the display switch operation in the inheritance character select screen 170 or the raised character list screen 180 include tapping the skill display button 172 and tapping and holding the raised character icon 182 illustrated in FIG. 10B, and tapping the nickname change button 186a, the memo input button 186b, the skill display tab 188a, the inheritance information display tab 188b, the raising information display tab 188c, and the close operation portion 188d in the character detail dialogue 185A illustrated in FIG. 15.

For example, when the skill display button 172 in the raised character list screen 180 is tapped, the raising game execution unit 701a displays the skill display dialogue 185B in P6-13. Here, in the raised character list screen 180, when a raised character icon 182 is tapped and held, the raising game execution unit 701a displays the character detail dialogue 185A in P6-13. Note that, when the nickname change button 186a, the memo input button 186b, the skill display tab 188a, the inheritance information display tab 188b, the raising information display tab 188c, or the close operation portion 188d in the character detail dialogue 185A is tapped, the screen switches to a screen corresponding to each operation portion.

In addition, when a select operation (tapping a raised character icon 182) is input in the main character list screen 180 (YES in P6-10), the raising game execution unit 701a sets and virtually stores, as an inheritance character (in-use game medium), the character (raising-completed game medium) corresponding to the raised character icon 182 for which the select operation has been input (P6-11), and switches the display screen (P6-13).

In addition, when a decision operation (tapping the next operation portion 154) is input in the inheritance character select screen 170 (YES in P6-12), the raising game execution unit 701a displays the support card formation screen 190 on the display 26 (P6-13).

In addition, when the support card select screen 200 is being displayed (YES in P6-14 in FIG. 67) and a select operation (tapping the card icon 201 of the support card) is input in the support card select screen 200 (YES in P6-15), the raising game execution unit 701a virtually stores the support card corresponding to the card icon 201 for which the select operation has been input (P6-16), and switches the display screen (P6-17).

When the support card formation screen 190 is being displayed (YES in P6-18) and a display switch operation of switching the screen display is input (YES in P6-19), the raising game execution unit 701a switches the screen displayed on the display 26 (P6-20).

When the preset select screen 205A is being displayed (YES in P6-21 in FIG. 68) and a display switch operation of switching the screen display is input (YES in P6-22), the raising game execution unit 701a switches the screen displayed on the display 26 (P6-25).

In addition, when a select operation (tapping the select operation portion 206c) is input in the preset select screen 205A (YES in P6-23), the raising game execution unit 701a virtually stores the reservation select information corresponding to the preset for which the select operation has been input (P6-24), and switches the display screen (P6-25).

When the final confirmation screen 205 is being displayed (NO in P6-21) and a display switch operation of switching the screen display is input (YES in P6-26), the raising game execution unit 701a switches the screen displayed on the display 26 (P6-27).

When a decision operation (tapping the start operation portion 205b) is input in the final confirmation screen 205 (YES in P6-28), the raising game execution unit 701a judges whether the game points are equal to or higher than a specified value (for example, 30) (P6-29). When the game points are equal to or higher than the specified value (YES in P6-29), the raising game execution unit 701a transmits confirmation information to the server 1000 (P6-30).

Note that the confirmation information includes the information that identifies the temporarily registered main characters, inheritance characters, and support cards. When the confirmation information is received, the server 1000 judges whether or not to permit execution of the raising main game by using the temporarily registered main character, inheritance characters, and support cards in the preparation stage process (S6).

When the player terminal 1 transmits the confirmation information (P6-30) and then receives the permission information (YES in P6-31), the raising game execution unit 701a registers the main character temporarily registered in P6-6 described above (P6-32). In addition, the raising game execution unit 701a registers, into a deck, raised characters virtually stored as inheritance characters in P6-11 described above and the support cards virtually stored in P6-16 described above.

Furthermore, the raising game execution unit 701a registers the character identifications of the characters set as special characters on the basis of the special character information (P6-33). The raising game execution unit 701a also sets the initial character identification information (P6-34). Furthermore, the raising game execution unit 701a registers the reservation select information of the preset virtually stored in P6-24 described above (P6-35). The raising game execution unit 701a also displays the game screen 210 on the display 26 (P6-36).

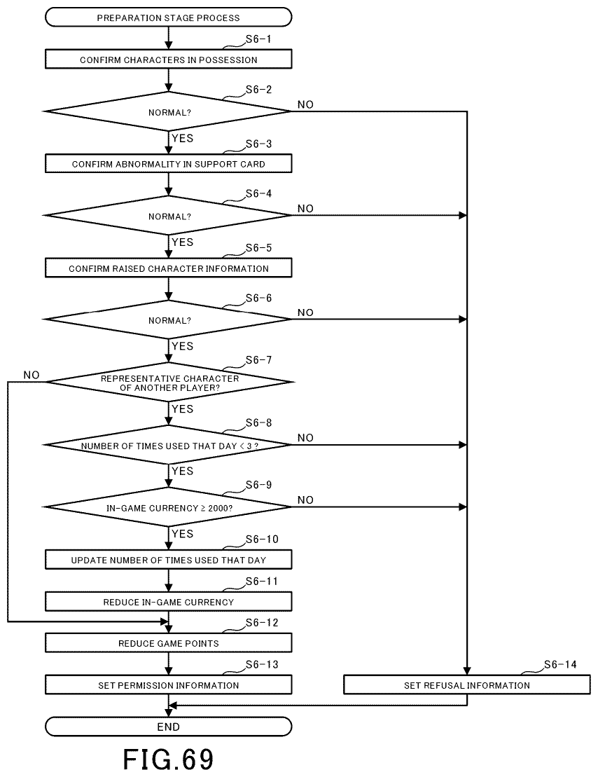

FIG. 69 is a flowchart illustrating the preparation stage process (S6) in the server 1000. The raising game execution unit 1101a that has received the confirmation information confirms the characters in the player's possession stored in the player information storage unit 1150 (S6-1). The raising game execution unit 1101a judges that there is no abnormality if the main character selected by the player is included in the in-possession characters (S6-2).

When there is no abnormality in the main character selected by the player (YES in S6-2), the raising game execution unit 1101a confirms whether there is abnormality in the support cards selected by the player (S6-3). Note that, in S6-3, it is judged that there is abnormality when, for example, a support card not in possession of the player is selected, the rental card selected by the player is not linked with the player ID of that player, or the support character overlaps the main character.

When there is no abnormality in the support cards selected by the player (YES in S6-4), the raising game execution unit 1101a confirms the raised character information stored in the game information storage unit 1151 (S6-5). Then the raising game execution unit 1101a judges that there is no abnormality in the inheritance characters if the raised characters selected by the player as the inheritance characters are linked with the player ID of that player, in other words, if the raised characters raised by the player are selected as the inheritance characters (YES in S6-6).

When it is judged that there is no abnormality in the inheritance characters, the raising game execution unit 1101a judges whether the raised characters selected by the player as the inheritance characters include representative characters of other players (S6-7). If a representative character of another player is included (YES in S6-7), the raising game execution unit 1101a judges whether the number of times used that day is less than 3 (S6-8).

When the number of times used that day is less than 3 (YES in S6-8), the raising game execution unit 1101a judges whether the specified in-game currency that the player has is 2000 or more (S6-9). In other words, in S6-8 and S6-9, it is judged whether the formation conditions are satisfied. When the player has 2000 or more of in-game currency (YES in S6-9), the raising game execution unit 1101a adds “1” to the number of times used that day (S6-10). The raising game execution unit 1101a also subtracts 2000 from the amount of the specified in-game currency in possession stored in the player information storage unit 1150 (S6-11).

Furthermore, the raising game execution unit 1101a subtracts a specified value (for example 30) from the game points of the player (S6-12). Next, the raising game execution unit 1101a sets permission information when there is no abnormality in the main character, the inheritance characters, and the support cards and when the formation conditions for using the representative characters of other players are satisfied (S6-13), and causes the player terminal 1 to receive this information. Meanwhile, when there is an abnormality in any one of the main character, the inheritance characters, and the support cards or when the formation conditions for using the representative characters of other players are not satisfied, the raising game execution unit 1101a sets refusal information (S6-14) and causes the player terminal 1 to receive this information.

Referring back to FIG. 65, after the preparation stage process (P6) ends, the raising game execution unit 701a executes a raising stage process (P7). During this raising stage process, a communication process is performed between the player terminal 1 and the server 1000. In the server 1000, the raising game execution unit 1101a executes the raising stage process (S7) on the basis of the information received from the player terminal 1. Note that, actually, tasks are divided among the player terminal 1 and the server 1000, and the raising main game progresses through the raising stage process (P7) in the player terminal 1 and the raising stage process (S7) in the server 1000; however, for the sake of ease of understanding, it is assumed here that all processes are performed in the raising stage process (P7) in the player terminal 1. It should be noted that some or all of the processes in the raising stage process (P7) described below may be performed in the raising stage process (S7) in the server 1000.

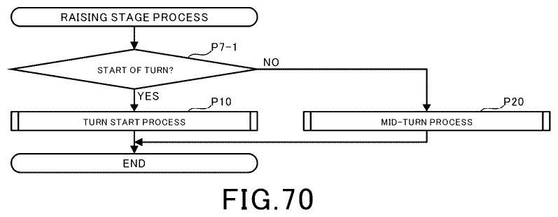

FIG. 70 is a flowchart illustrating the raising stage process in the player terminal 1. The raising game execution unit 701a in the player terminal 1 executes a turn start process (P10) if the process is at the start of the turn (YES in P7-1) and executes a mid-turn process (P20) if the process is not at the start of the turn.

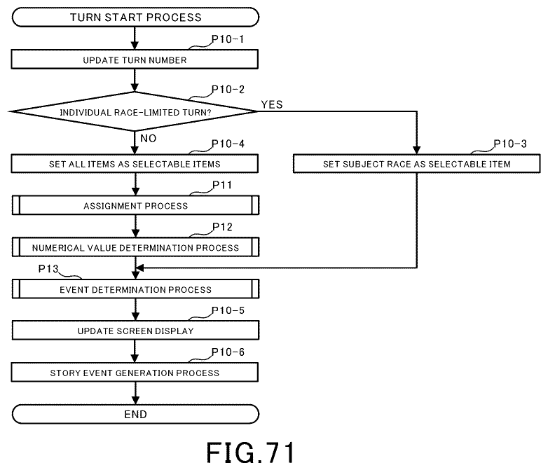

FIG. 71 is a flowchart illustrating the turn start process in the player terminal 1. The raising game execution unit 701a updates the current turn number stored in the game information storage unit 751 (P10-1). Furthermore, the raising game execution unit 701a refers to the selection item table (FIG. 24) stored in the data storage region 12b, and judges whether or not the current turn is the turn on which only an individual race can be selected (individual race-limited turn) (P10-2).

When the turn is an individual race-limited turn (YES in P10-2), in other words, when a subject race is set as the race in which participation is possible on this turn, the raising game execution unit 701a sets the subject race as the selectable item that can be selected by the player (P10-3), and the process proceeds to P13. As a result, on this turn, the player can only operate on the individual race operation portion 219 and the skill operation portion 217 and operations on other operation portions are restricted.

When the turn is not the individual race-limited turn (NO in P10-2), the raising game execution unit 701a sets all items as the selectable items that can be selected by the player (P10-4). Next, the raising game execution unit 701a sequentially executes an assignment process (P11), a numerical value determination process (P12), and an event determination process (P13).

Here, it is assumed that the assignment process (P11), the numerical value determination process (P12), and the event determination process (P13) are executed only in the player terminal 1. Alternatively, some or all of the assignment process (P11), the numerical value determination process (P12), and the event determination process (P13) may be executed in the server 1000. Furthermore, some of the processes in the assignment process (P11), the numerical value determination process (P12), and the event determination process (P13) described below may be executed in the server 1000. When the aforementioned processes are executed in the server 1000, the processes performed in the player terminal 1 are based on the information received from the server 1000.

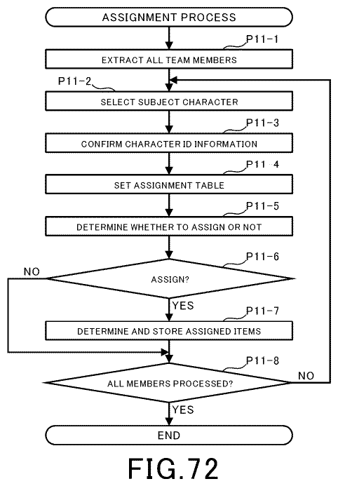

FIG. 72 is a flowchart illustrating the assignment process in the player terminal 1. The raising game execution unit 701a refers to the character identification information table (FIGS. 22 and 23) and extracts all characters registered as the team members (P11-1). Next, the raising game execution unit 701a selects, from among the team members extracted in P11-1, a character not subjected to the processes P11-3 to P11-7 described below as a subject character to be subjected to the processes (P11-2).

The raising game execution unit 701a refers to the character identification information table and confirms the character identification information of the subject character selected in P11-2 above (P11-3). The raising game execution unit 701a also sets the assignment table (FIG. 33) on the basis of the character identification information confirmed in P11-3 described above (P11-4). Furthermore, the raising game execution unit 701a determines, by a lottery, whether to conduct “assignment” or “no assignment” on the basis of the assignment table set in P11-4 described above (P11-5).

When “assignment” is determined (YES in P11-6), the raising game execution unit 701a determines and stores the training item to which the subject character is assigned (P11-7). When the process is yet to end for all of the team members extracted in P11-1 described above (NO in P11-8), the raising game execution unit 701a repeats the process from P11-2 until the process ends for all of the team members. Meanwhile, if the process ends for all of the team members (YES in P11-8), the raising game execution unit 701a ends the assignment process and executes the numerical value determination process (P12).

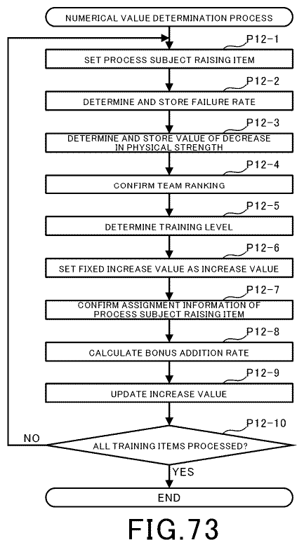

FIG. 73 is a flowchart illustrating the numerical value determination process in the player terminal 1. The raising game execution unit 701a sets a process subject item not subjected to the processes P12-2 to P12-9 described below from among the following training items: “speed”, “stamina”, “power”, “spirit”, and “wisdom” (P12-1).

Furthermore, the raising game execution unit 701a determines and stores the failure rate of the executed training with respect to the process subject item set in P12-1 on the basis of the present physical strength of the main character (P12-2). Furthermore, the raising game execution unit 701a determines and stores the value of decrease in physical strength when the training is executed with respect to the process subject item set in P12-1 (P12-3).

The raising game execution unit 701a also confirms the present team ranking (P12-4) and, on the basis of the team ranking, refers to the training level table (FIG. 34A) and determines the training level (P12-5).

The raising game execution unit 701a also refers to the fixed increase value table (FIGS. 34B and 34C) corresponding to the process subject item set in P12-1, and, on the basis of the training level determined in P12-5, determines and sets the fixed increase value (P12-6). The raising game execution unit 701a also confirms the information (assignment information) of the character for which assignment has been determined in P11 with respect to the training of the process subject item (P12-7).

The raising game execution unit 701a also refers to a bonus addition rate table (FIG. 34D) and calculates the bonus addition rate on the basis of the assignment information confirmed in P12-7 (P12-8). The raising game execution unit 701a updates the increase value on the basis of the bonus addition rate calculated in P12-8 with respect to the training of the process subject item (P12-9).

The raising game execution unit 701a repeats the process from P12-1 when the process of P12-2 to P12-9 is yet to end for all of the training items (NO in P12-10). Meanwhile, if the process ends for all of the training items (YES in P12-10), the raising game execution unit 701a ends the numerical value determination process and executes the event determination process (P13).

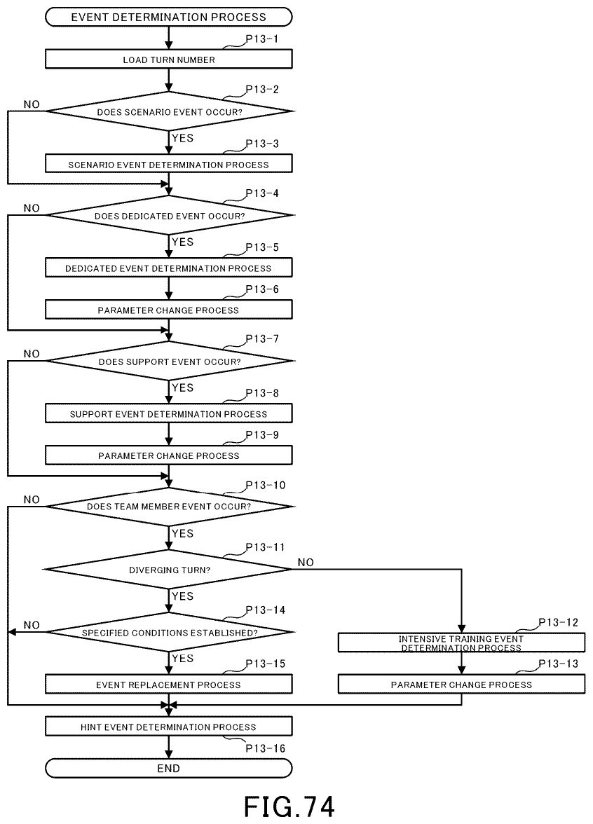

FIG. 74 is a flowchart illustrating the event determination process in the player terminal 1. The raising game execution unit 701a loads the current turn number (P13-1). Furthermore, the raising game execution unit 701a refers to the event occurrence determination table stored in the data storage region 12b and determines whether a scenario event occurs or not (P13-2). When it is determined that a scenario event will occur, in other words, when it is a scenario event occurring turn (YES in P13-2), the content (event ID) of the scenario event is determined on the basis of the event content determination table and stored (P13-3).

Specifically, the raising game execution unit 701a generates, on the basis of the event content determination table, a lottery table according to the event IDs of the scenario events that can occur. Then the raising game execution unit 701a determines by a lottery the content of the scenario event, that is, the event ID, by using the generated lottery table. Here, when the determined scenario event is an event, such as an ability event, that changes a parameter, the value of change is determined.

The raising game execution unit 701a then refers to the event occurrence determination table and determines whether a dedicated event occurs or not (P13-4). When it is determined that a dedicated event will occur, in other words, when it is a dedicated event occurring turn (YES in P13-4), the content (event ID) of the dedicated event is determined on the basis of the event content determination table and stored (P13-5).

Specifically, the raising game execution unit 701a generates, on the basis of the event content determination table, a lottery table according to the event IDs of the dedicated events that can occur. Then the raising game execution unit 701a determines by a lottery the content of the dedicated event, that is, the event ID, by using the generated lottery table. Here, when the determined dedicated event is an event, such as an ability event, that changes a parameter, the value of change is determined.

When the main character is a special character, the raising game execution unit 701a executes a parameter change process (P13-6) that changes the value of change in parameter that would be changed by the dedicated event. For example, in the parameter change process, a specified fixed value is added to or subtracted from the value of change determined in P13-5 or the value of change is multiplied by a specified multiplying factor. Here, the value of change is changed for the advantage of the player. In this manner, when the main character is a special character, the parameter changes more advantageously by the dedicated event.

The raising game execution unit 701a also refers to the event occurrence determination table and determines whether a support event occurs or not (P13-7). When it is determined that a support event will occur, in other words, when it is a support event occurring turn (YES in P13-7), the content (event ID) of the support event is determined on the basis of the event content determination table and stored (P13-8).

Specifically, the raising game execution unit 701a generates, on the basis of the event content determination table, a lottery table according to the event IDs of the support events that can occur. Here, the probability of winning a support event linked with a registered support card is set higher than the probabilities of winning other support events. By using the generated lottery table, the raising game execution unit 701a determines by a lottery the content of the support event, that is, the event ID. Here, when the determined support event is an event, such as an ability event, that changes a parameter, the value of change is determined.

When the main character or the support character linked with the support event is a special character, the raising game execution unit 701a executes a parameter change process (P13-9) that changes the value of change in parameter that would be changed by the support event.

The raising game execution unit 701a then refers to the event occurrence determination table and determines whether a team member event occurs or not (P13-10). When it is determined that a team member event will occur, in other words, when it is a team member event occurring turn (YES in P13-10), the raising game execution unit 701a determines whether the present turn is a diverging turn or not (P13-11).

If the turn is not a diverging turn (NO in P13-11), the raising game execution unit 701a determines, on the basis of the event content determination table, and stores an intensive training event corresponding to the present turn number as the event to occur (P13-12). Here, various increase values regarding intensive training events are determined.

When the main character or the character to be intensively trained is a special character, the raising game execution unit 701a executes a parameter change process (P13-13) that changes the value of change in parameter that would be changed by the intensive training event.

Furthermore, when the present turn is a diverging turn (YES in P13-11), the raising game execution unit 701a determines whether or not specified conditions are established (P13-14). Here, as mentioned above, it is judged whether the number of special characters included in the team members is equal to the specified number specified for each turn number. When the specified conditions are established (YES in P13-14), the raising game execution unit 701a replaces the scenario event stored in P13-3 by a special character event (P13-15). Here, the special character event that replaces the scenario event may be determined by a lottery or may be preliminarily set for each turn.

Furthermore, the raising game execution unit 701a performs a hint event determination process regarding a hint event for each character assigned to the training (P13-16). Here, whether a hint event occurs or not is determined by a lottery for each of the characters assigned to the training. When a hint event is to occur, it is determined which hint event is to occur.

Referring back to FIG. 71, the raising game execution unit 701a updates the screen displayed on the display 26 (P10-5). When a story event is to be generated at the start of the turn, a story event selected from events determined in P13 is generated (P10-6).

Referring back to FIG. 70, if it is not at the start of the turn (NO in P7-1), the raising game execution unit 701a executes a mid-turn process (P20).

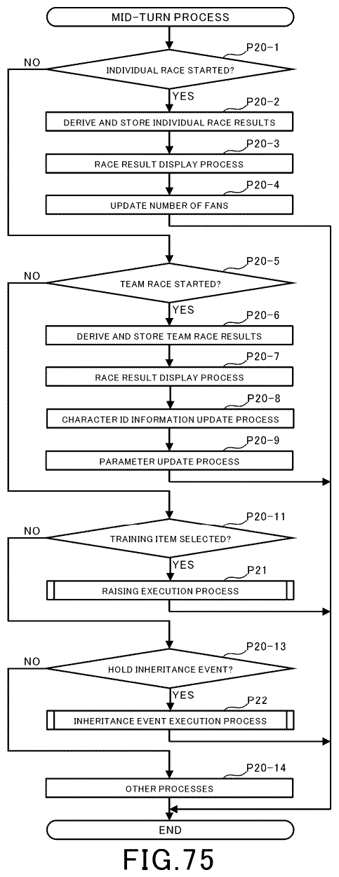

FIG. 75 is a flowchart illustrating the mid-turn process in the player terminal 1. The raising game execution unit 701a judges whether or not the result operation portion 253 or the race operation portion 254 in the individual race start screen 250 has been operated and whether or not an individual race has been started (P20-1). When an individual race has been started (YES in P20-1), the raising game execution unit 701a derives the results of the individual race, updates the parameters related to the race results, and stores the parameters etc. in the game information storage unit 751 (P20-2).

Specifically, for example, a calculation formula with weighting on the ability parameters and acquired skills of the NPCs and main character is set in advance, and the order of arrival in the individual race is determined by the calculation results. Note that this calculation formula may be set to differ from one race to another. In addition, for example, multiple patterns of the ability parameters of the NPCs may be set for each race, and which of the ability parameters is to be used may be determined by a lottery. In other words, even when the ability parameters, acquired skills, and participating races of the main character are all completely the same, the race results may differ. In addition, the calculation formula for weighting etc., may be provided in multiple patterns for each race, and the results may be made to differ depending on the selected calculation formula.

Here, it is assumed that the individual race results are derived in the player terminal 1. Alternatively, the individual race results may be derived in the server 1000. In such a case, information requesting that the individual race results be derived and information needed to derive the individual race results are transmitted from the player terminal 1 to the server 1000. Then the individual race results derived in the server 1000 may be received by the player terminal 1.

On the basis of the individual race results derived in P20-2, the raising game execution unit 701a executes a race result display process of displaying the individual race result screen 260 or a race video on the display 26 (P20-3).

The raising game execution unit 701a also derives the number of fans newly acquired on the basis of the race results, and adds this number to the number of fans acquired thus far (P20-4).

The raising game execution unit 701a judges whether or not the result operation portion 291 or the race operation portion 292 in the team race start screen 290 has been operated and whether or not a team race has been started (P20-5). As a result, if a team race has been started, the process proceeds to P20-6, and if a team race has not yet been started, the process proceeds to P20-11.

The raising game execution unit 701a derives the results of the team race and stores the results in the game information storage unit 751 (P20-6). Specifically, for example, a calculation formula with weighting on the ability parameters and acquired skills of the NPCs, the main character, and other team members is set in advance, and the order of arrival in the team race is determined by the calculation results. Note that this calculation formula may be set to differ from one race to another. In addition, for example, multiple patterns of the ability parameters of the NPCs may be set for each race, and which of the ability parameters is to be used may be determined by a lottery. In other words, even when the ability parameters, acquired skills, and participating races of the main character and other team members are all completely the same, the race results may differ. In addition, the calculation formula for weighting etc., may be provided in multiple patterns for each race, and the results may be made to differ depending on the selected calculation formula.

Here, it is assumed that the team race results are derived in the player terminal 1. Alternatively, the team race results may be derived in the server 1000. In such a case, information requesting that the team race results be derived and information needed to derive the team race results are transmitted from the player terminal 1 to the server 1000. Then the team race results derived in the server 1000 may be received by the player terminal 1.

On the basis of the team race results derived in P20-6, the raising game execution unit 701a executes a race result display process of displaying the team race midway result screen 300, the team race detail result screen 310, and the team race comprehensive result screen 320 on the display 26 (P20-7).

The raising game execution unit 701a also executes a character identification information update process (P20-8). Here, a specified number of characters are extracted according to specified conditions from among the characters presently registered as sub members. Then the character identification information of the extracted characters is updated to team members. In other words, in this embodiment, the number of team members increases every time a team race ends.

The raising game execution unit 701a executes a parameter update process of updating the information regarding team ranking on the basis of the team race results derived in P20-6 described above (P20-9).

When one of the training items is selected (YES in P20-11), the raising game execution unit 701a performs a raising execution process (P21). When none of the training items is selected (NO in P20-11), whether it is the timing for executing an inheritance event or not is judged (P20-13). If it is the timing for executing an inheritance event (YES in P20-13), the raising game execution unit 701a performs an inheritance event execution process (P22). If it is not the timing for executing an inheritance event (NO in P20-13), the raising game execution unit 701a executes a different process such as acquiring a skill by spending skill points (P20-14).

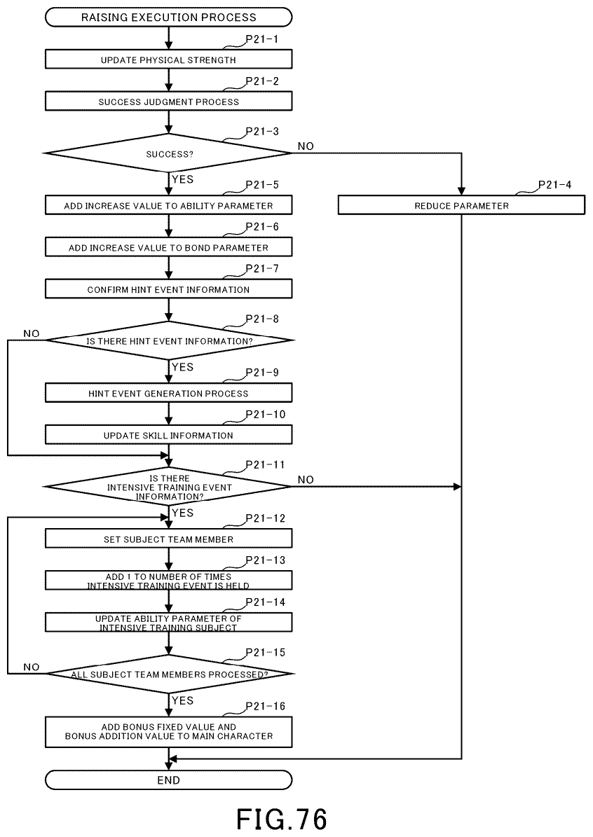

FIG. 76 is a flowchart illustrating the raising execution process in the player terminal 1. The raising game execution unit 701a updates the physical strength of the main character on the basis of the value of decrease in physical strength determined in P12-3 described above with respect to the selected training item (P21-1).

Furthermore, the raising game execution unit 701a executes a success judgment process of judging whether the training succeeds or not on the basis of the failure rate determined in P12-2 described above with respect to the selected training item (P21-2). If the training fails (NO in P21-3), the raising game execution unit 701a reduces the ability parameter, such as decreasing the condition, on the basis of the failure of the training (P21-4).

Meanwhile, if the training succeeds (YES in P21-3), the raising game execution unit 701a adds the increase value derived in P12-9 described above to the ability parameter of the main character (P21-5). Moreover, the raising game execution unit 701a adds the increase value to the value of the bond parameter determined in P13-12 and P13-13 (P21-6). In addition, the raising game execution unit 701a confirms the hint event information stored in the hint event determination process (P21-7).

If the hint event information is stored with respect to the selected training item (YES in P21-8), the raising game execution unit 701a allows a hint event to occur on the basis of the hint event information related to the selected training item (P21-9). If multiple pieces of the hint event information are stored with respect to the selected training item, the raising game execution unit 701a allows one of the hint events to occur. The raising game execution unit 701a updates the skill information regarding the main character stored in the game information storage unit 751 on the basis of the hint event information occurred in P21-9 (P21-10).

If intensive training event information is stored with respect to the selected training item (YES in P21-11), the raising game execution unit 701a sets a team member to be subjected to the intensive training event on the basis of the intensive training event information regarding the selected training item (P21-12).

In addition, the raising game execution unit 701a adds “1” to the number of times the coaching event is conducted on the team member set as the subject in P21-12 described above (P21-13). The raising game execution unit 701a also updates the ability parameters of the intensive training subject (P21-14). When the process of P21-13 to P21-14 ends for all of the team members subjected to the intensive training event (YES in P21-15), the raising game execution unit 701a adds a bonus additional value to the ability parameter of the main character on the basis of the selected training item and the intensive training event information (P21-16).

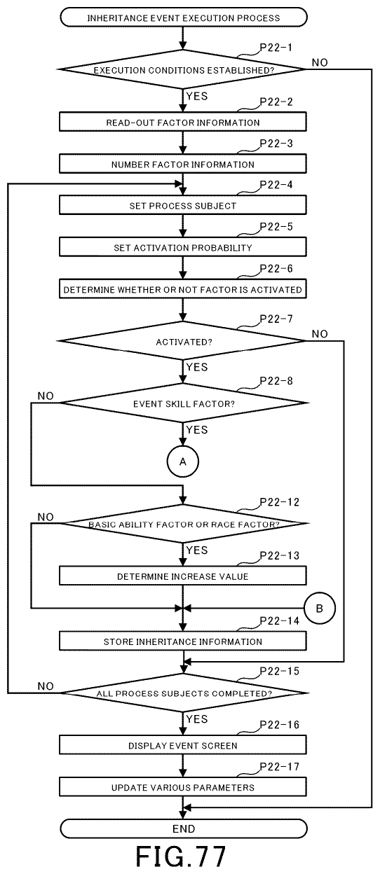

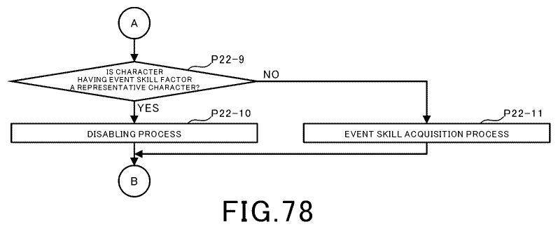

FIG. 77 is a first flowchart illustrating the inheritance event execution process in the player terminal 1. FIG. 78 is a second flowchart illustrating the inheritance event execution process in the player terminal 1. The raising game execution unit 701a judges whether the execution conditions for the inheritance event have been established or not (P22-1). Here, the inheritance event execution conditions differ depending on the factor activation turn. For example, the execution condition on the first turn is that the raising main game is started, and the execution conditions on the 30th turn and the 54th turn are that the operation portion (see FIG. 27A) displayed in the event screen 220b is operated.

If the execution condition for the inheritance event is established (YES in P22-1), the raising game execution unit 701a reads out the factor information linked with the raised characters of the inheritance first generation and inheritance second generation (P22-2). Furthermore, the raising game execution unit 701a sets numbers that indicate the order in which the read-out pieces of the factor information are processed in determining whether each piece of factor information is to be activated or not, etc. (numbering) (P22-3). Then the raising game execution unit 701a sets one factor as the process subject on the basis of the number set for each piece of factor information in P22-3 (P22-4) and sets its activation probability (P22-5). Note that, in step P22-5, the raising game execution unit 701a sets the activation probability to 100% if the subject to be processed is an event skill factor and the factor activation turn is the first turn.

The activation probability is set on the basis of the factor level, the factor information, and the compatibility level. Then the raising game execution unit 701a determines by a lottery whether or not to activate the factor to be processed on the basis of the activation probability set in P22-5 (P22-6). When it is determined that the factor to be processed is to be activated (YES in P22-7), whether the factor type is an event skill factor or not is judged (P22-8).

If the factor type is an event skill factor (YES in P22-8), the raising game execution unit 701a judges whether the character that has that event skill factor is a representative character of another player (P22-9). When the character having the event skill factor is a representative character of another player (YES in P22-9), the raising game execution unit 701a disables or removes the event skill factor (P22-10).

Meanwhile, when the character having the event skill factor is not a representative character of another player (NO in P22-9), the raising game execution unit 701a allows the main character to acquire an event skill (P22-11). The skill level of the event skill to be acquired by the main character is set according to the factor level (first parameter) of the event skill factor.

Specifically, the raising game execution unit 701a sets the skill level of the event skill to be acquired by the main character to the same level as the factor level of the event skill factor. As such, the raising game execution unit 701a changes the skill level (second parameter) of the event skill of the main character serving as the raising subject character on the basis of the factor level (first parameter) of the event skill factor.

When the factor type is not an event skill factor (NO in P22-8), it is judged whether the factor type is a basic ability factor or a race factor (P22-12). When the factor type is a basic ability factor or a race factor (YES in P22-12), an increase value of the subject ability parameter is determined on the basis of the factor type and the factor level (P22-13). Furthermore, the raising game execution unit 701a stores inheritance information that includes the ability parameters, the increase values of the aptitude parameters, and the skill hint to be acquired (P22-14).

The raising game execution unit 701a sets a new process subject when the process of P22-4 to P22-14 has not been completed for all of the process subjects (NO in P22-15) (P22-4), and repeats the same process as the one described above. When the process has been completed for all of the process subjects (YES in P22-15), the raising game execution unit 701a displays the event screen 220b related to the inheritance event (P22-16). Then the raising game execution unit 701a updates various parameters on the basis of the inheritance information stored in P22-14 (P22-17).

Here, for the sake of ease of understanding, it is assumed that the raising game execution unit 701a in the player terminal 1 executes the process of determining whether to activate a factor or not. Alternatively, whether to activate the factor may be determined by the raising game execution unit 1101a in the server 1000. In such a case, the information determined in the server 1000 may be received by the player terminal 1, and the raising game execution unit 701a may perform the process of displaying the event screen 220b on the basis of the received information.

Referring back to FIG. 65, after the raising stage process described above ends, the raising game execution unit 701a executes a raising game end process (P8) in the player terminal 1. In the raising game end process, the raising game execution unit 701a stores, in the game information storage unit 751, information regarding the raised characters raised in the raising game. In addition, the raising game execution unit 701a transmits end information to the server 1000. This end information includes information regarding the raised characters, etc. In the server 1000 that has received the end information, the raising game end process unit 1102a executes the raising stage end process (S8).

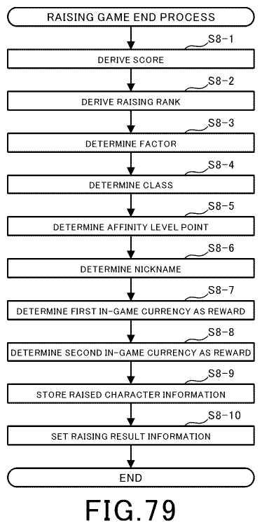

FIG. 79 is a flowchart illustrating the raising game end process in the server 1000. The raising game end process unit 1102a derives the score on the basis of the end information received from the player terminal 1 (S8-1). In addition, the raising game end process unit 1102a derives the raising rank on the basis of the derived score (S8-2).

The raising game end process unit 1102a also determines the factor to be acquired by the raised character (S8-3). In addition, the raising game end process unit 1102a determines the class on the basis of the number of fans acquired (S8-4). In addition, the raising game end process unit 1102a determines the affection level points on the basis of specified parameters such as the raising rank and the number of fans (S8-5). Although the detailed description is omitted, the affection level points are points not given to the raised character but to a character from which the raised character has originated.

Multiple story screens described above are provided for each of the characters, and a release condition is set for some of the story screens. The affection level points are set as the release condition for some of the story screens, and the player can view that story screen when the affection level points have reached the threshold or higher.

In addition, the raising game end process unit 1102a determines a nickname (S8-6). Here, the conditions achieved in the raising main game are confirmed in determining the nickname acquired by the raised character. In addition, the raising game end process unit 1102a determines the amount of the first in-game currency to be given on the basis of the number of fans acquired (S8-7), and determines the amount of the second in-game currency to be given on the basis of other information (S8-8). For example, the second in-game currency can be used in improving the level of the support card, and the amount thereof to be given is determined on the basis of the support card used in the latest raising game.

Furthermore, the raising game end process unit 1102a stores, in the game information storage unit 1151, the raised character information including the score, the raising rank, the ability parameters, the aptitude parameters, the acquired skills, the inheritance information, the factor information, the class, and the nickname linked with the player ID of the player (S8-9). The raising game end process unit 1102a sets the raising result information and allows the player terminal 1 to receive this information (S8-10).

Referring back to FIG. 65, the raising end process unit 702a that has received the raising result information executes the raising game end process (P9). Here, the raising end process unit 702a stores the received raising result information in the game information storage unit 751. The raising end process unit 702a also displays a raising complete screen 330 (see FIGS. 41A, 41B, and 41C) on the display 26 on the basis of the raising result information.

The aforementioned raising game is achieved by the aforementioned processes. In addition, the raised character information related to the raised character raised (formed) by the raising game is linked with the player ID and stored. Note that the processes in the player terminal 1 and the server 1000 described above are merely one example. Moreover, each of the processes described above may be executed in only the player terminal 1 or the server 1000.

### <Processes Related to Event Race>

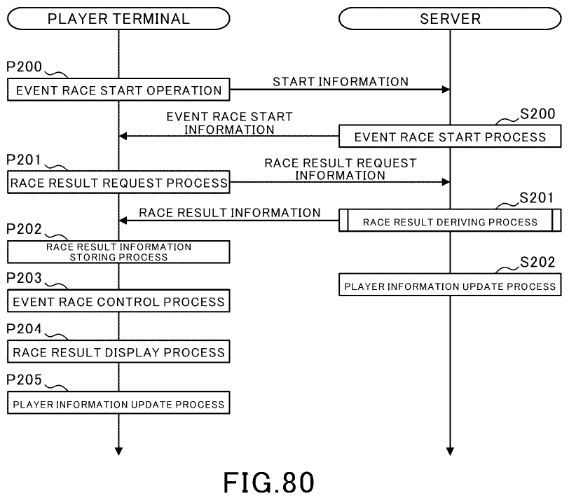

FIG. 80 is a sequence diagram illustrating the event race-related processes in the player terminal 1 and the server 1000. As illustrated in FIG. 80, in the player terminal 1, the player performs an event race start operation (P200). In such a case, the start information is transmitted from the player terminal 1 to the server 1000. Note that this start information includes information regarding the raised character (raising-completed game medium) selected by the player, the event race type information (information regarding regular event races, irregular event races, high-probability event races, and low-probability event races), etc.

When the start information is input, the server 1000 enables the player terminal 1 to download, from the server 1000, the event race start information necessary for starting the event race (S200).

When the event race execution unit 703a in the player terminal 1 receives the event race start information, the event race execution unit 703a executes a race result request process of transmitting race result request information to the server 1000 (P201). Upon receiving the race result request information, the event race execution unit 1103a in the server 1000 executes a race result deriving process (S201).

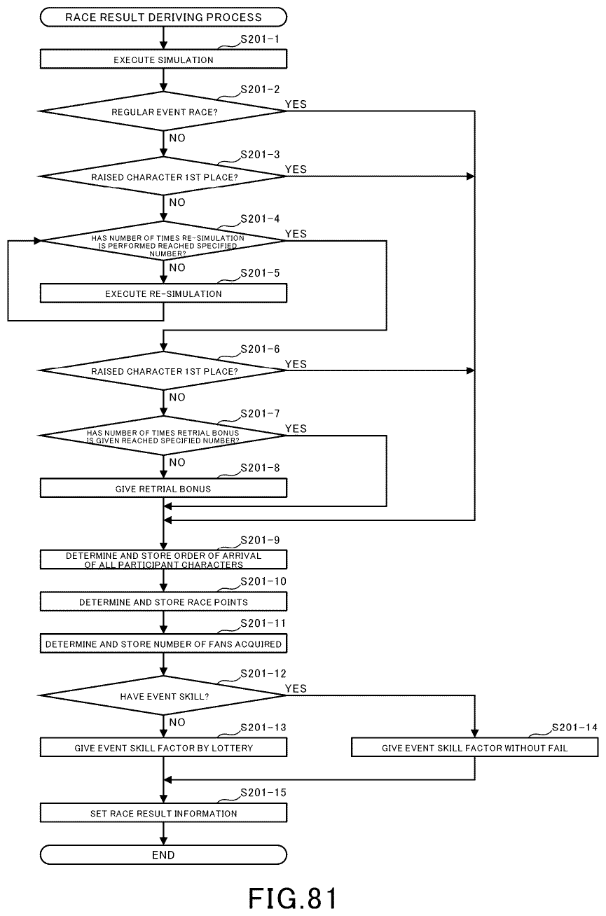

FIG. 81 is a flowchart illustrating the race result deriving process in the server 1000. The event race execution unit 1103a executes a simulation of the event race on the basis of the start information transmitted from the player terminal 1 (S201-1).

The event race execution unit 1103a judges whether or not the event race type selected by the player is a regular event race (S201-2). If the race is not a regular event race (that is, if it is during an irregular event race period), the event race execution unit 1103a judges whether or not the raised character has won the first place from the simulation results (S201-3).

If the first place was not won (NO in S201-3), the event race execution unit 1103a judges whether or not the number of times re-simulation is performed has reached a specified number corresponding to the number of times the player has played rematch of the irregular event race (S201-4).

When the number of times the re-simulation is performed has not reached the specified number (NO in S201-4), the event race execution unit 1103a executes re-simulation of the event race (S201-5). Here, the event race execution unit 1103a changes the number of times re-simulation is performed on the basis of the number of times of rematch.

After performing re-simulation, the event race execution unit 1103a judges whether or not the raised character has won the first place from the re-simulation results (S201-6).

When the first place was not won as a result of the re-simulation (NO in S201-6), the event race execution unit 1103a judges whether or not the number of times the retry bonus is given has reached a specified number (S201-7).

When the number of times the retry bonus is given has not reached the specified number (NO in S201-7), the event race execution unit 1103a gives a retry bonus to the raised character (S201-8). Here, the event race execution unit 1103a changes the parameter (correction value), which is a retry bonus, according to the number of times the retry bonus is given.

Next, the event race execution unit 1103a determines and stores the order of arrival of all participant characters including the raised character of the player (S201-9).

On the basis of the simulation results in S201-1, the event race execution unit 1103a calculates, determines, and stores the event points for the raised character of the player according to the point granting terms (S201-10). Next, the event race execution unit 1103a calculates, determines, and stores the number of fans acquired for the raised character of the player on the basis of the simulation results (S201-11).

Next, the event race execution unit 1103a judges whether or not the raised character of the player has event skills (S201-12). When the raised character does not have event skills (NO in S201-12), the event race execution unit 1103a carries out a lottery on the basis of the event race results, and gives an event skill factor to the raised character of the player with a specified probability (S201-13).

Specifically, when the raised character took first place in the event race, the event race execution unit 1103a gives an event skill factor of factor level 1 to the raised character with a probability of 100%. When the raised character took second place in the event race, the event race execution unit 1103a gives an event skill factor of factor level 1 to the raised characters with a probability of 90%.

In contrast, when the raised character has an event skill (YES in S201-12), the event race execution unit 1103a gives an event skill factor of a specified factor level on the basis of the skill level of that event skill (S201-14).

Specifically, the event race execution unit 1103a gives an event skill factor of a factor level equal to the sum of the value of the skill level of the event skill that the raised character has and a specified value (for example, “+1”). Although the event race execution unit 1103a gives the event skill factor to the raised character having the event skill without fail here, the event skill factor may be given with a specified probability according to the order of arrival.

As such, in the race result deriving process, the event race execution unit 1103a sets the factor level (first parameter) of the event skill factor on the basis of the skill level (second parameter) of the event skill of the raised character (raising-completed game medium).

The event race execution unit 1103a sets race result information including the information determined and stored in S201-1 to S201-14, and allows the player terminal 1 to receive this information (S201-15). Referring back to FIG. 80, the event race execution unit 1103a in the server 1000 updates the player information in the player information storage unit 1150 on the basis of the race result information (S202).

When the player terminal 1 receives the race result information, the event race execution unit 703a executes a race result information storing process of storing the received race result information in the game information storage unit 751 (P202). The event race execution unit 703a also executes an event race control process for controlling the event race (P203).

In this event race control process, an event race is performed by using the raised character (raising-completed game medium) selected by the player. The event race execution unit 703a also plays a race video. In addition, when the race video ends playing, the event race execution unit 703a executes a race result display process of displaying the race results (P204).

When the race results are displayed on the player terminal 1, the event race execution unit 703a updates the player information in the player information storage unit 750 on the basis of the race result information (P205).

The aforementioned event race is achieved by the aforementioned processes. Note that the processes in the player terminal 1 and the server 1000 described above are merely one example. Moreover, each of the processes described above may be executed in only the player terminal 1 or the server 1000.

Although one embodiment is described above by referring to the attached drawings, naturally, the present invention is not limited to the embodiment described above. Obviously, any person skilled in the art could easily conceive of various modifications and alterations within the scope defined by the claims, and any such modifications and alterations are naturally within the technical scope.

The game elements and the processes in the player terminal 1 and the server 1000 described above in the embodiment are merely examples. An information processing program may be any program that causes a computer (in the embodiments, one or both of the player terminal 1 and the server 1000) to perform the following processes.

### (Processes to be Performed by a Computer)

A process of setting one character, which is selected from among multiple characters by the player, as a raising-subject game medium (main character) in a raising game (first game) (P6-6).

A process of enabling the player to select a game medium used in raising the raising-subject game medium in the first game (P6-11).

A process of setting, as an in-use game medium (inheritance character), a game medium that is selected by the player and that includes a raising-completed game medium having a first parameter linked with the raising-subject game medium (P6-12).

A process of executing a first game that includes a process of raising the raising-subject game medium, in which a specified parameter linked with the raising-subject game medium is updated on the basis of the in-use game medium (P12-9).

A process of generating and storing the raising-completed game medium on the basis of completion of the first game (S8-9).

A process of executing an event race (second game) by using the raising-completed game medium selected by the player (S201).

The process of executing the first game includes a process of changing, on the basis of the first parameter, a second parameter linked with the raising-subject game medium when the raising-completed game medium having the first parameter set thereto is set as the in-use game medium (P22-11).

The process of executing the second game includes a process (S201-12 and S201-13) of setting the first parameter on the basis of the second parameter of the raising-completed game medium.

In the process of executing the second game, a reward obtained in the second game is increased on the basis of the second parameter of the raising-completed game medium.

The process of enabling the player to select a game medium involves enabling the player to select a raising-completed game medium raised by another player. When the raising-completed game medium raised by another player is set as the in-use game medium, the second parameter is not changed on the basis of the first parameter linked with this in-use game medium (P22-10).

The information processing programs for executing processes of the aforementioned embodiments and various modification examples may be stored in a non-transitory storage medium readable by a computer and may be provided as a storage medium. Furthermore, a game console including this storage medium may be provided. In addition, the aforementioned embodiments and various modification examples may be an information processing method that achieves functions and steps indicated in the flowcharts.

What is claimed is:

1. A non-transitory computer readable medium storing a program causing a computer to execute:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
a process of changing the second parameter linked with the raising subject game medium on the basis of the first parameter when the raising-completed game medium for which the first parameter is set is set as the in-use game medium, and
the process of executing the second game includes:
a process of setting the first parameter on the basis of the second parameter of the raising-completed game medium.

2. The non-transitory computer readable medium according to claim 1, wherein,
in the process of executing the second game,
a reward granted in the second game is increased on the basis of the second parameter of the raising-completed game medium.

3. The non-transitory computer readable medium according to claim 1, wherein,
the process of enabling the player to select a game medium involves:
enabling the player to select the raising-completed game medium raised by another player, and
not changing the second parameter on the basis of the first parameter linked with the in-use game medium when the raising-completed game medium raised by the other player is set as the in-use game medium.

4. An information processing method to be executed by a computer, the computer executing:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
a process of changing the second parameter linked with the raising subject game medium on the basis of the first parameter when the raising-completed game medium for which the first parameter is set is set as the in-use game medium, and
the process of executing the second game includes:
a process of setting the first parameter on the basis of the second parameter of the raising-completed game medium.

5. A game device comprising at least one computer,
wherein the at least one computer executes:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
a process of changing the second parameter linked with the raising subject game medium on the basis of the first parameter when the raising-completed game medium for which the first parameter is set is set as the in-use game medium, and
the process of executing the second game includes:
a process of setting the first parameter on the basis of the second parameter of the raising-completed game medium.

6. An information processing system comprising at least one computer,
wherein the at least one computer executes:
a process of setting, as a raising subject game medium in a first game, one character selected by a player from among a plurality of characters;
a process of enabling the player to select a game medium to be used in raising the raising subject game medium in the first game;
a process of setting, as an in-use game medium, the game medium that is selected by the player and that includes a raising-completed game medium having a first parameter linked with the raising subject game medium;
a process of executing the first game serving as a process of raising the raising subject game medium, the process including at least a process of updating a specified parameter linked with the raising subject game medium on the basis of the in-use game medium;
a process of generating and storing the raising-completed game medium on the basis of completion of the first game; and
a process of executing a second game by using the raising-completed game medium selected by the player, wherein
the process of executing the first game includes:
a process of changing the second parameter linked with the raising subject game medium on the basis of the first parameter when the raising-completed game medium for which the first parameter is set is set as the in-use game medium, and
the process of executing the second game includes:
a process of setting the first parameter on the basis of the second parameter of the raising-completed game medium.
